(19) United States
(12) Patent Application Publication
(10) Pub. No.: US 2026/0344934 A1
(43) Pub. Date: Nov. 5, 2026

(54) COOKING DEVICES AND COMPONENTS THEREOF

(71) Applicant: SharkNinja Operating LLC, Needham, MA (US)

(72) Inventors: Kin Kit Christopher Wong, London (GB); Christopher Meyer-Rassow, London (GB); Georgia Emily Ann Banton, London (GB); Caroline Claire DeFrancesco, Newton, MA (US); Toby Hale, Cheltenham (GB); Thomas Michael Malloy, Oxon (GB); Nicholas Christo, Mansfield, MA (US); Christopher Martin, North Attleboro, MA (US); Martin Pelaio Bouriez-Majourau, Chestnut Hill, MA (US)

(21) Appl. No.: 19/446,819

(22) Filed: Jan. 12, 2026

Related U.S. Application Data
(63) Continuation-in-part of application No. 19/195,077, filed on Apr. 30, 2025.

(51) Int. Cl. A47J 37/06

(52) U.S. Cl. CPC A47J 37/0641

(57) ABSTRACT

A cooking system is provided that includes a base, a spine projecting upward from the base, a housing coupled to the spine and positioned above the base in a cantilevered configuration, the cooking system configured to accommodate two or more containers between the base and the housing for cooking operations, and a structural frame comprising an internal reinforced spine structure, an internal reinforced base structure, and an internal reinforced housing structure, wherein the structural frame is configured to provide rigidity to the cantilevered configuration of the cooking system.

### CROSS-REFERENCE TO RELATED APPLICATIONS

The present application is a continuation-in-part of U.S. patent application Ser. No. 19/195,077, filed Apr. 30, 2025, entitled “COOKING DEVICES AND COMPONENTS THEREOF,” which is hereby incorporated by reference in its entirety.

### FIELD

A countertop cooking system including one or more heating and air movement elements, a cooking chamber, and one or more thermal protection elements, are provided.

### BACKGROUND

An air fryer is a kitchen appliance that cooks by rapidly circulating hot air around food within a basket positioned in a cooking chamber. Some air fryers may come with adjustable temperature and timer knobs that allow for more precise cooking. Typically, heat is created by a heating coil and a mechanical fan circulates the hot air around the food at high speed. This cooking method produces a crispy layer on the food due to Maillard reactions. By creating and circulating heated air at temperatures, the air fryer is able to fry foods like potato chips, chicken, fish, pastries and more using much less oil than a traditional deep-fryer. Various brands of air fryers claim to use as much as 80% less cooking oil in comparison to traditional deep-fryers.

### SUMMARY

In one aspect, a cooking system is provided that can include a base, a spine projecting upward from the base, a housing coupled to the spine and positioned above the base in a cantilevered configuration, the cooking system arranged to accommodate two or more containers between the base and the housing for cooking operations, and a structural frame including an internal reinforced spine structure, an internal reinforced base structure, and an internal reinforced housing structure, wherein the structural frame can be arranged to provide rigidity to the cantilevered configuration of the cooking system.

In some aspects, the structural frame can be constructed from metal materials.

In some aspects, the metal materials can include steel or aluminum.

In some aspects, the internal reinforced spine structure, the internal reinforced base structure, and the internal reinforced housing structure can be rigidly coupled to one another via at least one of bolts, rivets, or welded connections.

In some aspects, the internal reinforced spine structure can include internal ribbing to provide additional structural support.

In some aspects, the internal reinforced spine structure can be arranged to house one or more electrical wires.

In some aspects, the one or more electrical wires can include a power cord for the cooking system.

In another aspect, a cooking system is provided that can include a platform including a base and a spine projecting upward from the base, a housing coupled to the spine and cantilevered over the base, wherein a bottom surface of the housing can be arranged to selectively seal around top rims of two or more containers during cooking operations, and a rigid structural frame extending through the base, spine, and housing, wherein the structural frame can be constructed from metal and arranged to rigidly support the housing in the cantilevered configuration during cooking operations.

In some aspects, the structural frame can include an internal reinforced spine structure, an internal reinforced base structure, and an internal reinforced housing structure.

In some aspects, the internal reinforced spine structure, the internal reinforced base structure, and the internal reinforced housing structure can be rigidly coupled to one another via at least one of bolts, rivets, or welded connections.

In some aspects, the internal reinforced spine structure can include internal ribbing to provide additional structural support.

In some aspects, the structural frame can be constructed from steel or aluminum.

In some aspects, the structural frame can be arranged to house one or more electrical wires within the spine.

In some aspects, the one or more electrical wires can include a power cord for the cooking system.

In another aspect, a cooking system is provided that can include a base arranged to support two or more containers during a cooking operation, a spine extending upward from a rear portion of the base, a housing coupled to the spine and extending forward over the base in a cantilevered arrangement, the housing having a maximum lateral width greater than a lateral width of the spine, and an internal structural frame arranged to extend from the base through the spine to the housing, wherein the structural frame can be made from a metal material and can be arranged to provide structural support to the cantilevered housing.

In some aspects, the metal materials can have a yield strength of at least 200 MPa.

In some aspects, the metal materials can include steel or aluminum.

In some aspects, the structural frame can further include a structural fin arranged to project forward from the spine between the two or more containers to provide additional structural support for the housing.

In some aspects, the structural fin can be arranged to terminate short of a front of the housing to allow pivoting of the containers during insertion and removal.

In some aspects, the internal reinforced spine structure can include internal ribbing to provide additional structural support and can be arranged to house electrical wiring for the cooking system.

In another aspect, a cooking system is provided that can include a base arranged to support containers during cooking operations, a spine extending upward from a rear portion of the base, a housing coupled to the spine and extending forward over the base in a cantilevered arrangement, the housing arranged to accommodate two or more containers between the base and the housing, guide features extending upward from a top surface of the base, the guide features having an oblong shape with curved ends, and at least one container including a container body and a container base, the container base including elongated rails extending along opposite sides of a bottom surface of the container base, the rails having curved end portions and parallel central portions, wherein the curved end portions of the rails can be arranged to engage with the curved ends of the guide features to allow the container to be positioned at an angle relative to a front of the housing and then rotated into alignment with the housing such that the parallel central portions of the rails straddle the guide features to prevent lateral movement of the container.

In some aspects, the rails can include rubber inserts positioned on the curved end portions to prevent sliding when the container is placed on countertops.

In some aspects, the container base can further include secondary rails positioned between the parallel central portions of the rails, the secondary rails extending from the container base by a distance less than the distance the rails extend.

In some aspects, the secondary rails can be arranged to contact a top surface of the guide features during insertion and removal processes to reduce friction between the container base and the base.

In some aspects, the base of the cooking system can further include a switch arranged to detect presence of the container when the container is properly seated on the base of the cooking system.

In some aspects, the switch can be biased to an extended position by a spring and can be arranged to be compressed by the container base during insertion.

In some aspects, the container base can include one or more detents positioned to align with the switch when the container is properly positioned, allowing the switch to at least partially return to the extended position.

In some aspects, the detents can have a teardrop shape that facilitates removal of the container while preventing the container from being pushed past the switch during insertion.

In some aspects, the container base can include multiple handle structures extending from different sides of the container base to provide various gripping options for users.

In some aspects, the multiple handle structures can include a front handle extending from a front edge of the container base and a rear handle extending from a rear edge of the container base.

In some aspects, the cooking system can further include a platform insert arranged to be selectively coupled to the guide features of the cooking system to elevate a smaller container being accommodated within the cooking system, wherein the smaller container can include a container body and a container base, the container base including elongated rails extending along opposite sides of a bottom surface of the container base, the rails having curved end portions and parallel central portions, wherein the curved end portions of the rails can be arranged to engage with the curved ends of the platform insert to allow the smaller container to be positioned at an angle relative to a front of the housing and then rotated into alignment with the housing such that the parallel central portions of the rails straddle the platform insert to prevent lateral movement of the smaller container.

In another aspect, a method is provided that can include positioning a container at an angle relative to a front of a housing of a cooking system having a base with guide features extending upward from a top surface thereof, wherein the container can include rails with curved end portions provided on a base thereof, engaging the curved end portions of the rails with curved ends of the guide features on the base, rotating the container from the angled position toward alignment with the front of the housing while the rails slide along the guide features, and securing the container in a final position where parallel central portions of the rails straddle the guide features to prevent lateral movement of the container, and wherein a top rim of the container can be selectively sealed with a cooking portion of the cooking system.

In some aspects, the container can include one or more handle structures extending from sides of the base of the container, and wherein positioning the container at the angle can be performed by gripping the one or more handle structures.

In some aspects, the one or more handle structures can include a front handle and a rear handle, and wherein positioning the container can include gripping both the front handle and the rear handle simultaneously to maintain secure control during the angled insertion.

In some aspects, the method can further include actuating a switch positioned within the base of the cooking system when the container reaches the final position, wherein the switch provides tactile feedback to indicate proper seating of the container.

In another aspect, a container is provided that can include a container body having an upper rim and sidewalls, a container base coupled to the container body and including a bottom surface, elongated rails extending along a bottom surface of the container base, the rails having curved end portions arranged to facilitate initial engagement with guide features provided on a base of the cooking system, and parallel central portions arranged to straddle the guide features when the container is properly positioned, and one or more handles extending from the container base to provide gripping surfaces for user manipulation during insertion and removal of the container from the cooking system.

In some aspects, the rails can include rubber inserts positioned on the curved end portions to prevent sliding when the container is placed on countertops or other supporting surfaces.

In some aspects, the container base can further include secondary rails positioned between the parallel central portions of the rails, the secondary rails extending from the container base by a distance less than the distance the rails extend.

In some aspects, the secondary rails can be arranged to contact a top surface of guide features of the cooking system during insertion and removal processes to reduce friction between the container base and a base of the cooking system.

In some aspects, the container body can be made from a transparent thermal shock-resistant material.

In some aspects, the container body can be made from borosilicate glass or thermally resistant plastic.

In some aspects, the container body can include one or more first detents or indents provided on an exterior of the sidewalls, and wherein the container base can include one or more second detents or indents provided on an interior face thereof and arranged to interact with the one or more first detents or indents to securely couple the container base to the container body.

In some aspects, the container base can further include one or more projections provided along an upper surface of the base arranged to support the container body and create a gap between the container body and the container base, providing a thermal barrier between the upper surface of the base and the container body.

In some aspects, the one or more handles can include a front handle extending from a front edge of the container base, a rear handle extending from a rear edge of the container base, and side handles extending laterally from opposite sides of the container base to provide multiple gripping options for users.

In another aspect, a cooking system is provided that can include a base arranged to support two or more containers during cooking operations, a spine extending upward from a rear portion of the base, a housing coupled to the spine and extending forward over the base in a cantilevered arrangement, the housing arranged to accommodate the two or more containers between the base and the housing, first and second heating elements positioned within the housing above respective cooking zones, first and second air movement devices arranged to direct air over the first and second heating elements and into volumes of the two or more containers during cooking operations, and third and fourth air movement devices arranged to direct cooling air through cooling airflow channels within the housing, wherein the cooling airflow channels extend within the housing from at least one inlet to a plurality of outlets positioned radially outward from the cooking zones and arranged to expel cooling air around perimeters of the two or more containers during cooking operations.

In some aspects, the cooling airflow channels can have a varying cross-sectional geometry that narrows from an upper portion toward the outlets, wherein the narrowing geometry creates a venturi effect that accelerates the cooling airflow as it passes through the channels.

In some aspects, the third and fourth air movement devices can be arranged to actuate in opposite directions to ensure that the cooling air converges through a center of the cooking device.

In some aspects, the housing can further include a secondary air inlet positioned between a top portion of the housing and a brim portion of the housing to supplement airflow for the cooling airflow channels.

In some aspects, the secondary air inlet can be arranged to provide an exit path for water diverted from a primary air inlet through a water diversion channel.

In some aspects, the cooking system can further include a blast cooling functionality that can be arranged to activate the third and fourth air movement devices at increased speed when one of the two or more containers is removed from the cooking system to provide additional cooling during container removal.

In some aspects, the cooking system can be provided with one or more additional cooking fans provided in the base or the spine of the cooking system that can be arranged to provide direct cooling to bases or sides of the two or more containers during cooking operations.

In another aspect, a cooking system is provided that can include a base arranged to support two or more containers during cooking operations, a spine extending upward from a rear portion of the base, a housing coupled to the spine and extending forward over the base in a cantilevered arrangement, the housing having an upper portion and a lower portion separated by a partition assembly, first and second heating elements positioned in the lower portion of the housing, first and second air movement devices arranged to direct air over the first and second heating elements, heating airflow paths extending from an air inlet through a periphery of the upper portion of the housing and through bypass openings in the partition assembly, and exhaust vents positioned at a rear of the housing and including louvered grills arranged to direct exhausted air outward at an angle to prevent recirculation back into the housing.

In some aspects, the partition assembly can include an upper divider, a first shield layer, and a second shield layer with air gaps between the layers to provide thermal insulation between the upper portion and the lower portion of the housing.

In some aspects, the partition assembly can include additional openings positioned at the central regions to allow airflow to pass from the gaps between shield layers into the lower portion of the housing directly above the first and second air movement devices.

In some aspects, the first and second air movement devices can be arranged to actuate in opposite directions to ensure that the heating air provided to the cooking chambers converges through a center of the cooking device.

In some aspects, the louvered grills can be angled to direct the exhausted air upward and outward from the housing to prevent heated air from being drawn back into air inlets of the housing.

In some aspects, the exhaust vents can bypass the partition assembly to allow exhaust air to be expelled directly from a brim portion of the housing.

In some aspects, a total area of the air inlet can match a total area of the exhaust vents to optimize airflow efficiency.

In some aspects, the cooking system can further include a water diversion channel positioned below a top rim of the housing and arranged to direct water away from internal components through a labyrinth flow path that includes an elevated wall to permit air flow while blocking liquid ingress.

In another aspect, a cooking system is provided that can include a base arranged to support two or more containers during cooking operations, a spine extending upward from a rear portion of the base, a housing coupled to the spine and extending forward over the base in a cantilevered arrangement, the housing having a top rim with an air inlet, a water flow diversion channel positioned below the top rim and within the air inlet region of the housing, the water flow diversion channel including a sloped surface arranged to direct water away from internal components, a labyrinth flow path formed within the water flow diversion channel and including multiple directional changes arranged to allow air to pass through while blocking liquid ingress, an elevated wall positioned within the labyrinth flow path and arranged to permit air to flow over the wall while preventing water from flowing past the wall, and a secondary air inlet positioned between a top portion of the housing and a brim portion of the housing, the secondary air inlet arranged to provide an exit path for water diverted by the water flow diversion channel.

In some aspects, the sloped surface of the water flow diversion channel can be arranged to facilitate gravity-driven water flow toward the secondary air inlet.

In some aspects, the secondary air inlet can be positioned as a gap between the top portion of the housing and the brim portion of the housing.

In some aspects, the water flow diversion channel can be arranged to route water that enters through the air inlet along the labyrinth flow path toward the secondary air inlet, and wherein the secondary air inlet provides both an exit path for diverted water and supplemental airflow for cooling operations within the housing.

### BRIEF DESCRIPTION OF DRAWINGS

These and other features will be more readily understood from the following detailed description taken in conjunction with the accompanying drawings, in which:

FIG. 1A is a perspective view of an aspect of a cooking device according to the subject matter described herein;

FIG. 1B is a front view of the cooking device of FIG. 1A with a cooking container attached;

FIG. 1C is a front view of the cooking device of FIG. 1A with the cooking container removed;

FIG. 1D is a side view of the cooking device of FIG. 1A;

FIG. 1E is a top view of the cooking device of FIG. 1A;

FIG. 1F is a cross-sectional view of the cooking device of FIG. 1A taken along section C-C of FIG. 1C;

FIG. 1G is an enlarged view of DETAIL-A of FIG. 1F;

FIG. 1H is a cross-sectional view of the cooking device of FIG. 1A taken along section D-D of FIG. 1C;

FIG. 1I is a cross-sectional view of the cooking device of FIG. 1A taken along section F-F of FIG. 1D;

FIG. 1J is a cross-sectional view of the cooking device of FIG. 1A taken along section E-E of FIG. 1C;

FIG. 1K is a cross-sectional view of the cooking device of FIG. 1A taken along section A-A of FIG. 1B;

FIG. 1L is an enlarged view of DETAIL-B of FIG. 1H, illustrating portions of one aspect of a seal assembly of the cooking devices according to the subject matter described herein;

FIGS. 1M-IN are detailed views of the portions of the aspect of the seal assembly of FIG. 1L depicting the seal assembly receiving a small or medium container and receiving a large container, respectively;

FIGS. 10-1P are cross-sectional views of the cooking device of FIG. 1A taken along section G-G of FIG. 1E depicting the seal assembly with no container attached and the seal assembly with a container attached, respectively;

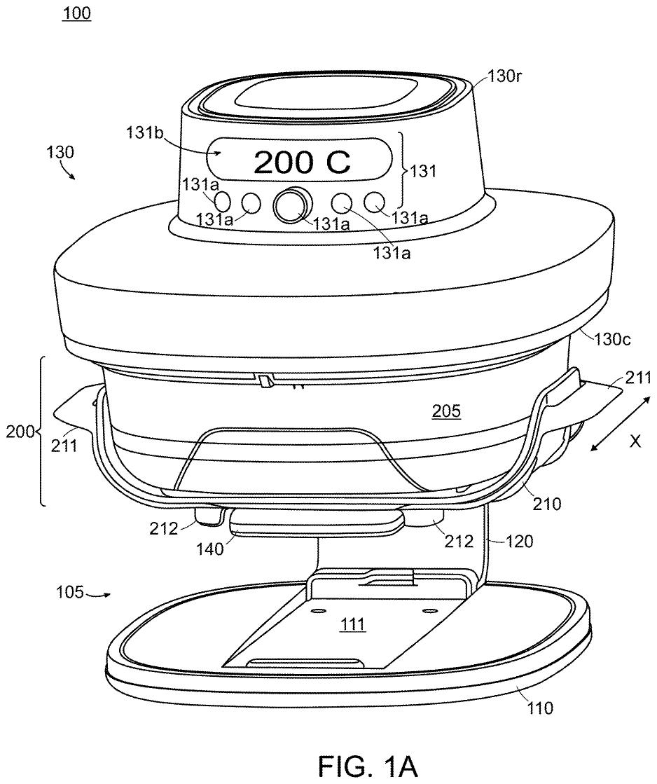

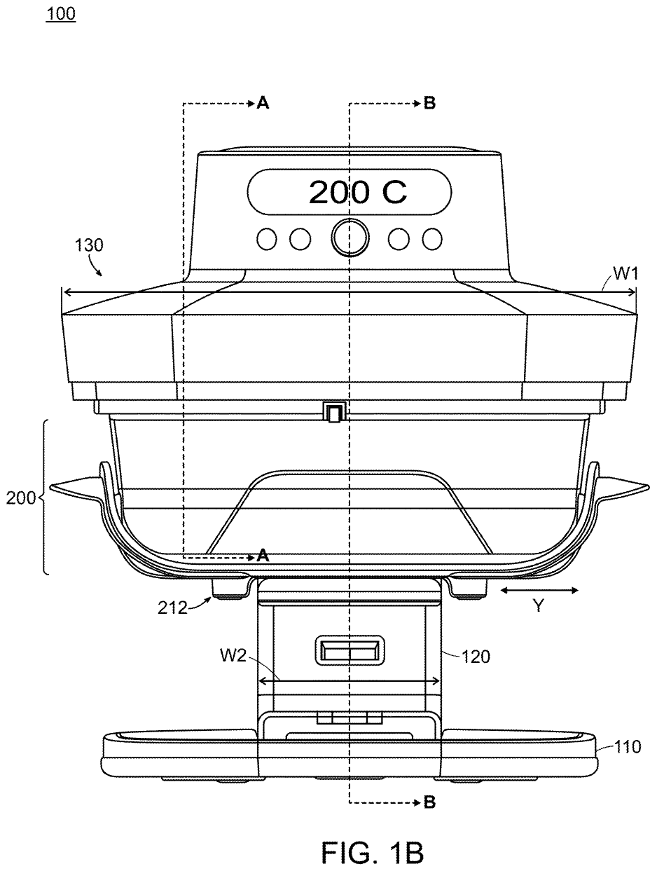

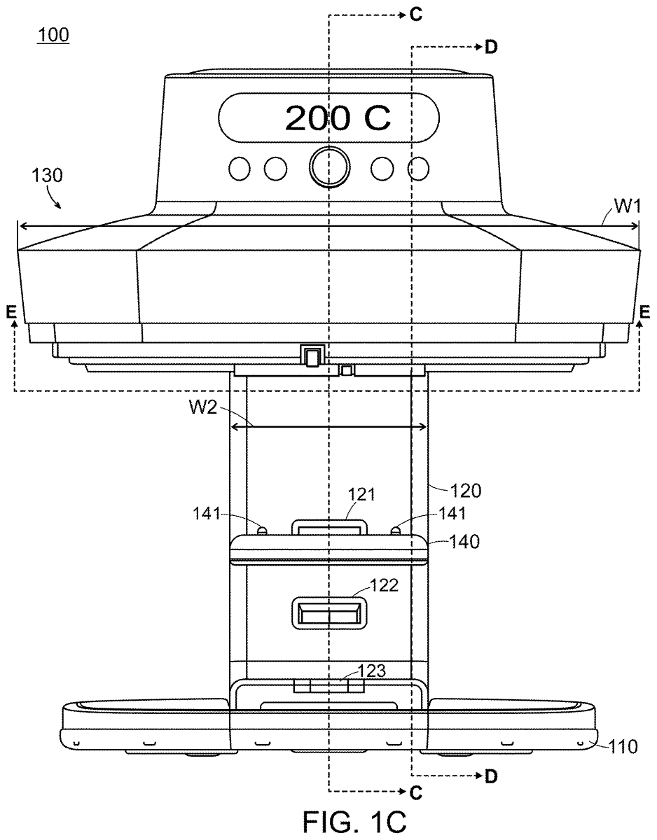

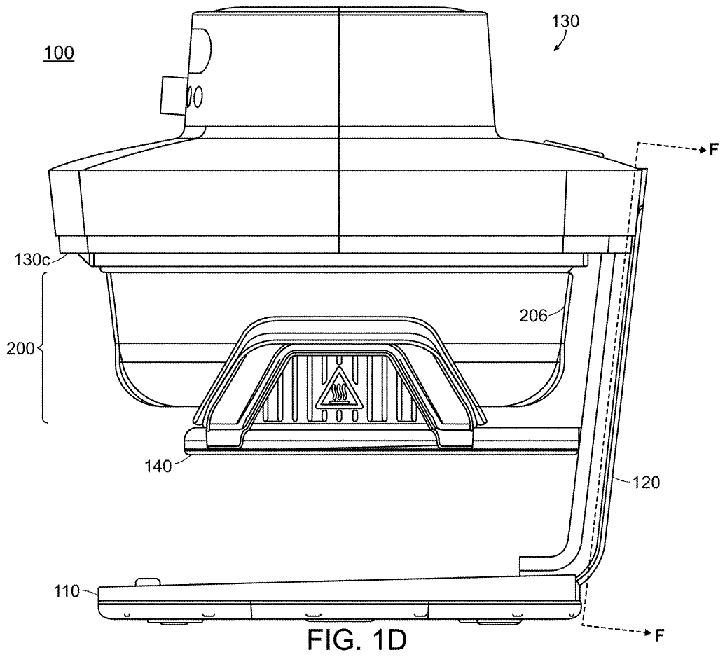

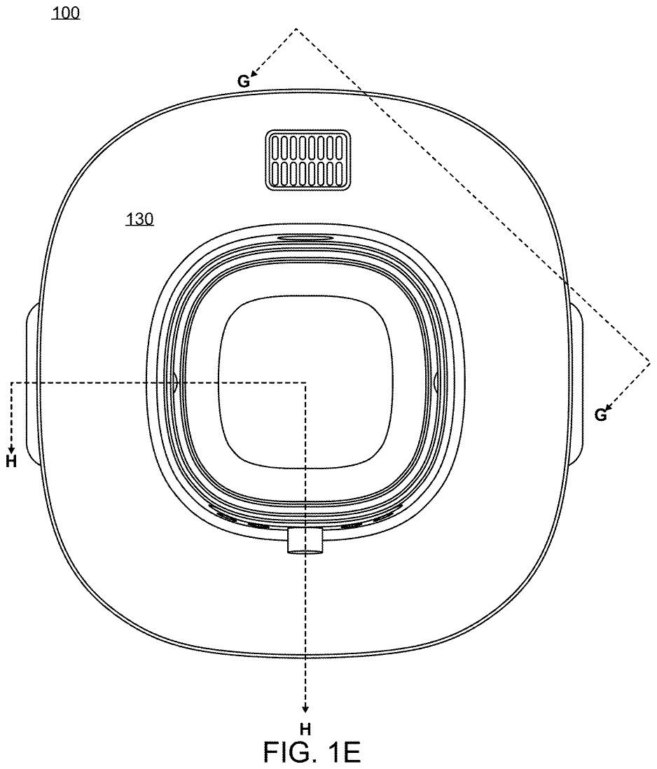

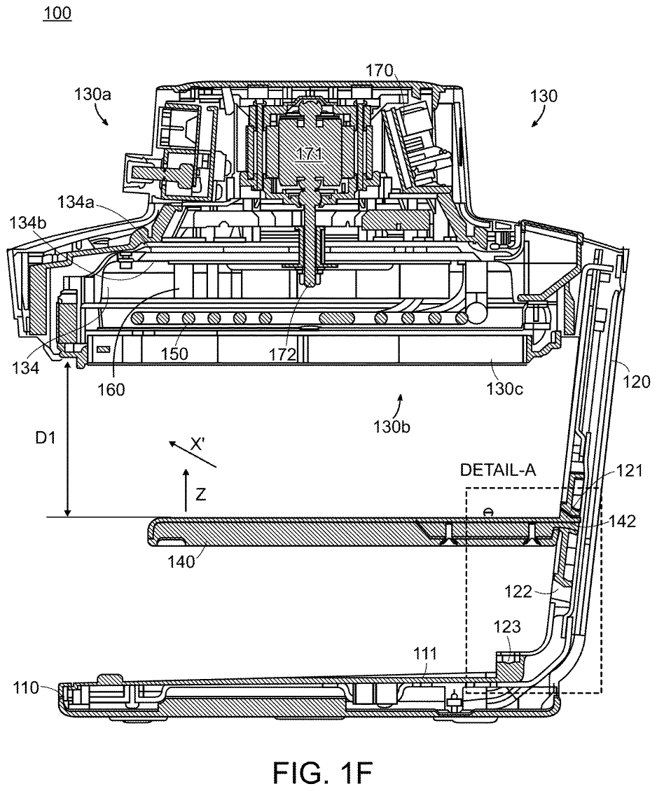

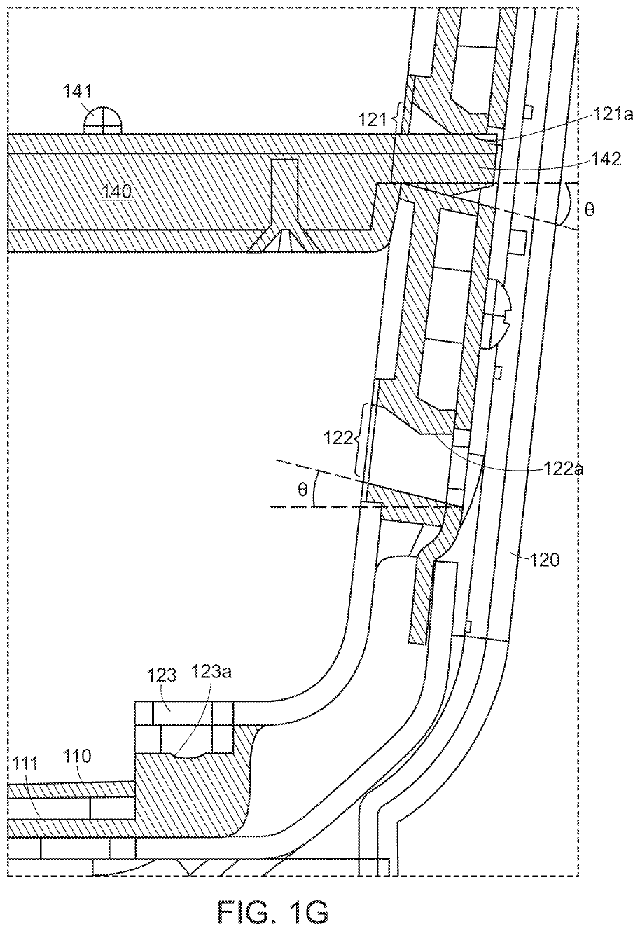

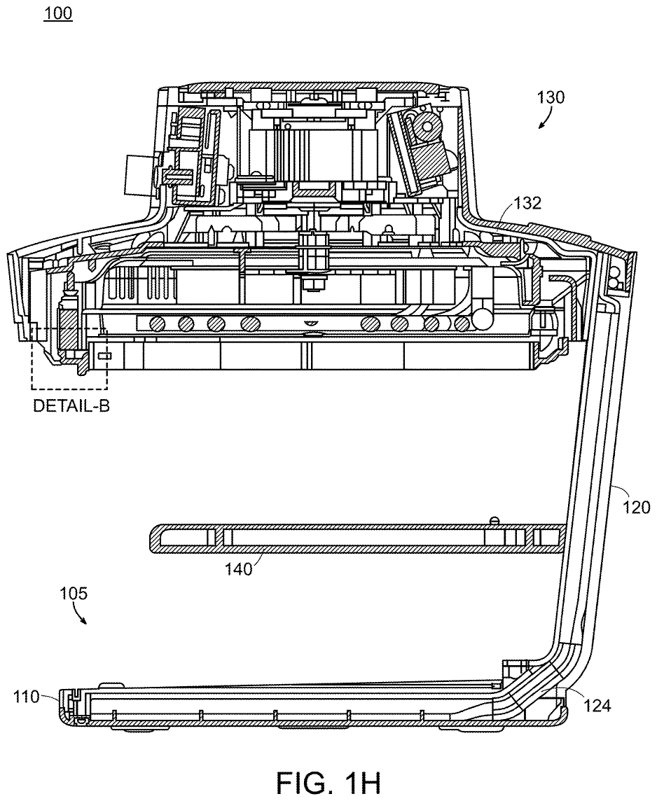

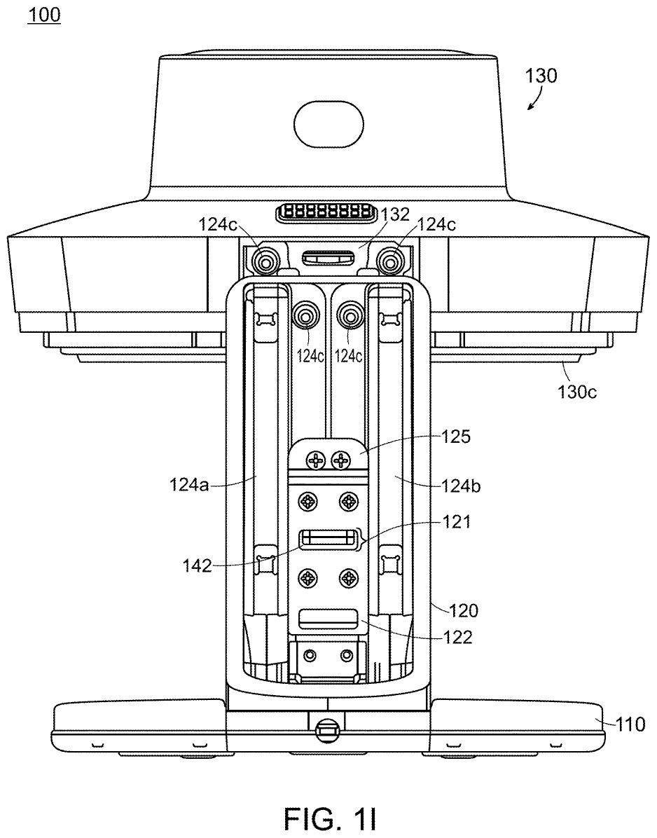

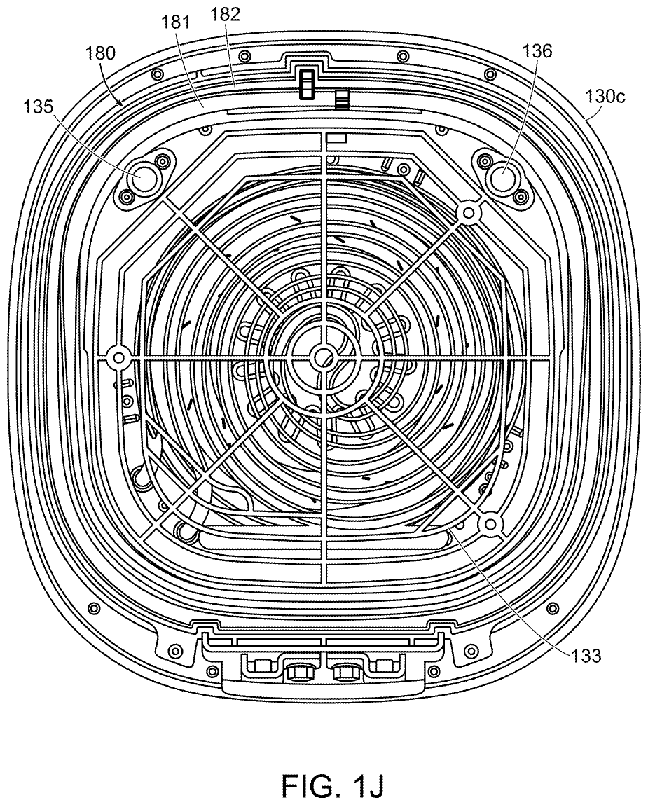

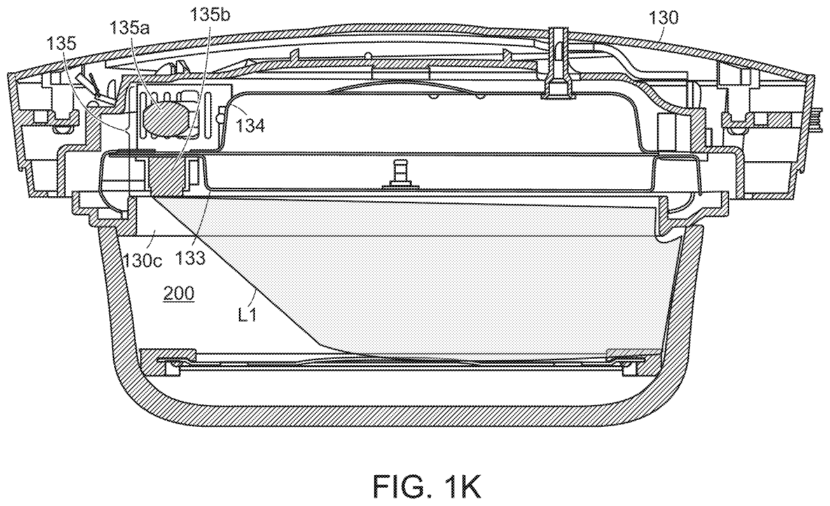

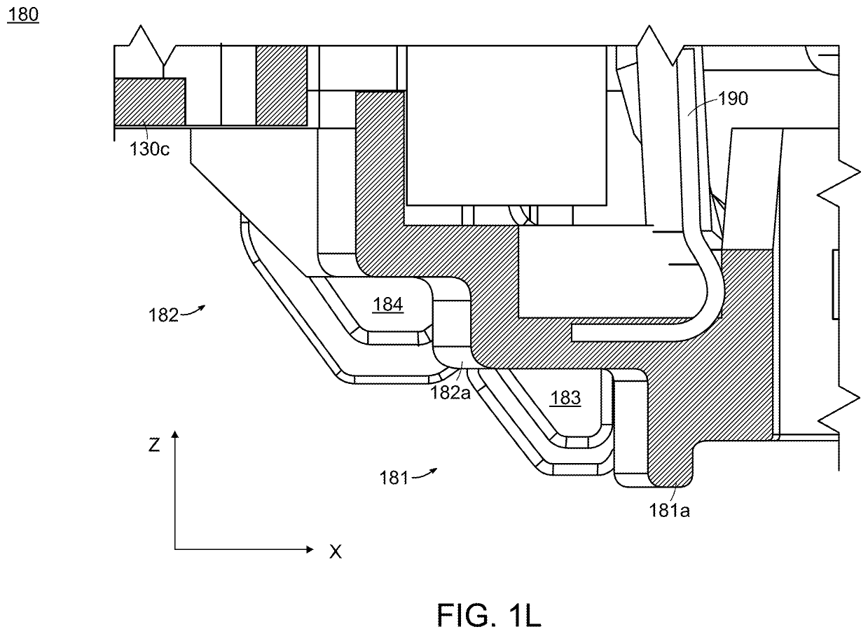

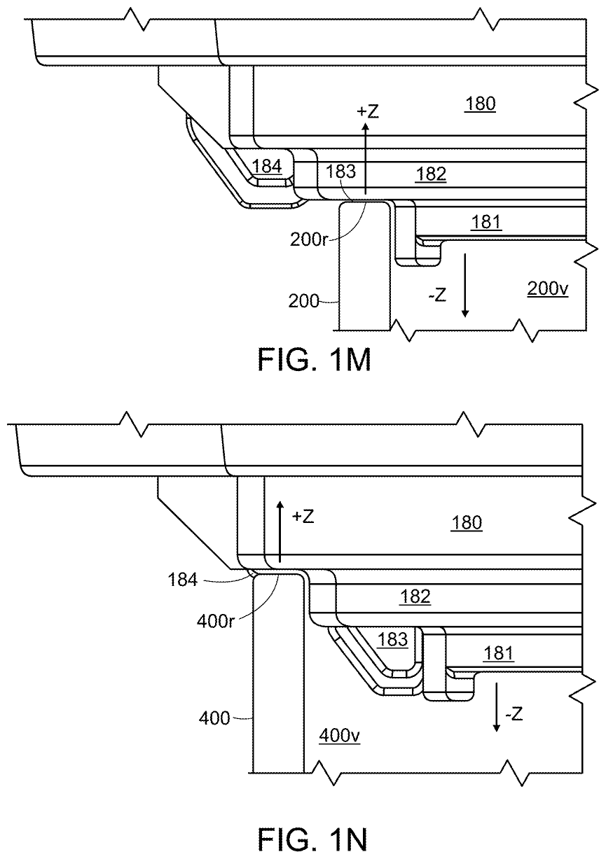

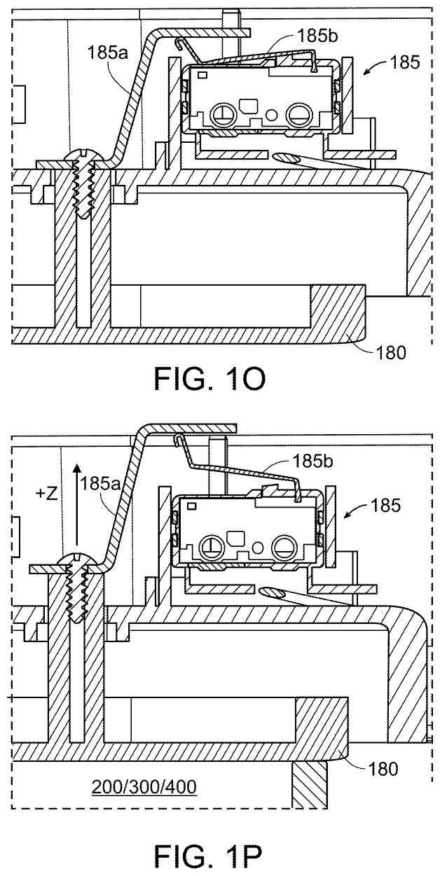

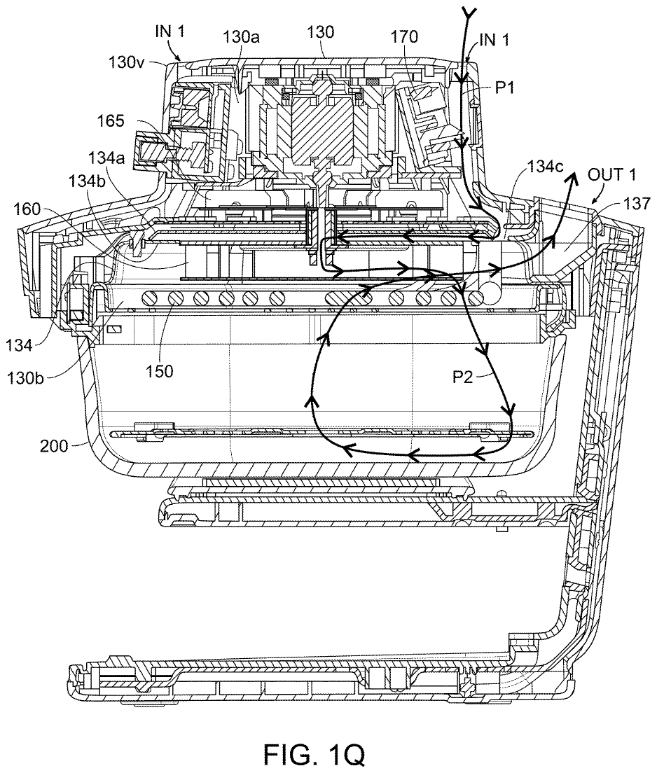

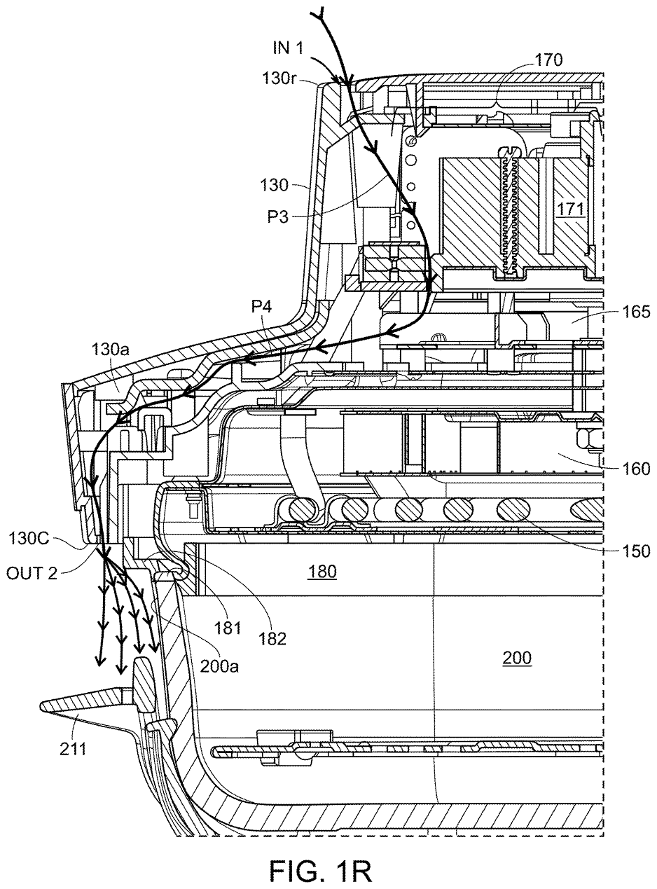

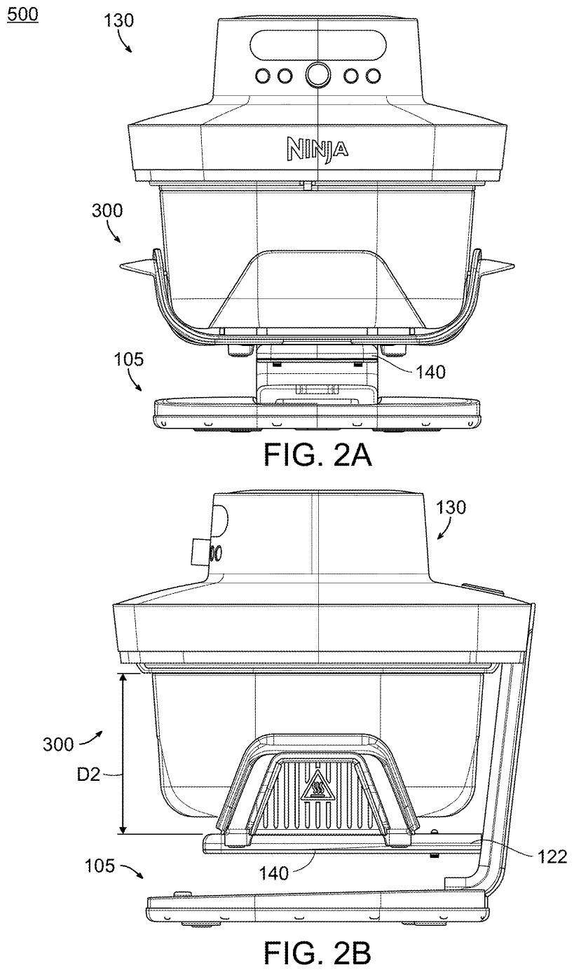

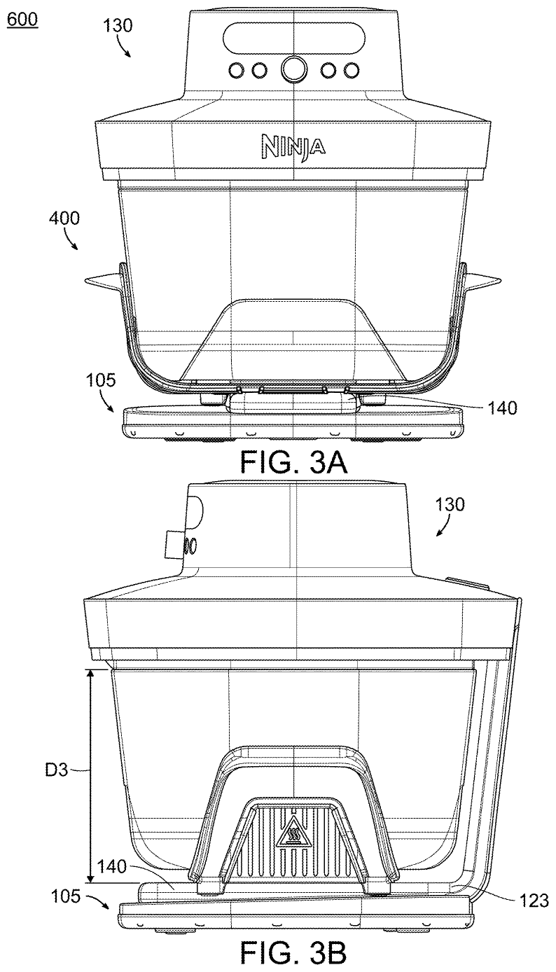

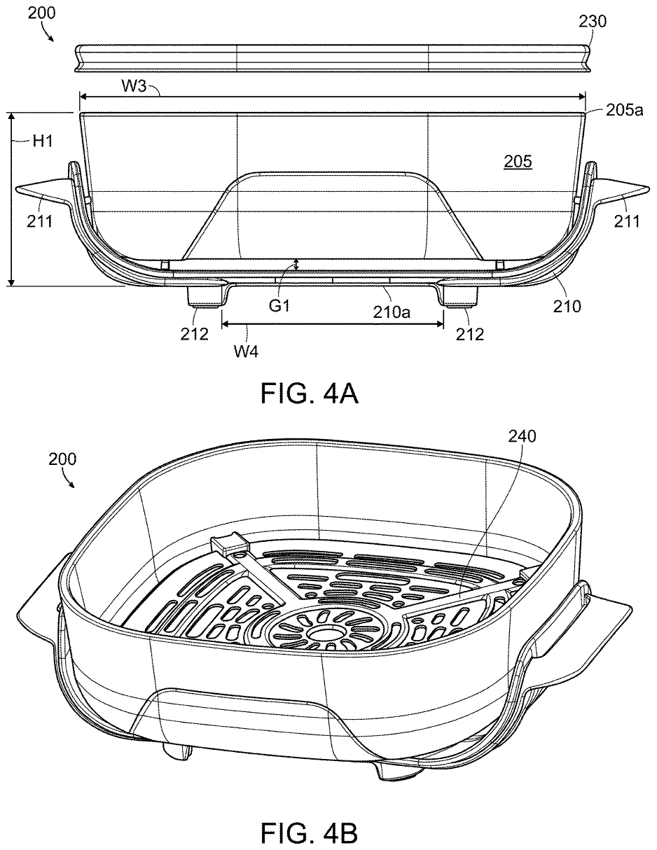

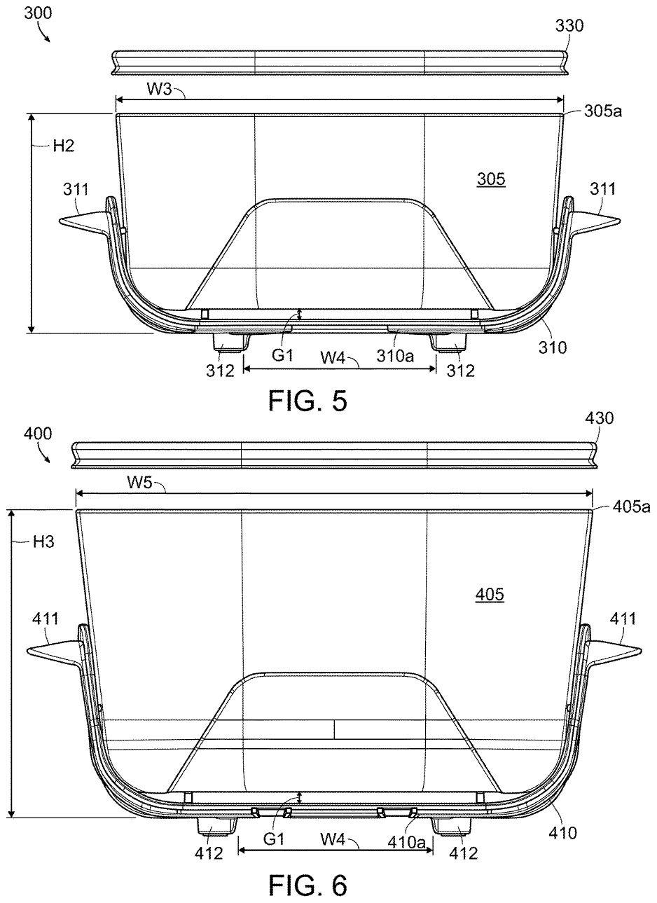

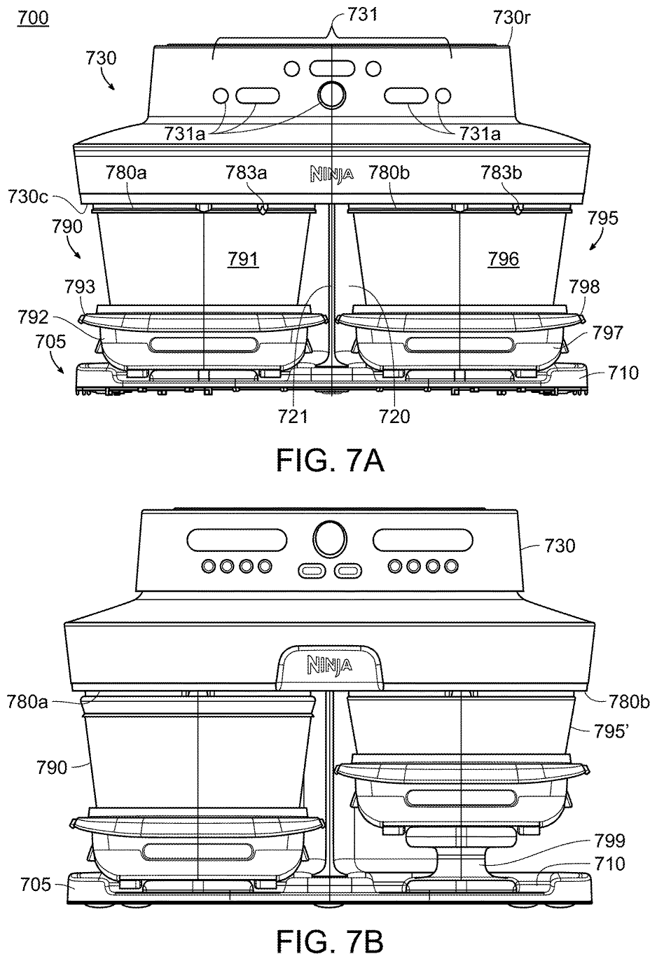

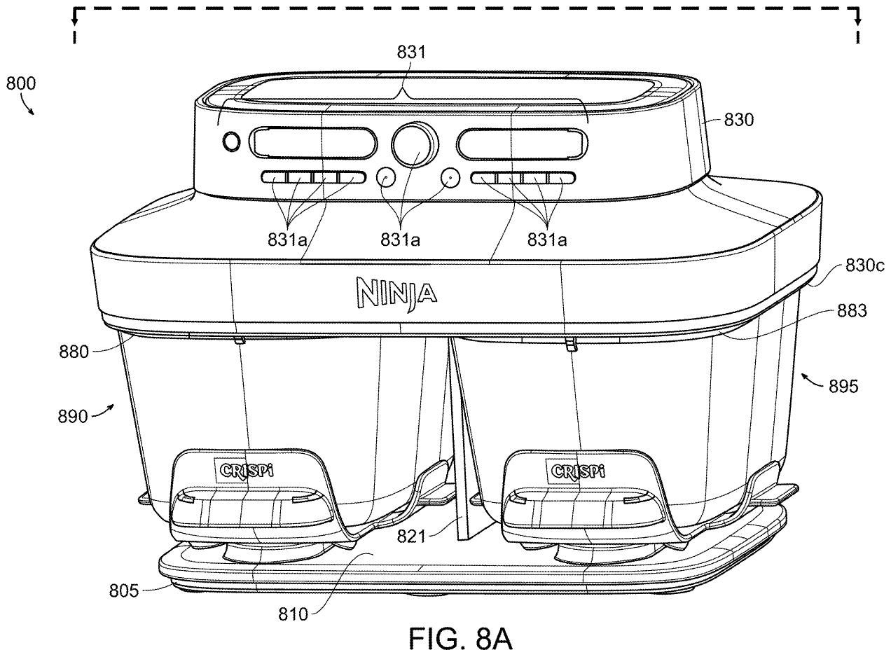

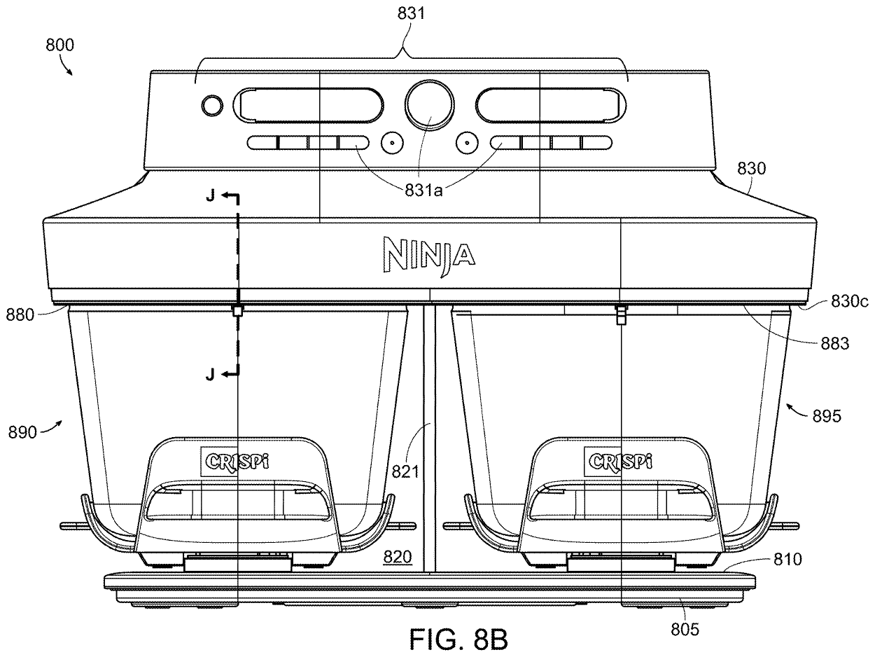

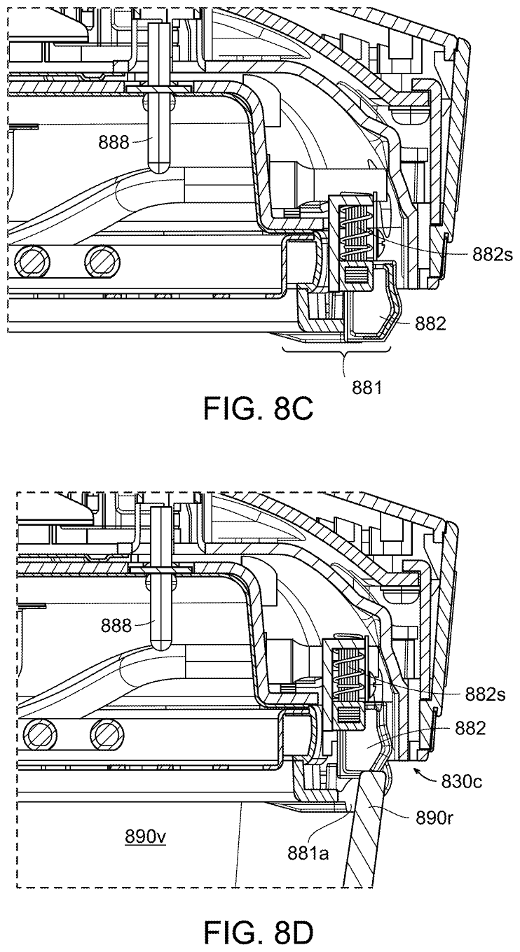

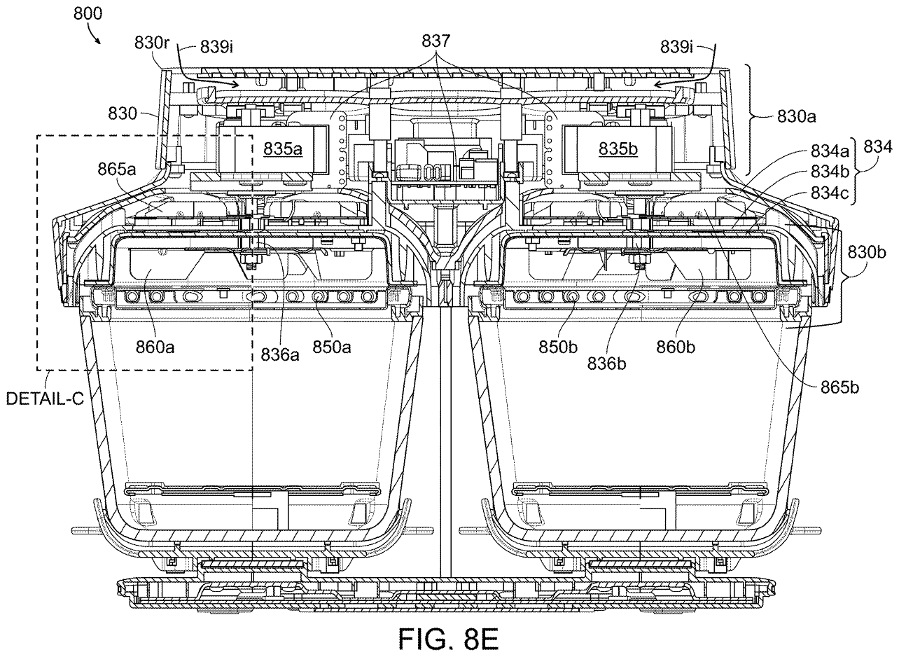

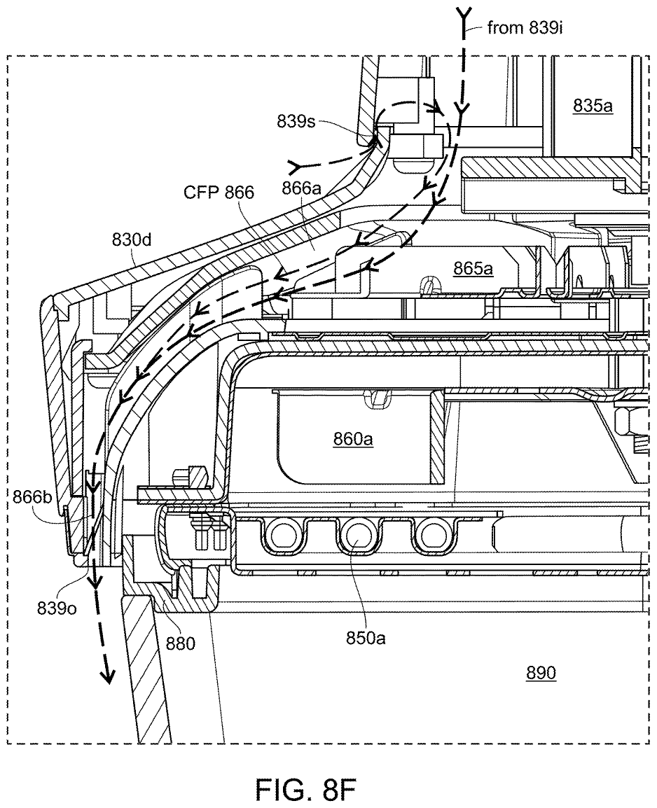

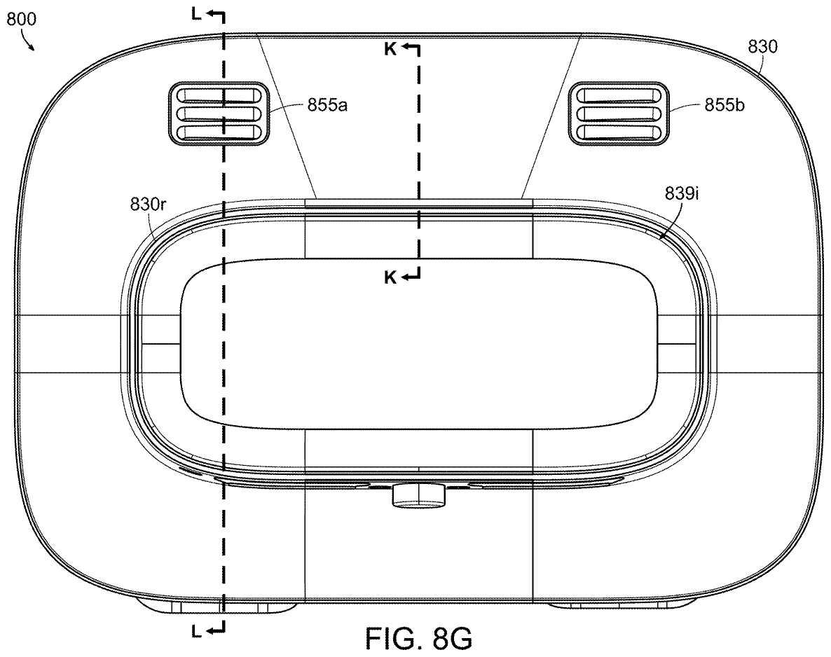

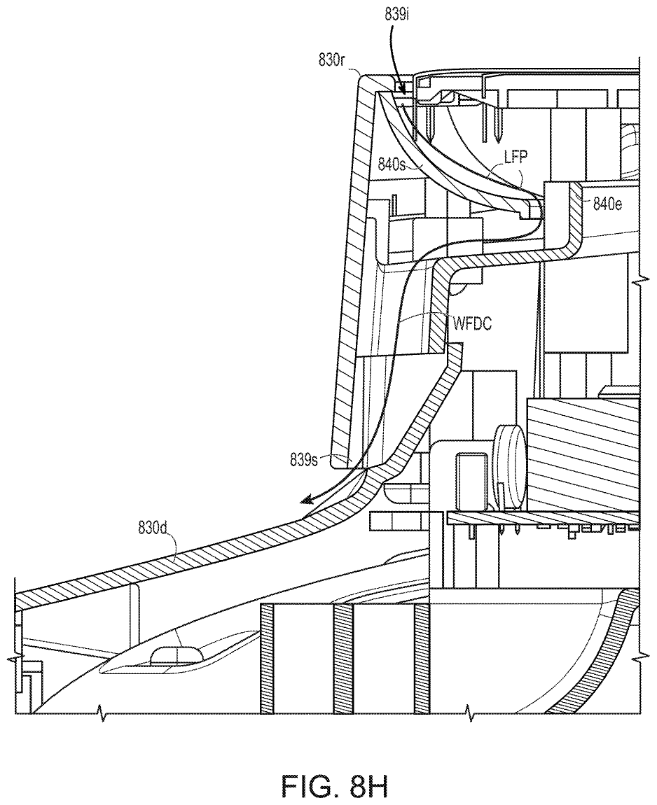

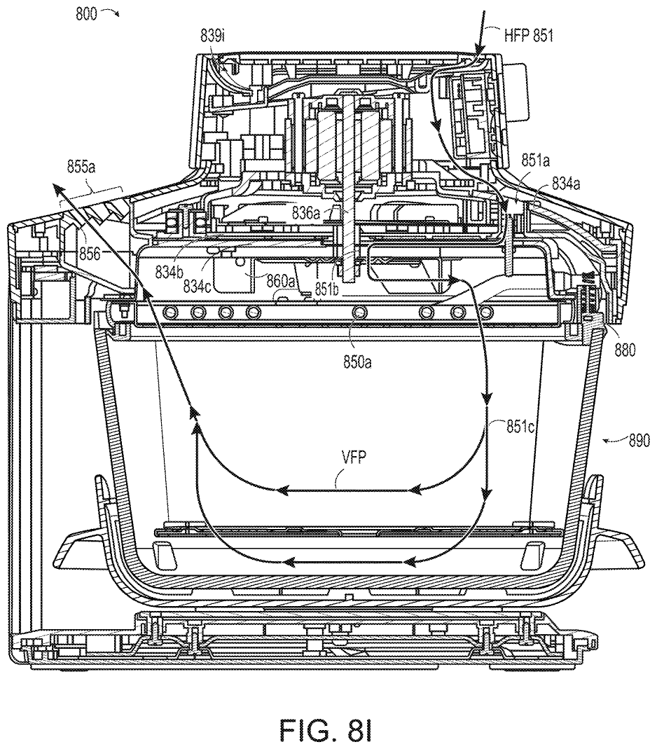

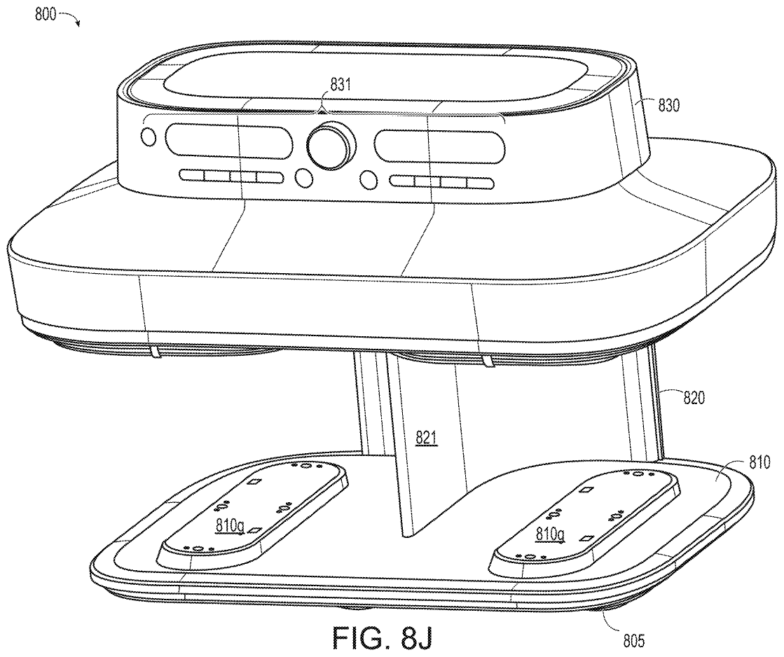

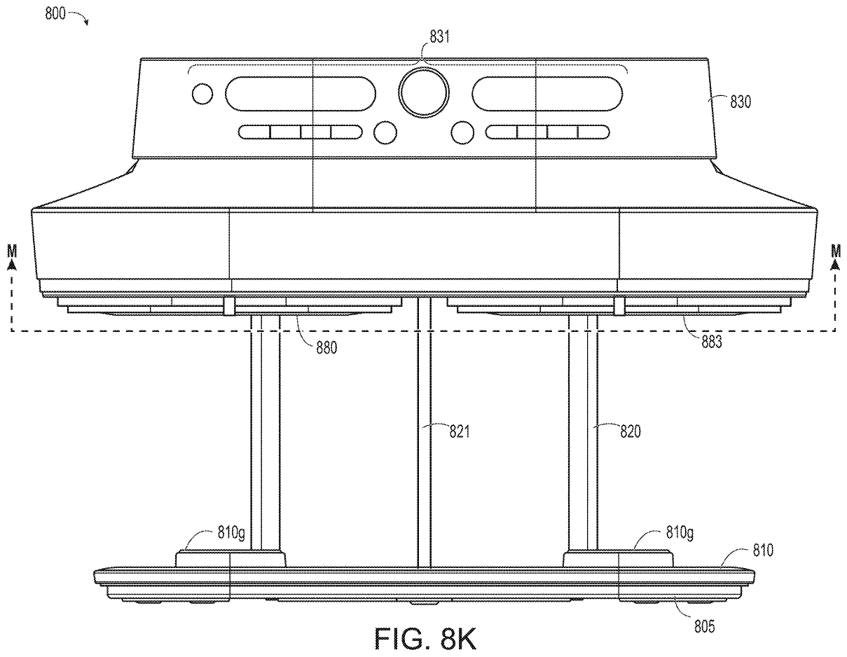

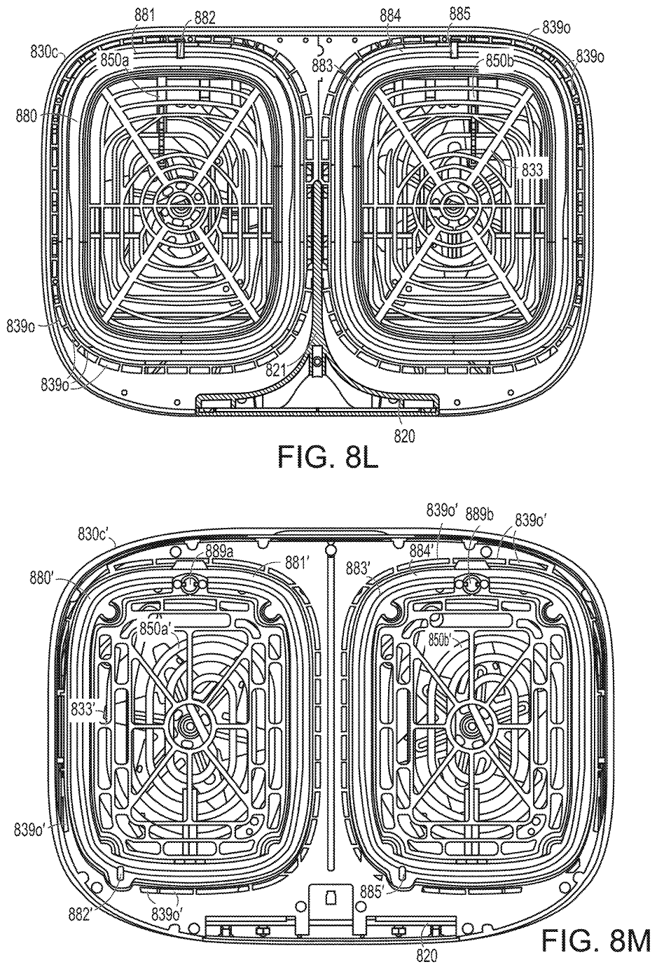

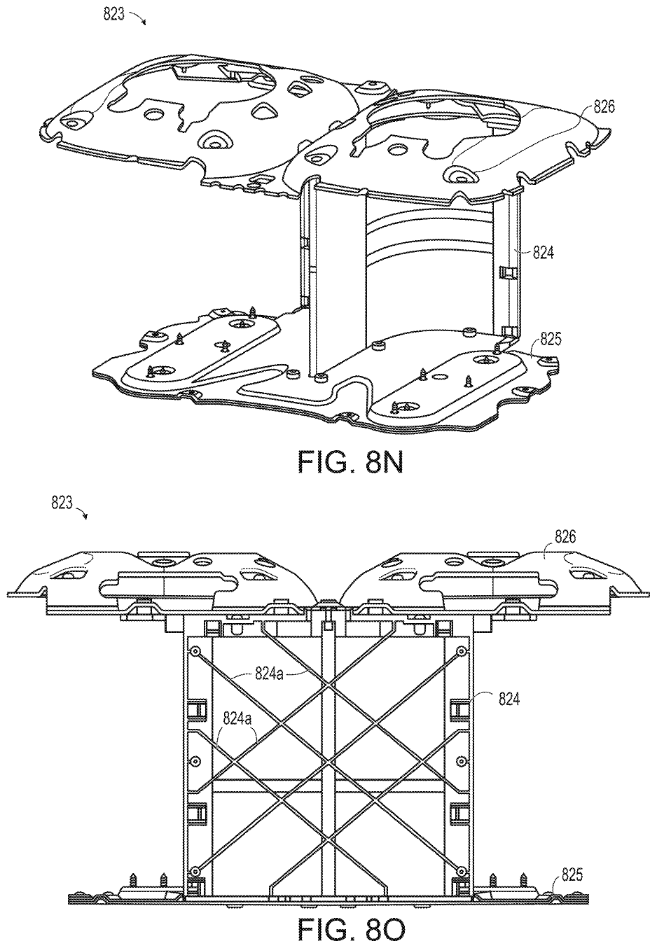

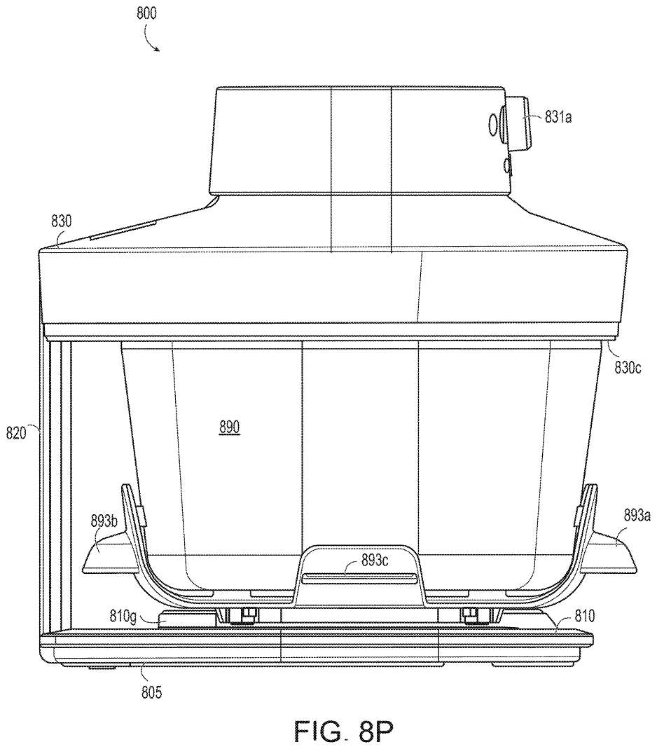

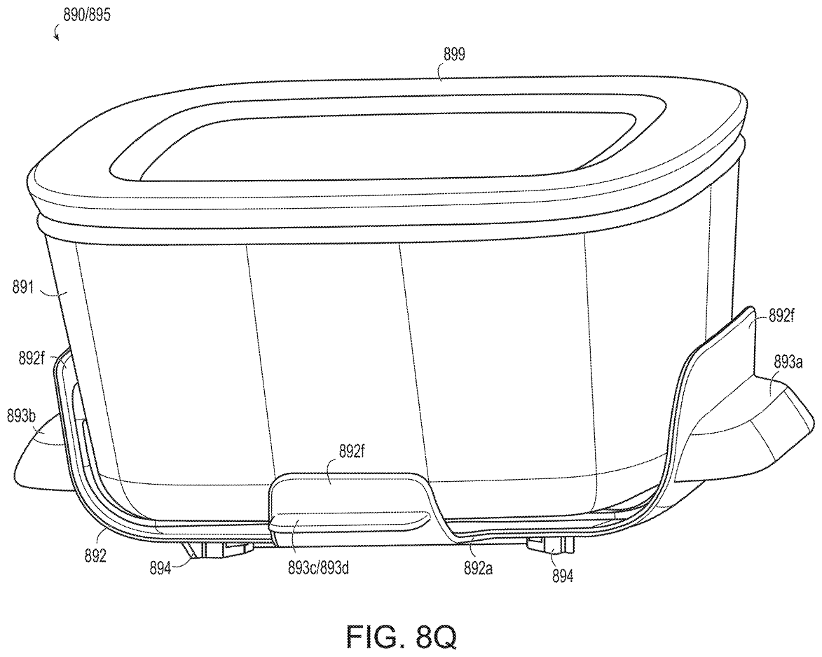

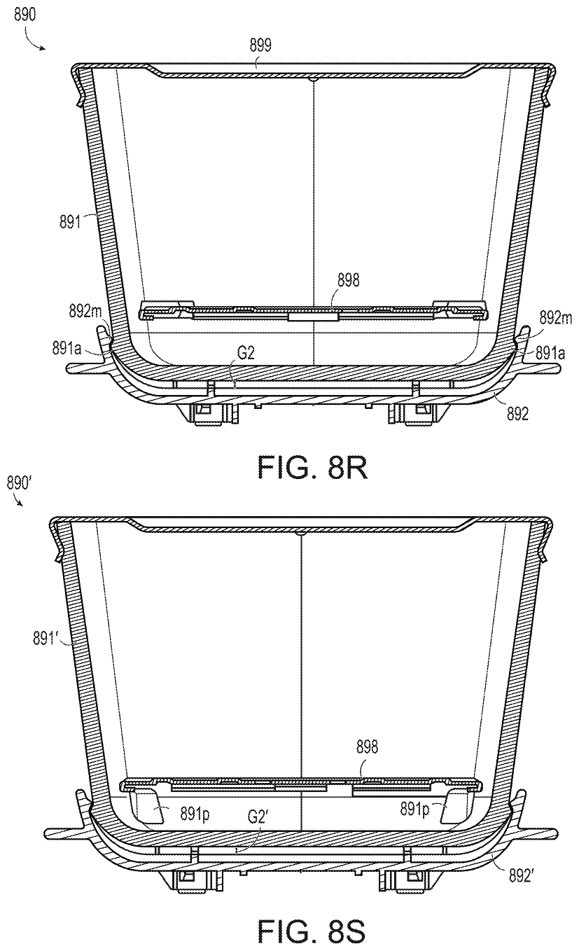

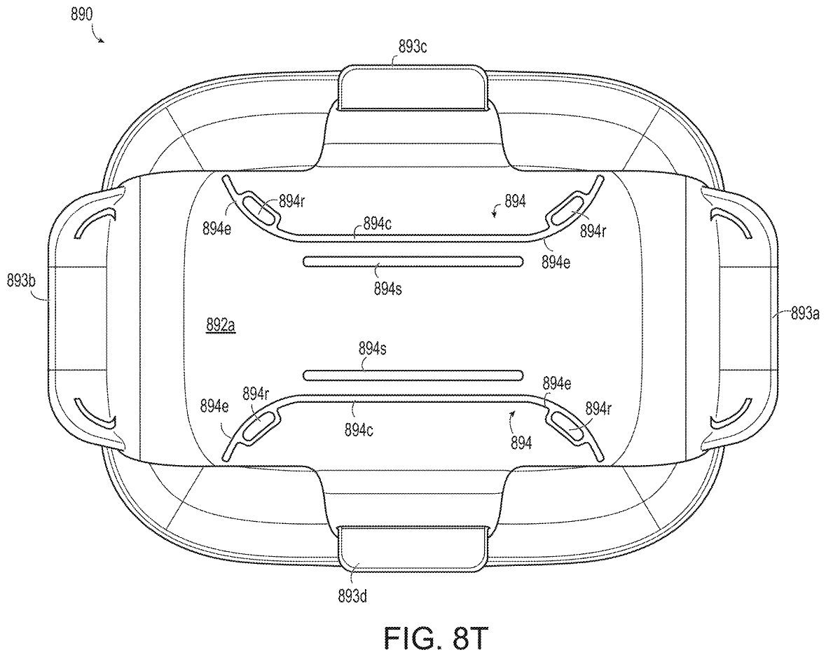

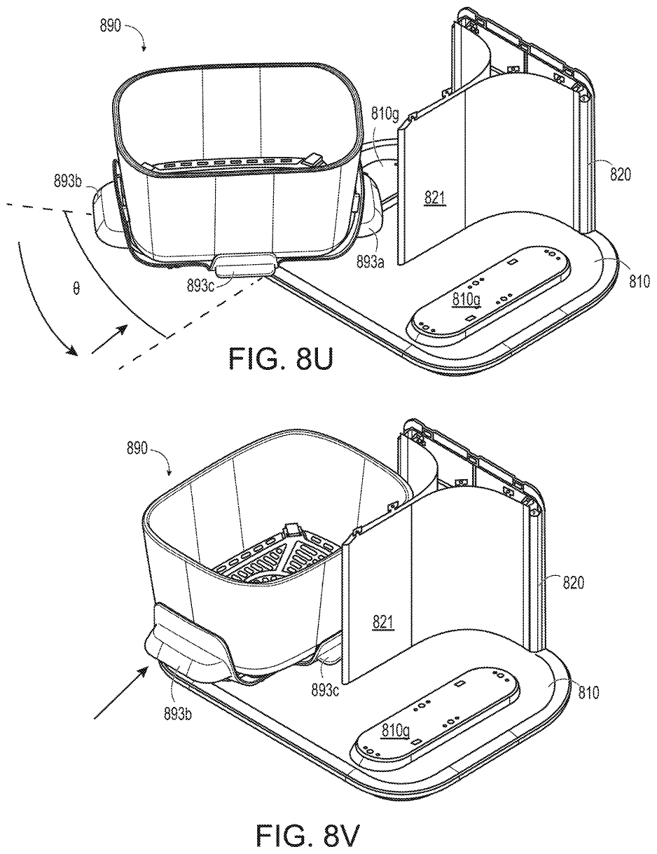

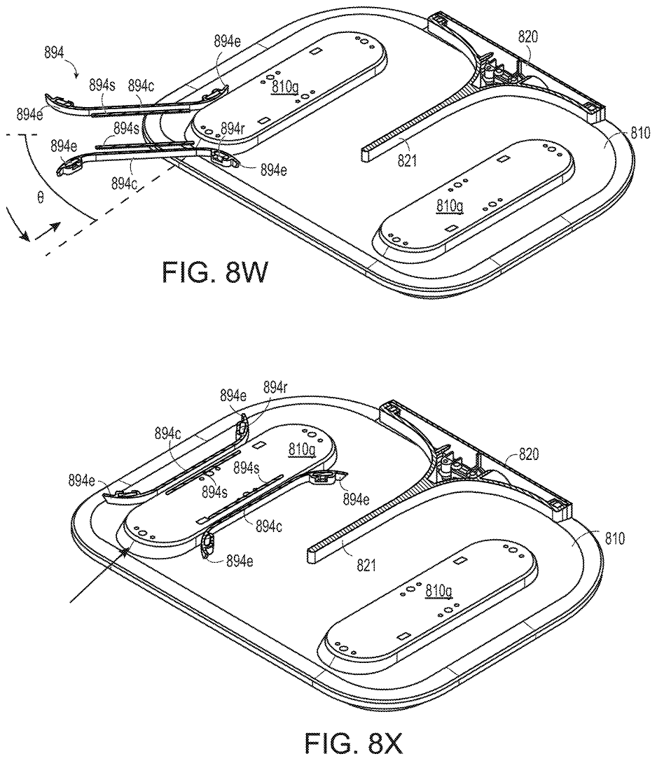

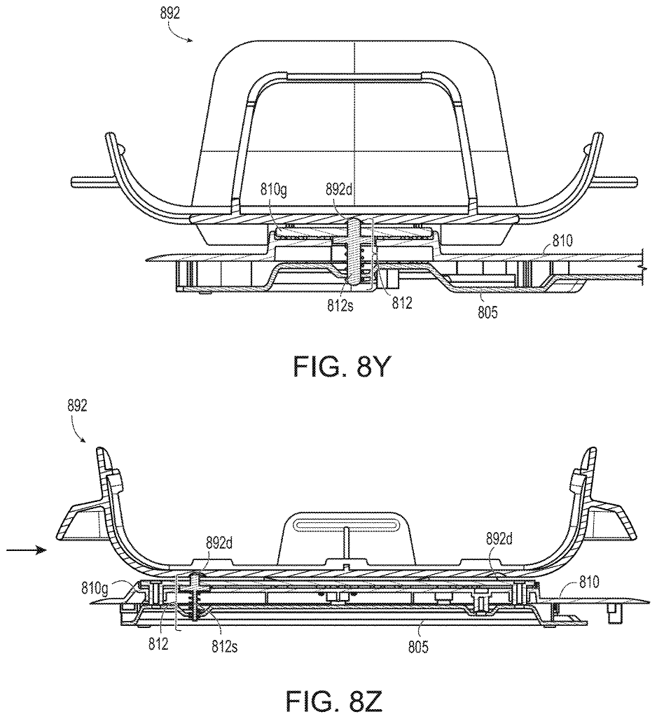

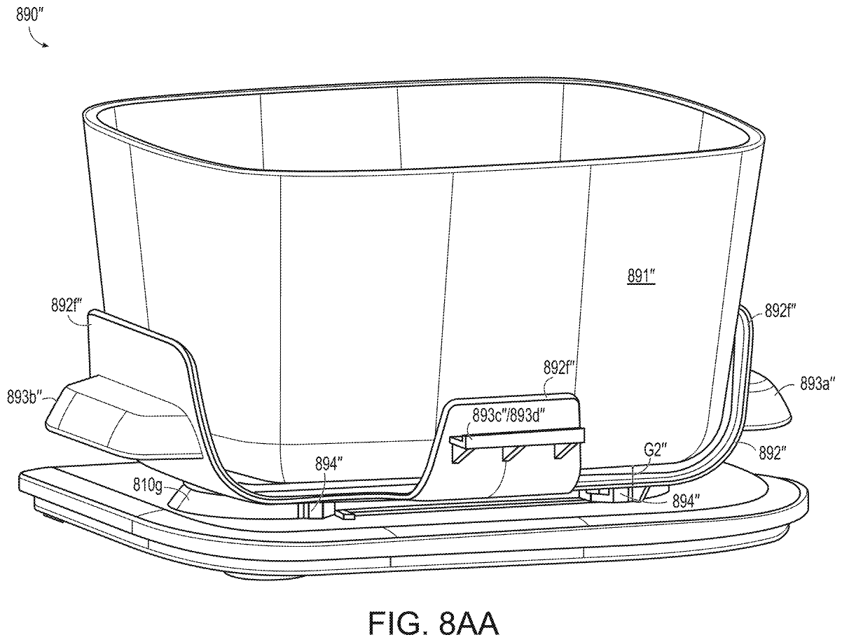

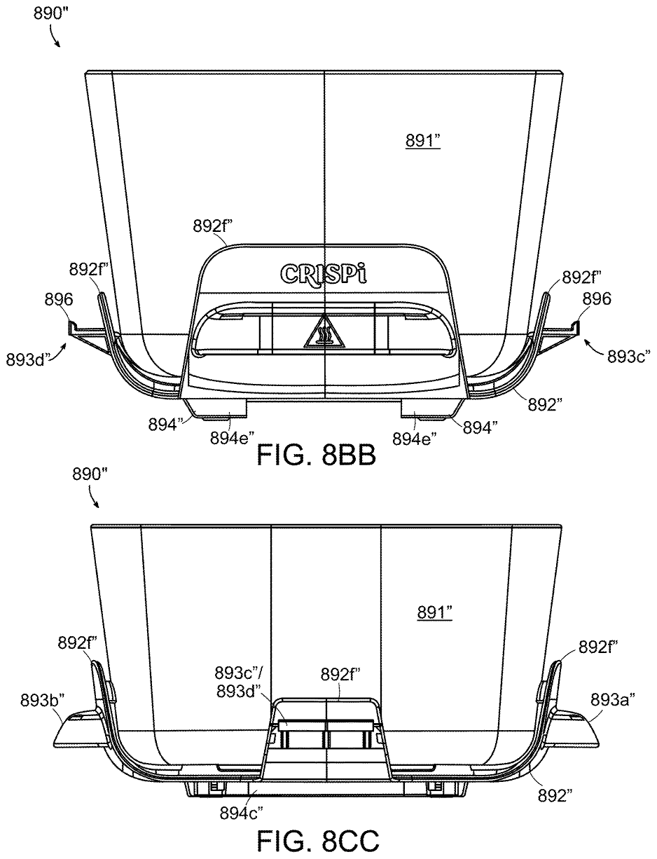

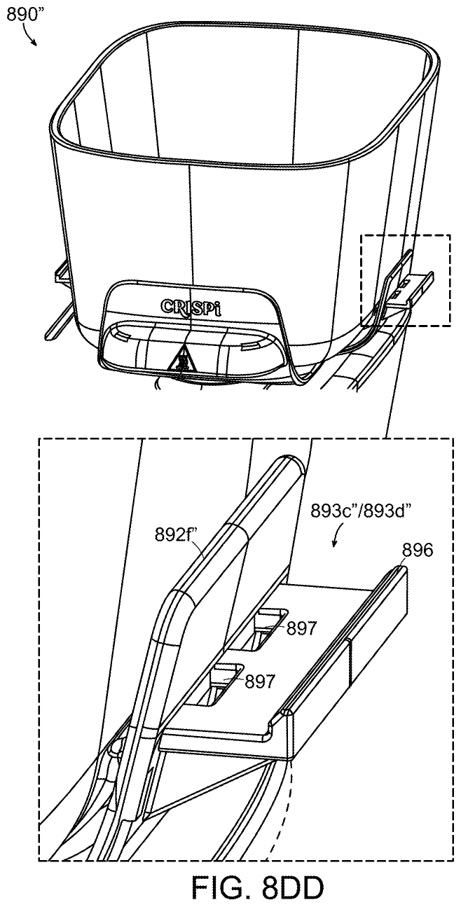

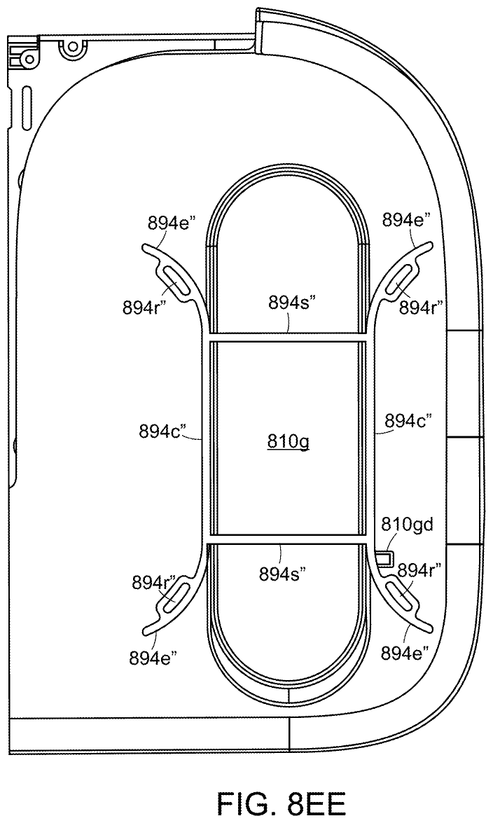

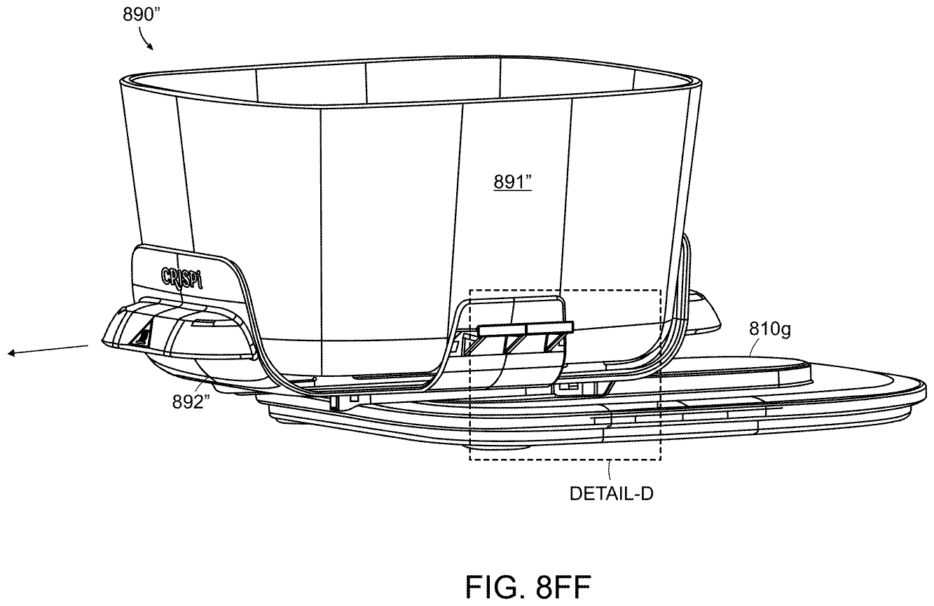

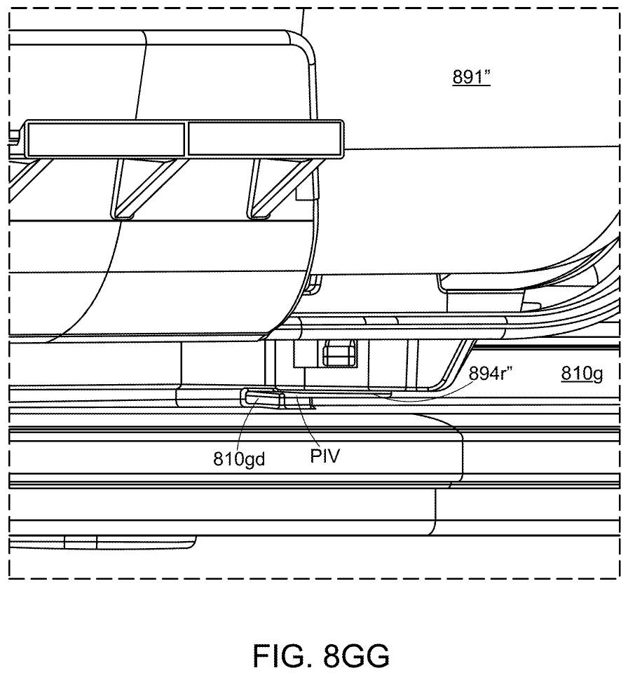

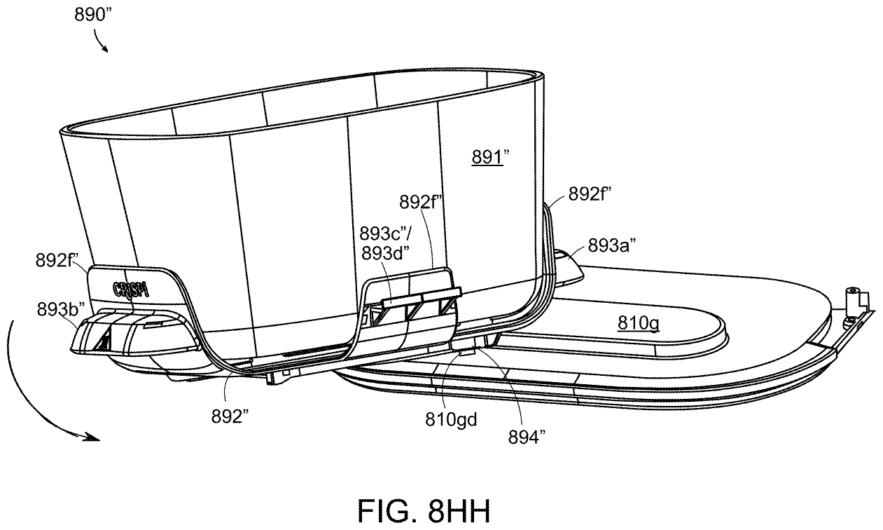

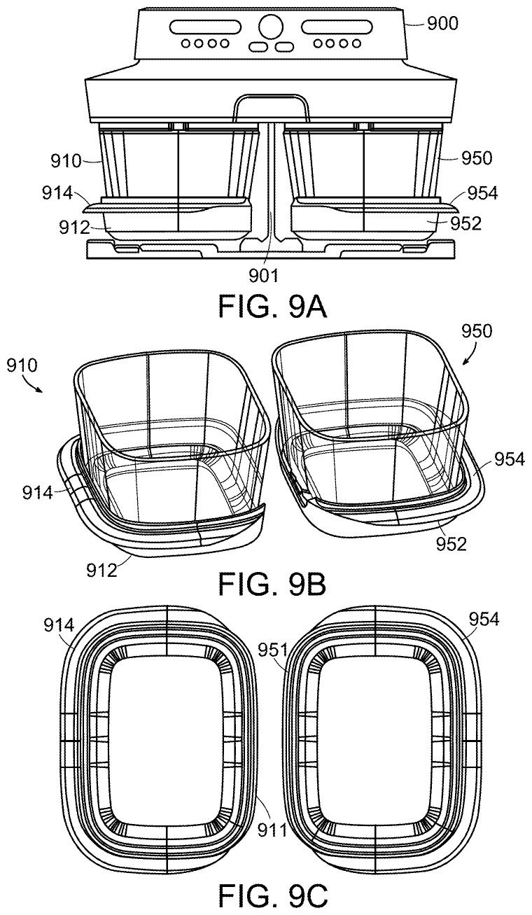

FIG. 1Q is a cross-sectional view of the cooking device of FIG. 1A taken along section B-B of FIG. 1B;

FIG. 1R is a cross-sectional view of the cooking device of FIG. 1A taken along section H-H of FIG. 1E;

FIGS. 2A-2B illustrate respective front and side views of another aspect of a cooking device according to the subject matter described herein;

FIGS. 3A-3B illustrate respective front and side views of another aspect of a cooking device according to the subject matter described herein;

FIGS. 4A-4B illustrate respective front and isometric views of one aspect of a cooking container according to the subject matter described herein;

FIG. 5 is a front view of another aspect of a cooking container according to the subject matter described herein;

FIG. 6 is a front view of another aspect of a cooking container according to the subject matter described herein;

FIG. 7A is a front view of another aspect of a cooking device according to the subject matter described herein;

FIG. 7B is a front view of a variation of the cooking device of FIG. 7A with different sized containers attached thereto and with a platform provided to elevate the smaller container;

FIG. 8A is a front orthogonal view of a cooking system according to the subject matter described herein;

FIG. 8B is a perspective view of another cooking device according to the subject matter described herein;

FIGS. 8C-8D are cross-sectional views of the cooking system of FIGS. 8A-8B taken along section J-J of FIG. 8B depicting the seal assembly with no container attached and the seal assembly with a container attached, respectively;

FIG. 8E is a cross-sectional view of the cooking system of FIGS. 8A-8B taken along section I-I of FIG. 8A depicting the internal components of the cooking system;

FIG. 8F is an enlarged view of DETAIL-C of FIG. 8E, illustrating an exemplary cooling airflow channel of the cooking system;

FIG. 8G is a top view of the cooking system of FIGS. 8A-8B;

FIG. 8H is a partial cross-sectional view of a water flow diversion channel taken along section K-K of FIG. 8G;

FIG. 8I is a cross-sectional view of the cooking system of FIGS. 8A-8B taken along section L-L of FIG. 8G;

FIG. 8J is a perspective view of the cooking system of FIGS. 8A-8B with no containers attached;

FIG. 8K is a front view of the cooking system of FIG. 8J;

FIGS. 8L-8M are alternative variations of the cooking system of FIGS. 8A-8B, taken along section M-M of FIG. 8K;

FIG. 8N is a perspective view of a structural frame of the cooking system of FIGS. 8A-8B;

FIG. 80 is a rear view of the structural frame of FIG. 8N;

FIG. 8P is a side view of the cooking system of FIGS. 8A-8B;

FIG. 8Q is a perspective view of an exemplary container configured to be used with the cooking system of FIGS. 8A-8B;

FIGS. 8R-8S are cross-sectional views of alternative variations of the container of FIG. 8Q:

FIG. 8T is a bottom view of the container of FIG. 8Q;

FIGS. 8U-8X are partial perspective views of an insertion operation of a container into the cooking system of FIG. 8G;

FIGS. 8Y-8Z are front and side sectional views of the base of the container of FIG. 8Q selectively connected to the base of the cooking system of FIGS. 8A-8B;

FIG. 8AA-8DD are perspective, front, side, and detail views, respectively, of another container according to the subject matter described herein;

FIG. 8EE is a partial sectional view of the container of FIG. 8AA-8DD properly seated within a cooking system

FIG. 8FF is a perspective view illustrating an initial removal operation of the container of FIG. 8AA-8DD being removed from a cooking system;

FIG. 8GG is an enlarged view of DETAIL-D of FIG. 8FF, illustrating a contact pivot point formed between a foot of the container of FIG. 8AA-8DD and a guide feature detent of the system during an exemplary container removal operation;

FIG. 8HH is a perspective view illustrating an final removal operation of the container of FIG. 8AA-8DD being removed from a cooking system;

FIGS. 9A-9C illustrate front, isometric, and top views of exemplary container structures as described herein;

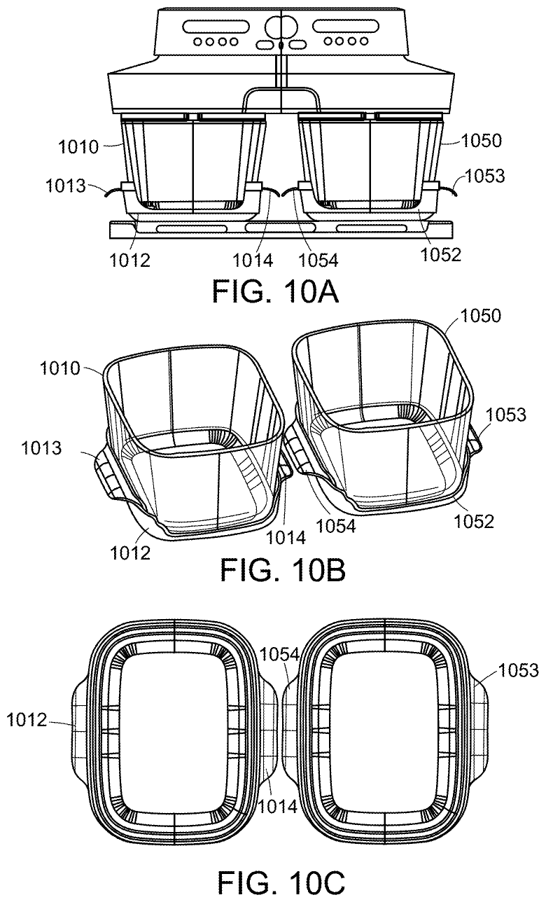

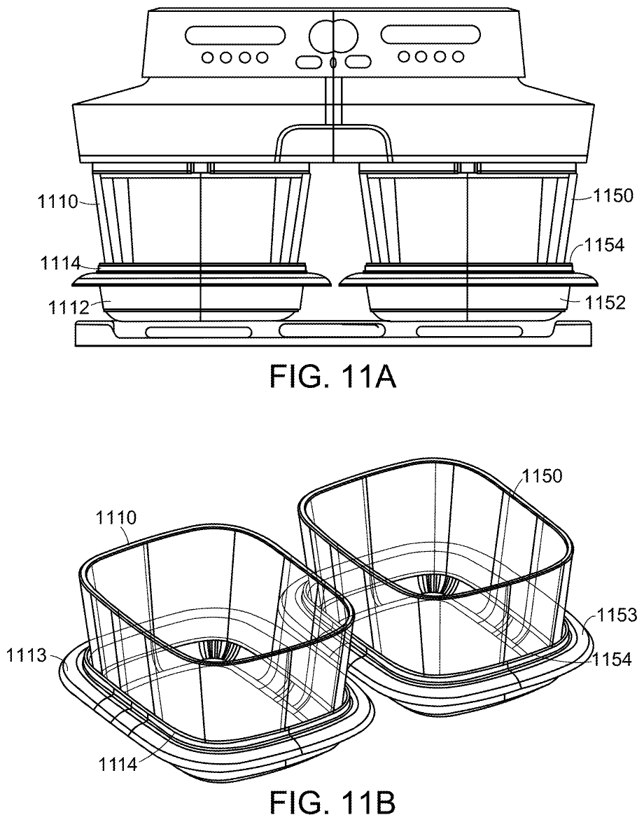

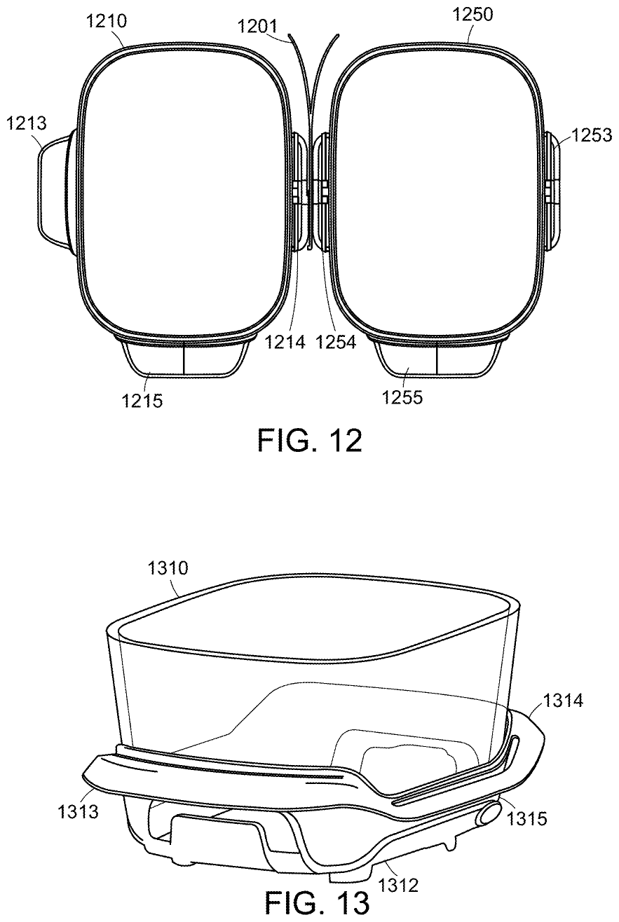

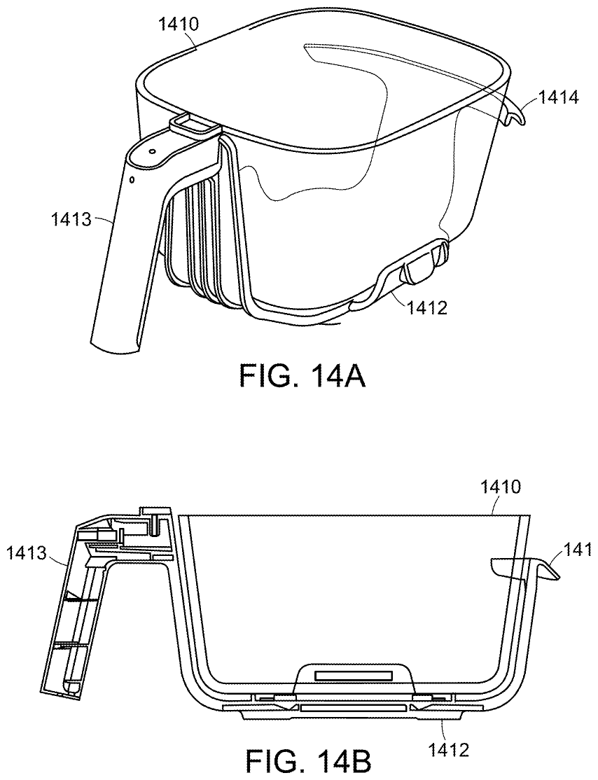

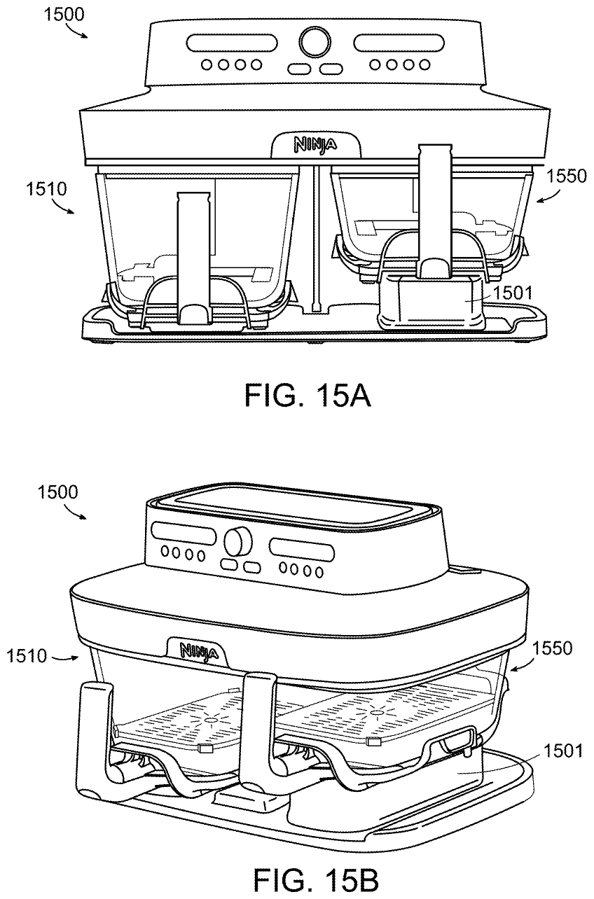

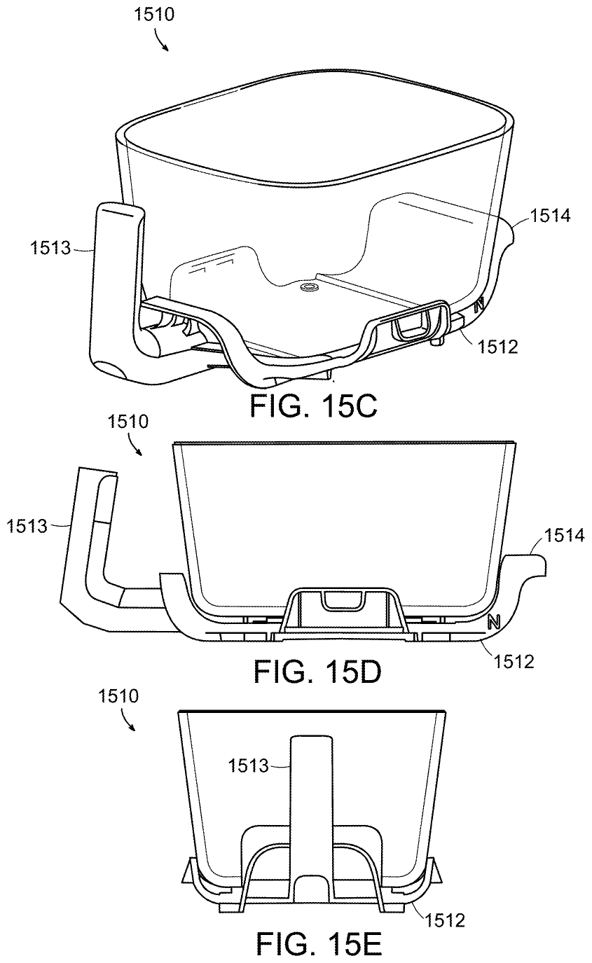

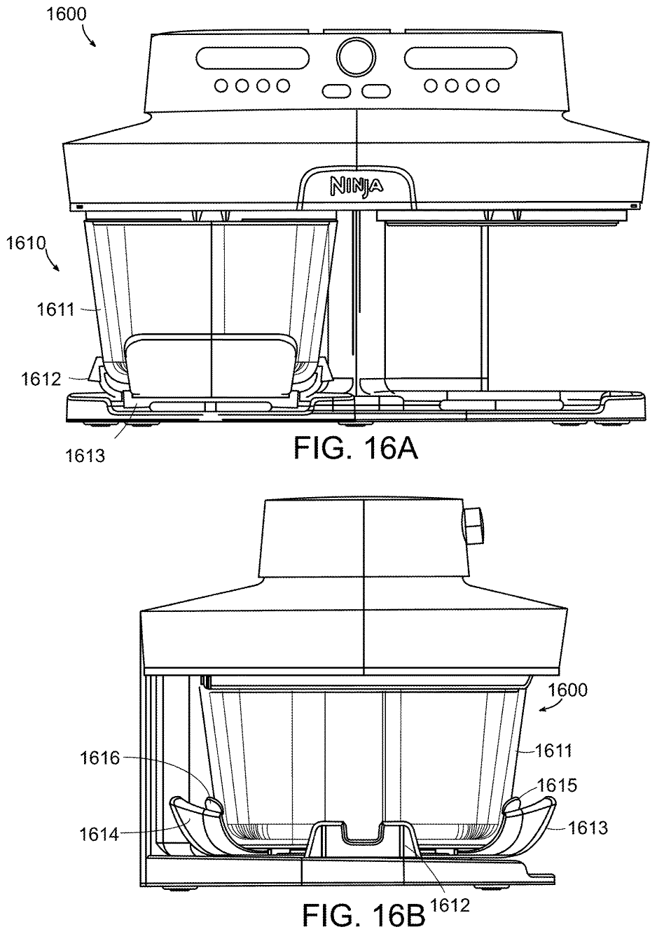

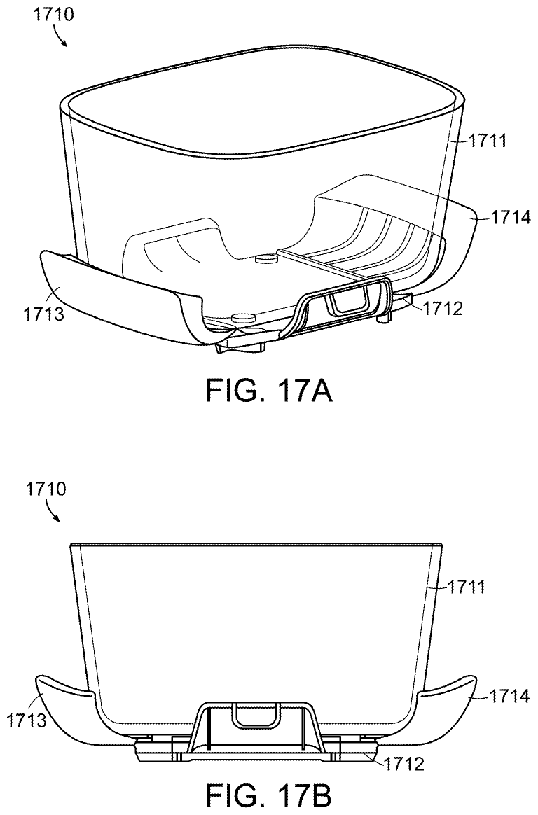

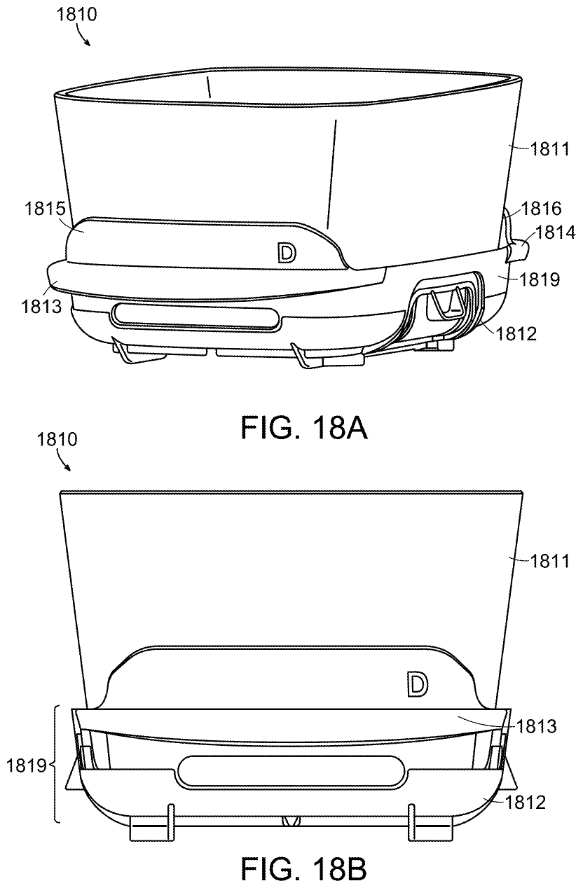

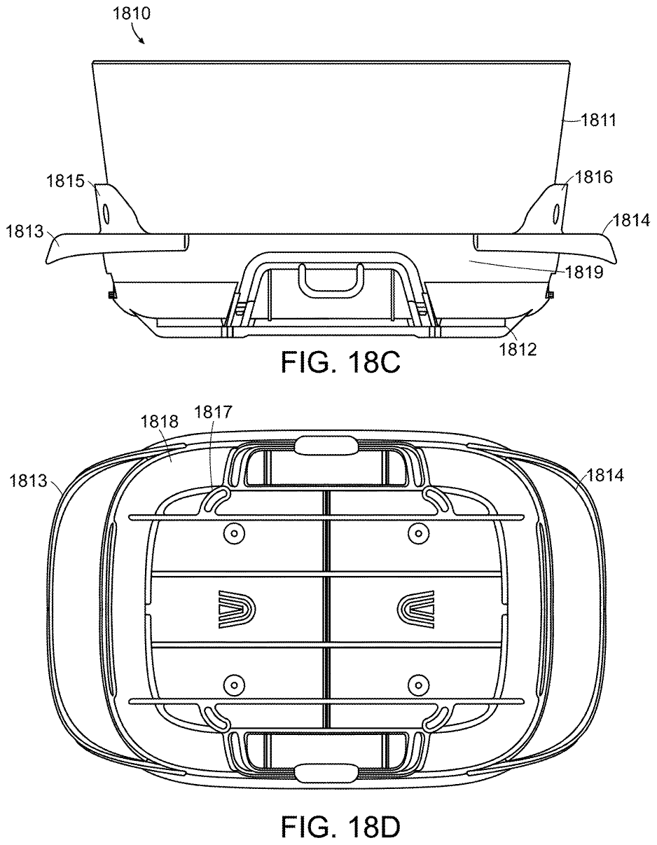

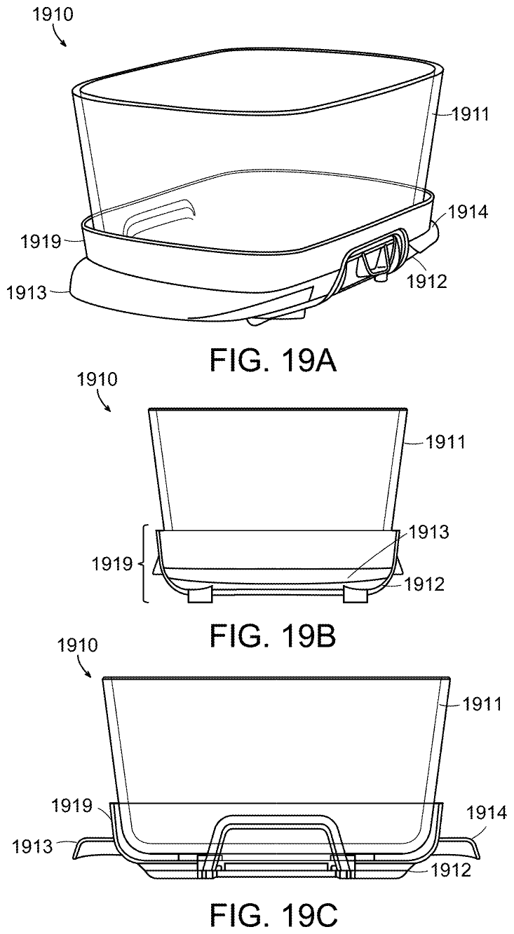

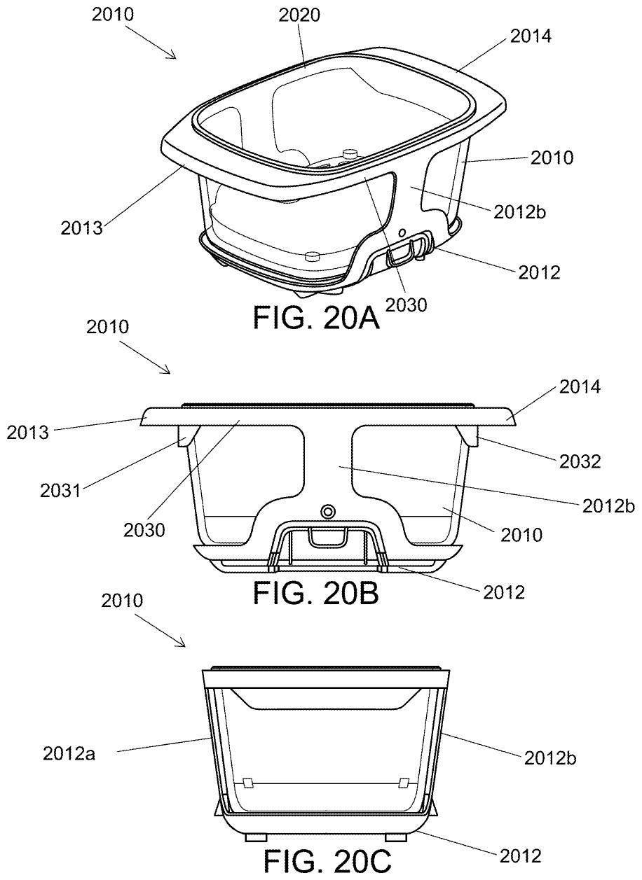

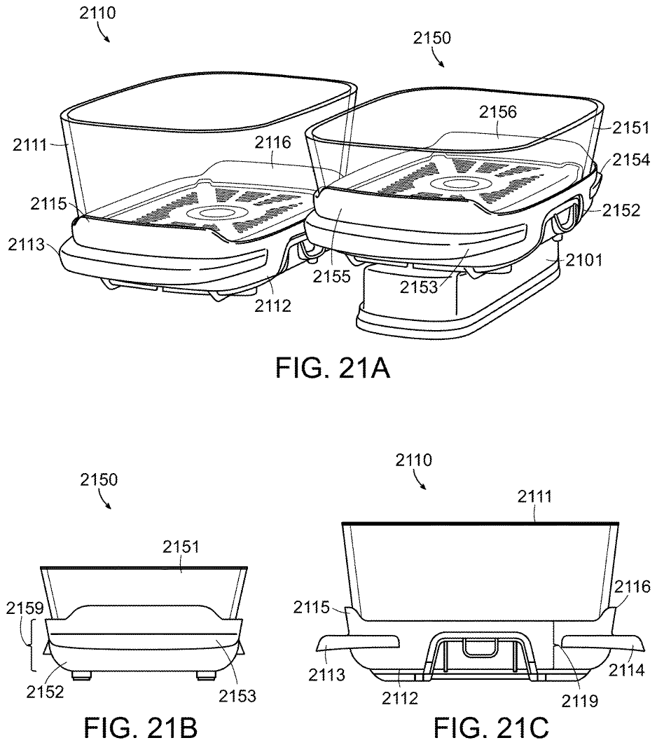

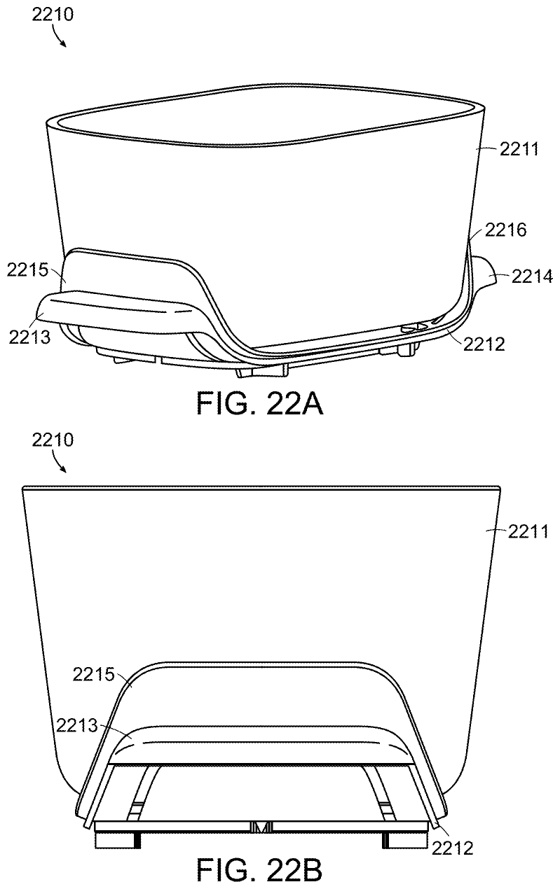

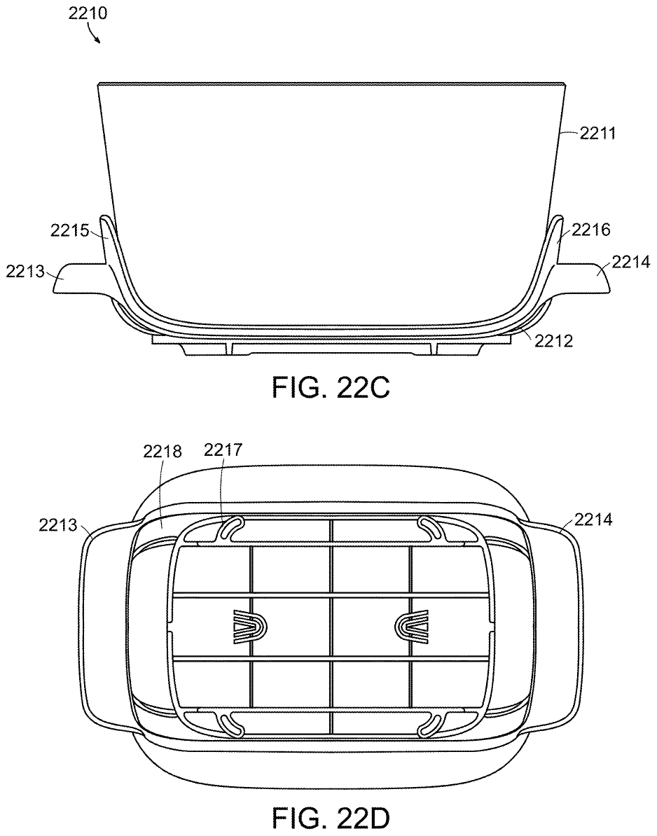

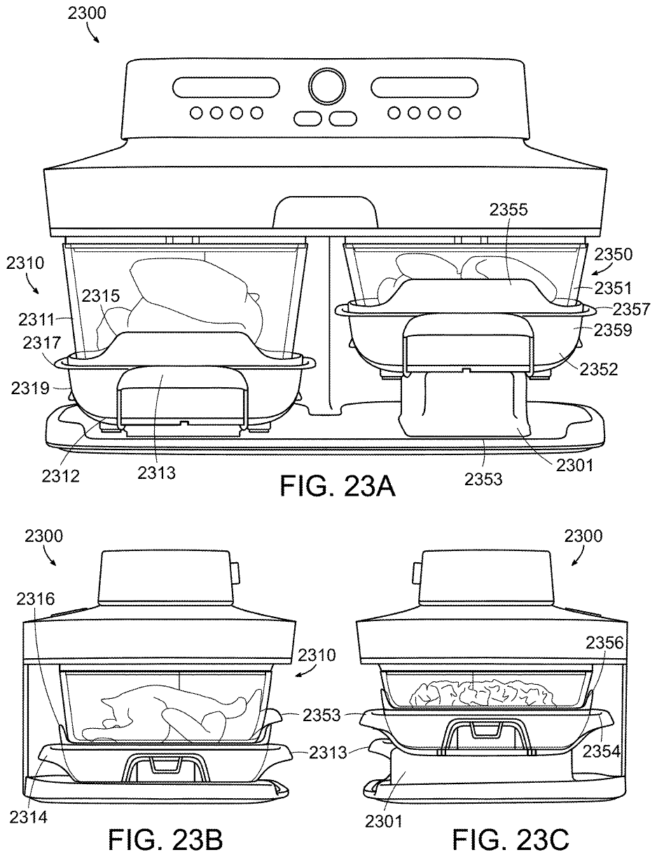

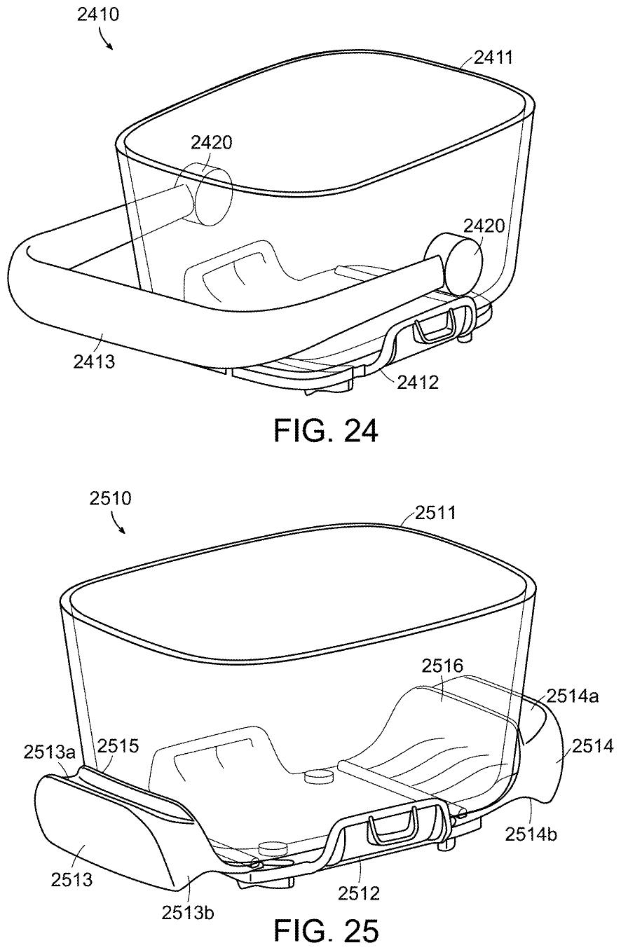

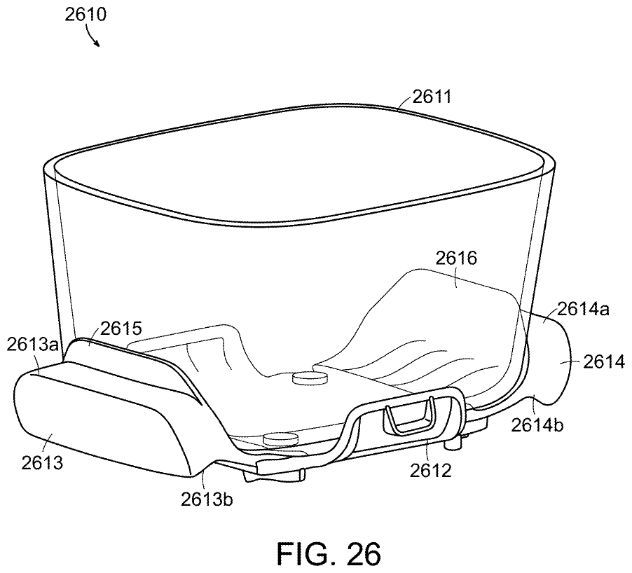

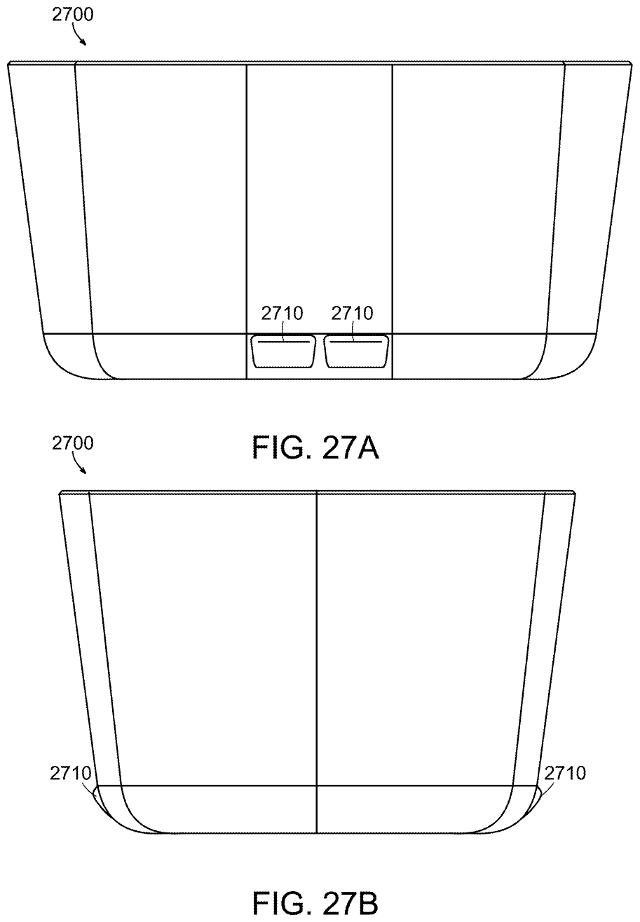

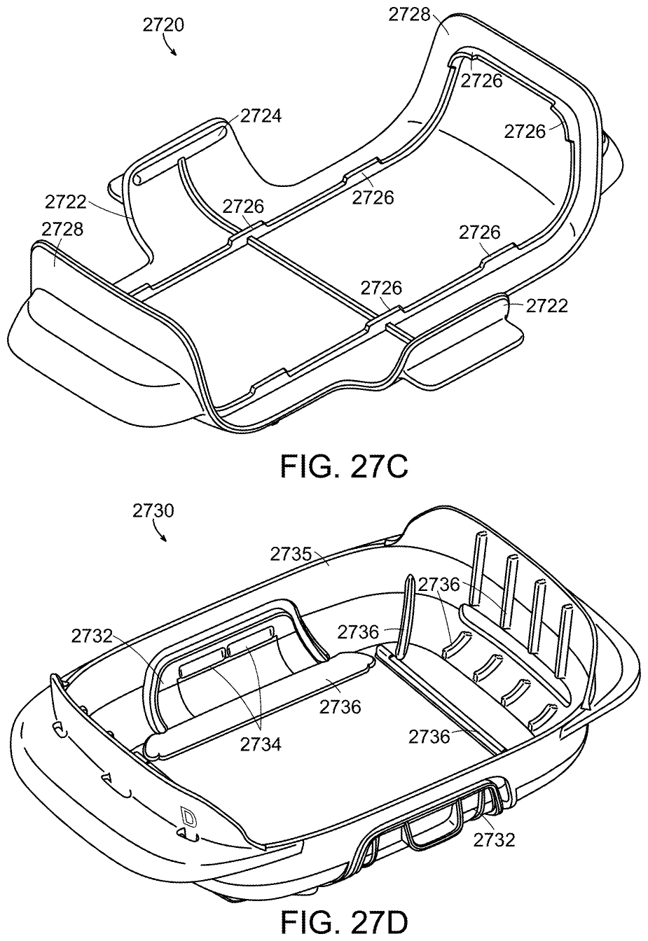

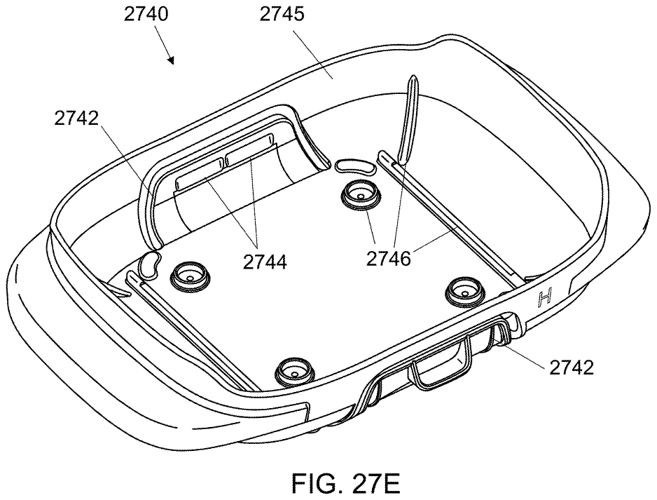

FIGS. 10A-10C illustrate front, isometric, and top views of other exemplary container structures as described herein;

FIGS. 11A-11B illustrate front and isometric views of other exemplary container structures as described herein;

FIG. 12 is a top other exemplary container structures as described herein;

FIG. 13 is an isometric view of another exemplary container structure as described herein;

FIGS. 14A-14B illustrate isometric and side sectional views of another exemplary container structure as described herein;

FIGS. 15A-15B illustrate front and perspective views of a cooking system with other exemplary container structures selectively coupled thereto;

FIGS. 15C-15E illustrate isometric, side, and front views of one of the container structures of FIGS. 15A-15B;

FIGS. 16A-16B illustrate front and side views of a cooking system with another exemplary container structure selectively coupled thereto;

FIGS. 17A-17B illustrate isometric and side views of another exemplary container structure as described herein;

FIGS. 18A-18D illustrate isometric, front, side, and bottom views of other exemplary container structures as described herein;

FIGS. 19A-19C illustrate isometric, front, and sectional side views of another exemplary container structure as described herein;

FIGS. 20A-20C illustrate isometric, side, and front views of another exemplary container structure as described herein

FIG. 21A illustrates a perspective view of other exemplary container structures as described herein;

FIG. 21B illustrates a front view of the smaller container structure of FIG. 21A;

FIG. 21C illustrates a side view of the larger container structure of FIG. 21A;

FIGS. 22A-22D illustrate isometric, front, side, and bottom views of other exemplary container structures as described herein;

FIGS. 23A-23C illustrate front and side views of a cooking system with other exemplary container structures selectively coupled thereto;

FIG. 24 is an isometric view of another exemplary container structure as described herein;

FIG. 25 is an isometric view of another exemplary container structure as described herein;

FIG. 26 is an isometric view of another exemplary container structure as described herein;

FIGS. 27A-27B illustrate side and front views, respectively, of an exemplary container body of a container assembly according to the systems described herein, which is shown separately from a corresponding container base;

FIG. 27C is a perspective view of an exemplary container base of a container assembly according to the systems described herein, which can be coupled to the container body of FIGS. 27A-27B;

FIG. 27D is a perspective view of another exemplary container base of a container assembly according to the systems described herein, which can be coupled to the container body of FIGS. 27A-27B; and

FIG. 27E is a perspective view of another exemplary container base of a container assembly according to the systems described herein, which can be coupled to the container body of FIGS. 27A-27B.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Traditional countertop cooking systems, such as air fryers, typically consist of a heating element and a fan positioned overtop of a cooking cavity of a fixed size that can only accommodate a singular sized cooking vessel. These conventional air fryers have a heating source and an air source located in the housing, above the cooking cavity, with both sources being supplied power for operation, typically by an AC power cord. These fryers also include a cooking basket provided with a handle which can be slidably secured within the cooking chamber to perform a cooking operation. However, due to the cooking basket being uniquely sized to fit in the cooking cavity, users often are required to remove food from any container in which it was previously stored and place the food into the cooking basket for cooking. Additionally, any food that not being consumed after cooking then has to be removed from the cooking basket and placed into a separate container for storage, which results in extra dishes having to be cleaned. Usually, the food basket is a large, heat conductive drawer that can accommodate a large volume of food. However, not all users require the large volume that traditional air fryers offer, if they are only cooking a small meal. Furthermore, these conventional air fryers can take up a lot of countertop space and can be clunky and aesthetically unappealing.

The present cooking devices disclosed herein look to combine both the cooking and storage aspect of a food product, while also allowing for versatility in the size of container that can be used for cooking. The cooking systems described herein are also much more sleek than conventional air fryers, providing a much more aesthetically modern look on a countertop. The present devices are compatible with a variety of different sized containers which can be utilized for both cooking of a food product, and storage of the food product. In order to achieve this efficiency, the variety of containers used are made from a thermal shock-resistant material such as borosilicate glass. Further, the food product placed in the containers for a cooking process can remain in the container after a cooking process without the need to be removed prior to storage. Instead of removing the food and cleaning the container, a user can use lids which are correspondingly sized to the openings on the containers, to seal the food product within the containers so that the containers can be easily transported.

The cooking systems described herein may comprise a cooking device and at least one vessel/container. The cooking devices (e.g., air fryers) may comprise a base and a housing which includes at least one heating element and at least one air movement device. The platform can be positioned on a countertop and includes a base and a spine projecting upward from the base, the spine being arranged to couple to the housing such that a front of the housing is cantilevered over the base with a bottom surface of the housing being suspended over the countertop. A container of the cooking system can be selectively secured to the cooking system such that an opening of the container is sealed with the bottom surface of the housing. During a cooking operation, the at least one air movement device draws air into the housing and directs the air over the at least one heating element and into a volume of the container to heat food within the container. The heating element may be configured to convert electrical energy into thermal energy. For example, the cooking device may further comprise an electrical conduit (e.g., wire) that may be electrically connected to the heating element. The electrical conduit may also be configured to couple to a power source, such as a wall outlet. The air movement device(s) facilitate air flow around the heating element. For example, the air movement device(s) pull in relatively cool air from an external environment and push the air through one or more fluid conduits such that the air flows around the heating element. The heating element may transfer heat to the air such that the now-heated air may flow into the vessel. Accordingly, the air movement device(s) may facilitate convective heat transfer to any contents within the vessel.

Accordingly, embodiments of the cooking systems and methods described herein advantageously provide a system that can reheat and/or cook quickly using forced convection heat. Additional and/or alternative aspects of air frying technology are described in U.S. Pat. Nos. 11,619,394 and 11,490,761, and U.S. Patent Application Nos. 63/516,980, 63/616,182, 63/670,400, Ser. No. 18/883,692, Ser. No. 18/883,517, and Ser. No. 18/883,593, each of which are incorporated in their entirety by reference herein.

The overall structure and functionalities of the cooking systems described herein will be described in detail below, with reference made to FIGS. 1A-1R. FIG. 1A is an isometric view of one embodiment of a cooking system 100 according to the systems and methods described herein. As shown in FIG. 1A, the cooking system 100 includes a platform 105, a housing 130, a container holder 140 and at least one container 200. The housing 130 can be formed from a thermally nonconductive material, such as plastic. The housing 130 includes an input interface 131 on a top surface of the housing 130. The input interface 131 comprises a plurality of buttons/knobs 131a configured to allow a user to control the cooking device 100. The input interface 131 is connected to a control unit (not shown) arranged within the cooking device 100. For example, a user may control a power status (e.g., on, off), a cooking temperature, a power setting, a cooking mode (e.g., Airfry, Max Crisp, Reheat, etc.), a cooking time, or a combination thereof via the input interface 131. In some aspects, the input interface 131 can also include a digital screen 131b which can show a cooking temperature or other cooking information, and which can be illuminated by one or more lights (not shown) for user visibility. Additionally, in some aspects, a top rim 130r of the housing 130 can also be provided with a light strip (not shown) to provide additional aesthetic illuminating functionalities.

The platform 105 is arranged to be positioned on a countertop and includes a base 110 and a spine 120 projecting upward from the base 110 and coupling the housing 130 to the base 110. The base 110 also includes a cutout 111 for receiving the container holder 140 when a large sized container is being used. In some aspects, the base 110 and/or the spine 120 could also include a cooling fan (not shown), which can provide direct cooling to a base/side of the containers during cooking operations.

In some aspects, the container holder 140 can be selectively positioned at a variety of heights above the base 110 to accommodate a variety of container sizes, as discussed in greater detail below. Furthermore, the base 110 and/or the container holder 140 can be provided with weight sensors to both detect the presence of a container and to sense a weight of the container, which can be used by the controller, for example, to modify the cooking mode of the cooking operation. In some aspects, a top surface of the base 110 can be pitched at a slight angle from a front of the base 110 to a back of the base 110 such that the back of the base 110 is elevated a greater distance from the countertop that the front surface of the base. In this case, the cutout 111 can be parallel to the countertop such that the container holder 140 is horizontal when received in the cutout 111, as will also be discussed in greater detail below.

In some aspects, the at least one container 200 can include at least one of a small container 200. The cooking system 100 can also accommodate a medium container 300, and a large container 400, which are shown and described in greater detail below in reference to FIGS. 2A-6. The container 200 can be selectively coupled to the cooking system 100 by inserting the container 200 along a direction X such that the container 200 is securely positioned between the container holder 140 and a bottom surface 130c of the housing 130. Similarly, the container 200 can be selectively removed from the cooking system 100 by reversibly removing the container 200 along the direction X.

As shown in FIG. 1A, the container 200 can include a container body 205, and a container base 210 which includes handles 211 and feet 212, the details of which are described in greater detail below. By having the housing 130 only coupled to the platform 105 at a back of the housing by the spine 120, lateral sides of the container 200 are exposed when the container 200 is coupled to the cooking system. This advantageously allows for a user to grip the container with two hands, using the handles 211, to selectively couple/remove the container 200 from the cooking system 100, which can be beneficial in cases where the container 200, with food therein, is heavy.

As shown in FIG. 1B, when the container 200 is coupled to the cooking system 100, the feet 212 of the container base 210 can be positioned laterally outside of the container holder 140 such that movement of the container 200 in a lateral direction Y is restricted. As shown in FIG. 1C, a maximum lateral width W1 of the housing 130 is greater than a lateral width W2 of the spine 120. Additionally, the spine 120 is arranged to project upward from a back of the base 110 to couple the back of the base 110 to a back of the housing 130 such that the housing 130 is cantilevered over the base 110. This design provides the cooking system 100 with an aesthetically appealing look that creates the illusion that the housing 130 is floating over the countertop. Additionally, this design provides for a less clunky cooking system compared to conventional cooking systems. A front face of the spine 120 includes a plurality of angled slots 121, 122 and a base slot 123 which are each provided at different heights above the base 110. Each of the plurality of angled slots 121, 122 and the base slot 123 are arranged to selectively receive a tab of the container holder 140 to position the container holder at the different heights above the base 110 depending on a size of the container 200 being used for the cooking operation, as described in greater detail below. In some aspects, the plurality of angled slots 121, 122 can be substantially rectangular, however other shapes for the slots are also realized. For example, as shown in FIG. 1C, the container holder 140 is positioned in the angled slot 121 such that a top surface of the container holder 140 is positioned a first distance below a first seal provided on the bottom surface 130c of the housing 130 as discussed in greater detail below. In some aspects, a lateral width of the container holder can be substantially the same as the lateral width W2 of the spine 120 as shown, however it is also realized that the lateral width of the container holder 140 could be wider or narrower than the width W2 of the spine 120. In some aspects, as shown in FIG. 1C, the container holder 140 can further include one or more detent pins 141 which can protrude from a top surface of the container holder 140 and can be arranged to releasably engage with detents (e.g., recessed slots or holes) provided in the bases of any of the containers described herein to lock or index containers in place during cooking operations. In some cases, the detent pins 141 may be spring-loaded to allow for the pins to move out of the way of the containers as they are inserted into the cooking system 100 and then snap into releasable engagement with detents provided in the bases of any of the containers herein to lock the container in place. In some aspects, as shown in greater detail below, the detent pins 141 may only interact with a base of the large container 400 and may be unused during cooking operations with the small and medium containers 200/300.

FIG. 1D is a side view of the cooking system 100 of FIG. 1A with the container holder 140 and the container 200 attached. As shown in FIG. 1D, the spine 120 is arranged to project upward from a back of the base 110 to couple the back of the base 110 to a back of the housing 130 such that the housing is cantilevered over the base 110 with the top surface of the container holder 140 positioned the first distance below the seal provided on the bottom surface 130c of the housing 130 (distance D1 shown in FIG. 1F). In some aspects, the spine 120 can be arranged to project from the base at a slight angle from a vertical direction. Additionally, in some aspects, sidewalls 206 of the container body 205 can be pitched at an angle which corresponds to the angle at which the spine 120 projects from the base.

FIG. 1F is a cross-sectional view of the cooking device 100 taken along section C-C of FIG. 1C. As shown in FIG. 1F, the container holder 140 can include a tab 142 which is arranged to be securely positioned in the angled slot 121 such that the container holder 140 is cantilevered over the base 110 with the top surface of the container holder 140 positioned the first distance D1 below the first seal provided on the bottom surface 130c of the housing 130. The container holder 140 can be decoupled and recoupled from the spine 120 by reversibly lifting a cantilevered end of the container holder 140 in a direction Z and pulling the container holder 140 in a direction X′ such that the tab 142 can be removed from the angled slot 121. As shown in FIG. 1F, and as mentioned above in reference to FIG. 1A, the base 110 also includes a cutout 111 for receiving the container holder 140 when a large sized container is being used and the top surface of the base 110 can be pitched at a slight angle from a front of the base 110 to a back of the base 110 such that the back of the base 110 is elevated a greater distance from the countertop that the front surface of the base. In this case, the cutout 111 can be parallel to the countertop such that the container holder 140 is horizontal when received in the cutout 111.

FIG. 1G is an enlarged view of DETAIL-A of FIG. 1F. As shown in FIG. 1G, openings of each of the plurality of angled slots 121, 122 can be pitched at an angle from horizontal and a bottom side of the tab 142 can be pitched at an angle reciprocal to the angle. Each of the plurality of angled slots 121, 122 can also include a horizontal bearing surface 121a, 122a arranged to engage the top surface of the tab 142 when the tab 142 is inserted into the slots to provide direct resistance to the moment forces caused by the cantilevered container holder 140 to maintain a horizontal projection of the container holder 140 as it extends over the base 110. By providing the slots 121, 122 with the horizontal bearing surfaces 121a, 122a and the openings of the slots 121, 122 and the bottom side of the tab 142 with reciprocal angled pitches, the container holder 140 can be securely retained within the plurality of angled slots 121, 122 while maintaining a horizontal projection of the container holder 140 as it is cantilevered over the base 110. This design advantageously allows for the container(s) 200 of the cooking system 100 to be supported by the container holder 140 without the risk of the container holder 140 falling off the spine 120 when the container is removed from the cooking system 100. In other aspects, the tab/slot connection between the container holder 140 and the spine 120 can be more like a French cleat connection. As further shown in FIG. 1G, the top surface of the cutout 111 can be horizontal to the countertop and the base slot 123 can include a shelf surface 123a shaped corresponding to the bottom surface of the tab 142. The shelf surface 123a can be arranged to receive the bottom surface of the tab 142 when the container holder 140 is laid into the cutout 111. Accordingly, when the container holder 140 is laid into the cutout 111, the top surface of the container holder 140 is elevated from the top surface of the base 110. In case where a large container is being used with the system (e.g., container 400, as described below), feet of the large container can be positioned laterally outside of the container holder 140 such that movement of the large container in a lateral direction is restricted, similarly to as described above in reference to FIG. 1B. In other aspects, the container holder 140 can be omitted during a cooking operation using the large container 400 and the large container 400 can simply be received by the cooking system 100 between the base 110 and the bottom surface 130c of the housing 130. Additionally, in other aspects, rather than coupling to the spine 120, the container holder 140 can be a container platform having a greater height than that of the container holder 140 and can be arranged to slide into the cutout 111 without coupling to the spine 120 and to act as a platform to support either of the small or medium containers 200, 300.

FIG. 1H is a cross-sectional view of the cooking device 100 taken along section D-D of FIG. 1C. As shown in FIG. 1H, the spine 120 can also be provided with at least one bracing beam 124. In some aspects, the at least one bracing beam 124 can be provided laterally outside of the plurality of the plurality of slots 121, 122 and can be constructed from a material with a yield strength of 200 MPa. For example, in some aspects, the at least one beam 124 can be a uniform beam made from steel. As shown in FIG. 1H, the at least one beam 124 can follow the curvature of the platform 105, extending from the front end of the base 110 to that back end of the base 110, up the spine 120, and rigidly coupling to a structural plate 132 provided in the housing 130. In some aspects, the structural plate 132 can extend throughout the housing 130, acting as a structural frame and providing rigidity to the cantilevered housing 130. In some aspects, the structural plate 132 can be made from a material similar to the material of the at least one beam 124. It is also realized that the at least one beam 124 and the structural plate 132 could be formed as one uniform piece.

FIG. 1I is a cross-sectional view of the cooking device 100 taken along section F-F of FIG. 1D. As shown in FIG. 1I, in some aspects, the at least one beam 124 of the spine 120 can include a pair of parallel beams 124a, 124b. The pair of beams 124a, 124b can be rigidly coupled to the structural plate 132 via bolts 124c or via a welded connection, or any combination thereof. However, as mentioned above, it is also realized that the pair of beams 124a, 124b and the structural plate 132 could be formed as one uniform piece. Additionally, in some aspects, the structural beams can be coupled to the structural plate 132 via a hinged connection (not shown), or the like, which can allow for the entirety of the housing 130 to be pivoted upward relative to the base 110. This hinged design may be beneficial to make the base 110 and the bottom surface 130c of the housing more accessible to a user for in cleaning, or to allow the cooking system 100 to become thinner for storage purposes. In some aspects, as shown in FIG. 1I, the spine can also include a slot plate 125 mounted to the spine 120, laterally inside of the pair of parallel beams 124a, 124b, and arranged to provide rigidity to the plurality of slots 121, 122. For example, in some aspects, the horizontal bearing surfaces 121a, 122a of the plurality of slots 121, 122 can be formed in the structural plate 125. The pair of parallel beams 124a, 124b can be constructed from a material with a yield strength of 200 MPa in order to rigidly support the housing 130, similarly to as described above.

Turning to the housing 130, as illustrated in FIG. 1F, the housing 130 can be divided into an upper portion 130a and a lower portion 130b, which can be separated by a partition/radiation shield 134. As shown, the partition/radiation shield 134 can include two layers of material (upper layer 134a, and lower layer 134b) separated by an air gap to provide desirable insulative properties between the upper portion and the lower portion of the housing 130. The cooking system 100 also includes a heating element 150, a heating fan 160, a cooling fan 165, a temperature sensor (not shown), and electronics components (e.g., PCBA) 170 arranged to provide power to the heating element 150, heating fan 160, cooling fan 165, and temperature sensor. In some aspects, the cooling fan 165 and electronics components 170 can be arranged in the upper portion 130a of the housing 130 and the heating element 150 and the heating fan 160 can be arranged in the lower portion 130b of the housing, fully separated by the radiation shield 134. The electronics components 170 can include a controller arranged to control operations of the cooking system 100. The electronics components 170 can also provide power to the heating element 150 and can also include a motor 171 that powers the heating fan 160 and cooling fan 165. The motor 171, heating fan 160, and cooling fan 165 may together define an air movement device coupled together by a common axle 172, which is driven by the motor 171. The heating fan 160 can be a centrifugal fan or a stirrer fan which provides more efficient heat transfer during cooking operations. However, other commonly known fan types for the heating fan 160 are also realized. In some aspects, the temperature sensor can be a NTC or bimetallic temperature sensor which can shut off the heating element 150 in the event of overheating. In some aspects, the cooking system can further include a container temperature sensor (not shown), which can also be a NTC or bimetallic temperature sensor. In a case where a container temperature sensor is included in the cooking system 100, the container temperature sensor can be arranged to measure a temperature of the glass body of the container that is being used for the cooking operation and can communicate the temperature readings to the controller of the system. When the temperature of the glass rises above a predetermined threshold, the controller can be arranged to throttle the heating element 150 to allow for the glass of the container to cool.

The heating element 150 can be a radiative or convective heat source that, in combination with the heating fan 160, can produce a stream of heated air to cook food within the various containers described herein. For example, during a cooking operation, power from a power source can be provided to the electronics components 170 which can activate the heating element 150 and provide power to the air movement device causing a stream of air to be drawn into the housing 130 by the heating fan 160 and directed over the heating element 150 and into a cavity within the container to heat food disposed therein, as discussed in greater detail below. Additionally, as the heating fan 160 directs air over the heating element 150, the cooling fan 165 can simultaneously be arranged to direct a portion of the air drawn into the housing back up into the electronics components 170 to provide convective cooling to the electronics components, as discussed in greater detail below. In an aspect, the heating element 150 is a cal-rod, graphite, carbon fiber, or any other suitable heating source. In particular, the heating element 150 may convert electrical energy received into thermal energy, such that the heating element 150 increases in temperature. Furthermore, the heating fan 160 may rotate in either a clockwise or counterclockwise direction, such that air may move through, over, or otherwise around the heating element 150. The operation of the heating element 150 in combination with the heating fan 160 may correspond to a cooking process.

FIG. 1J is a cross-sectional view of the cooking device 100 taken along section E-E of FIG. 1C. As illustrated in FIG. 1J, the bottom surface 130c of the housing 130 can also be provided with a grill 133 which is arranged below the heating element 150. Additionally, as described above, the containers of the cooking systems described herein can be made from glass and can therefore be transparent. Accordingly, as shown in FIG. 1J, to allow for a user to better see the contents of the cooking container during a cooking operation, and to provide additional aesthetic value, the bottom surface 130c of the housing 130 can also be provided with at least one light 135, 136 arranged to illuminate a volume of the container during a cooking operation. In some aspects, a first light 135 can be provided in a front left side of the housing 130 and/or a second light 136 can be provided in a front right side of the housing 130. In other aspects, the systems described herein can include a single light provided centrally within the front of the housing 130, or a bar light provided across the front of the housing. This illuminating feature is shown, for example, in reference to FIG. 1K, which is a cross-sectional view of the cooking device 100 taken along section A-A of FIG. 1B. As shown in FIG. 1K, the light 135 can be provided within the front of the housing 130 and can be arranged to project light L1 from the bottom surface 130c of the housing 130 at an angle oriented away from the front of the housing toward to a back of the container 200 (or a back of the containers 300 or 400 discussed below). The light 135 can include a halogen lamp 135a provided within the housing 130 and insulated from the heating element 150, and a light pipe 135b coupled to the bottom surface 130c of the housing 130 and in optical communication with the halogen lamp 135a. For example, in some aspects, the halogen lamp 135a can be provided in the upper portion 130a of the housing 130, above the partition/radiation shield 134 and the light pipe 135b can be provided in the lower portion 130b of the housing 130. In this case, the partition/radiation shield 134 can include an opening that allows for the light pipe 135b to be in optical communication with the halogen lamp 135a. During a cooking operation, the electronics components (e.g., electronics components 170) can provide power to the halogen lamp 135a such that light from the halogen lamp 135a is projected into the light pipe and directed at an angle from the front of the housing toward to a back of the container 200 to illuminate the interior volume of the container. In some aspects, the light pipe 135b can receded into the bottom surface 130c of the housing 130, as shown in FIG. 1K, such that only a small portion of the light pipe 135b extends past the grill 133 so as to not obstruct a cooking airflow during the cooking operation. The second light 136 can be substantially identical to the first light 135 and can operate similarly, accordingly, like components are not described herein. The lights 135, 136 can be programmed such that when the cooking system is initially powered on, the lights 135, 136 can be illuminated at a lower brightness (e.g., 50%). As the user begins to interact with the user interface 131, inputting cooking parameters, the lights 135, 136 can be controlled to increase their luminescence until the lights are illuminated at a higher brightness (e.g., 100%) for the cooking operation. Additionally, in some aspects, the cooking system 100 can be programmed with different light modes that allow for the lights 135, 136 to be variously illuminated in a theatrical fashion, to exhibit a sort of light show upon powering on the machine and/or during the cooking operation. In some aspects, the if the cooking system 100 also includes the light strip provided on the top rim 130r of the housing 130, as described above, the light strip can also be programmed to perform a similar sort of light show upon powering on the machine and/or during the cooking operation. In some aspects, any of the lights of the cooking systems described herein can further be programmed to change in intensity or color to indicate various cooking information to the user, like progress or temperature of a cooking operation or the like.

Conventionally, as described above, traditional air fryers typically consist of a cooking cavity of a fixed size that can only accommodate a singular, often large-sized cooking vessel. While these conventional large-sized cooking vessels can accommodate a lot of food, not all users require such a large volume, for example, in cases where they are only cooking a small meal. Additionally, the connection interface between the upper rim of the cooking basket and the cooking cavity of traditional air fryers typically has a tolerance gap which allows for the cooking basket to be easily inserted into the cooking cavity. However, one downside of this design is that hot air produced during a cooking operation can flow out of the gap between the upper rim of the cooking basket and the cooking cavity, causing heat loss which can result in inefficiencies of the cooking operation. The cooking systems and methods described herein have addressed the aforementioned shortcomings of traditional air fryers providing a dynamic seal assembly that is capable of accommodating and sealing around a variety of container sizes.

For example, looking back to FIG. 1J, the cooking system 100 can further include a seal assembly 180 which can be coupled to the bottom surface 130c of the housing 130. In some aspects, the seal assembly 180 can include a first seal 181 and a second seal 182. As shown in FIG. 1J, the first seal 181 can be arranged to seal around an upper rim of a small and/or medium container (e.g., containers 200 and 300) and the second seal 182 can be arranged to seal around a large container (e.g., container 400), as discussed in greater detail below. Accordingly, in some aspects, the first seal 181 and the second seal 182 can be concentric, with the second seal 182 being disposed radially outside of the first seal 181, as shown in FIG. 1J.

FIG. 1L is an enlarged view of DETAIL-B of FIG. 1H, showing a portion of the seal assembly 180. As shown in FIG. 1L, the first seal 181 and the second seal 182 can be concentric, with the second seal 182 being disposed radially outside of the first seal 181. Additionally, in some aspects, the first seal 181 can include an inner portion 181a that is arranged to protrude downward a first distance from the bottom surface 130c and the second seal 182 can include an inner portion 182a that is arranged to protrude downward a second distance from the bottom surface 130c, where the first distance is greater than the second distance. By providing the first and second seals with the aforementioned inner portions, the seals can advantageously project into a volume of the container which they are sealing around to better seal the container with the cooking system 100 during a cooking operation, as described below. The seal assembly 180 can also include a first sensor/switch 183 and/or a second sensor/switch 184 which are each arranged to detect when a container is received in the first seal 181 or the second seal 182, respectively. Additionally, in some aspects, the seal assembly can further include a deformable portion 190 which can allow for the seal to move up and down during container insertion and removal. The deformable portion 190 can be made from a heat-resistant rubber, or the like. In some aspects, the seal assembly 180 can also include one or more springs (not shown) provided within the housing 130 and arranged to bias the seal assembly 180 downward to ensure proper sealing around the container during the cooking operation.

For example, as a container is inserted into the cooking system 100 along the direction X, a leading edge of the rim of the container can be arranged to contact the seal assembly 180, causing the seal assembly 180 to move upward in the direction Z, which is permitted by deformable portion 190 and/or the springs provided in the housing. Once the container is properly seated in the cooking system (e.g., as shown in FIG. 1A), the springs of the seal assembly 180 can bias the seal assembly back downward in the Z direction to seal around the rim of the container. For example, FIG. 1M and IN show detailed views of the portion of the seal assembly 180 shown in FIG. 1L, when the seal assembly 180 receives a small/medium container (e.g., container 200 or 300) or a large container (e.g., container 400). As shown in FIG. 1M, once the small container 200 (or medium container 300 described below) is received by the seal assembly 180, the seal assembly 180 is biased downward in the −Z direction such that the first seal 181 seals around a rim 200r of the container 200, with the inner portion 181a protruding into a cooking volume 200v of the container. Additionally, as the seal assembly 180 is biased downward, the first sensor/switch 183 contacts the rim 200r of the container and is actuated upward in the +Z direction. Depressing (e.g., applying a compressive force against) the first switch 183 may cause an electrical signal to change accordingly, which can be communicated to the controller of the system 100 to inform the system that the small container (or medium container 300) is present in the cooking system. Similarly, as shown in FIG. 1N, once the large container 400 is received by the seal assembly 180, the seal assembly 180 is biased downward such that the second seal 182 seals around a rim 400r of the container 400, with the inner portion 182a protruding into a cooking volume 400v of the container. By being able to dynamically move upward and downward, the seal assembly 180 described herein is advantageously capable of fully sealing around the rims of the containers described herein. This remedies the inefficiencies that are caused by the heat loss through the gap between the upper rim of the cooking basket and the cooking cavity of traditional air fryers. This design also allows for the cooking systems described herein to be accommodate and sealing around a variety of container sizes as described above.

As the seal assembly 180 is biased downward, the second sensor/switch 184 contacts the rim 400r of the container and is actuated upward. Depressing (e.g., applying a compressive force against) the second switch 184 may cause an electrical signal to change accordingly, which can be communicated to the controller of the system 100 to inform the system that the large container is present in the cooking system. In some aspects, for example, the seal assembly 180 can be provided with a 10 mm range of travel in the Z direction, to allow for the containers of the system to be easily positioned within the cooking system. However, larger or smaller travel distances for the seal assembly 180 are also realized. The controller may be arranged to determine a cooking mode for the cooking operation depending on whether the first switch 183 or the second switch 184 is actuated. For example, the small/medium containers of the system may be provided with a shallower cooking volume than the large container (discussed in greater detail below). In this case, a cooking operation with the small/medium containers may not require as much power/heat to achieve the same result as a cooking operation with the large container. Accordingly, by providing the seal assembly with the first and second switches 183, 184 corresponding to the first and second seals 181, 182, the controller of the system is advantageously able to determine which container is present within the system and automatically adjust the cooking mode or power setting of the cooking operation, or notify the user, via the interface 131, that a power increase/decrease is recommended based on the container size detected.

It is also realized that a user could accidentally actuate one of the first or second switches 183, 184 when no container is properly positioned within the cooking system 100. Accordingly, to avoid inadvertent cooking operations in this case, the seal assembly 180 can also be provided with a third sensor/switch 185, as shown in FIGS. 10 and 1P. FIGS. 10 and 1P are cross-sectional views of the cooking system 100 taken along section G-G of FIG. 1E. As shown in FIGS. 10 and 1P, the third switch 185 can include a lever arm 185a that is configured to bias a microswitch 185b into a first position, as shown in FIG. 10 when no container is present in the cooking system. The lever arm 185a is coupled to the seal assembly 180 such that when any container (e.g., any of containers 200, 300, 400 described herein) is properly positioned within the cooking system, the lever 185a is arranged to move upward in the Z direction with the seal assembly 180 to move the microswitch 185b into a second position, as shown in FIG. 1P. Accordingly, the controller of the system can be programmed to only allow for a cooking operation to be initiated if the third switch 185 is actuated, in addition to one of the first or second switches 183, 184. For example, upon determining, by the controller, that the first switch 183 and the third switch 185 have been actuated, the controller may activate a first cooking mode that is tuned specifically for a cooking operation with the small/medium container. Similarly, upon determining, by the controller, that the second switch 184 and the third switch 185 have been actuated, the controller may activate a second cooking mode that is tuned specifically for a cooking operation with the large container.

It is also realized that any of the sensors/switches 183-185 described above could be other sensor/switch types arranged to detect the presence of the containers described herein. For example, in some aspects, the sensors/switches 183-185 can include any of optical sensors, pressure sensors, infrared sensors, time-of-flight sensors, other electrical sensors, or combination thereof, which are capable of individually identifying the variety of containers described herein, as well as being able to confirm that the container is properly positioned within the cooking system.

As mentioned above, traditional air fryers typically have a gap between the upper rim of the cooking basket and the cooking cavity, which can be a point of heat loss. However, because traditional air fryers are not well sealed, they are able to draw air into the cooking cavity during cooking operations, through the gap between the basket and the cavity. By providing the improved sealing capabilities described above, the cooking systems described herein are not able to rely on this natural air seepage that is relied upon by traditional air fryers. Accordingly, the cooking systems described herein can further include a dedicated fresh air snorkel that is capable of bringing fresh air into the housing and directing the air into the cooking chamber for cooking. For example, FIG. 1Q is a cross-sectional view of the cooking system 100 taken along section B-B of FIG. 1B. As shown in FIG. 1Q, the top rim 130r of the housing 130 can be provided with an air inlet IN1. In some aspects, the air inlet IN1 can be provided around either an entirety of the top rim 130r, or only around a portion thereof. Additionally, or alternatively, in some aspects, the air inlet IN1 can also include one or more openings (e.g., small holes, slots, or other openings) provided on exterior sides of housing 130, arranged below the top rim 130r.

As described above, the housing 130 is arranged to house the heating element 150, the heating fan 160, the cooling fan 165, and the electronics components (e.g., PCBA) 170 arranged to provide power to the heating element 150, heating fan 160, cooling fan 165. The cooling fan 165 and electronics components 170 (including the motor 171) can be arranged in the upper portion 130a of the housing 130 and the heating element 150 and the heating fan 160 can be arranged in the lower portion 130b of the housing, fully separated by the radiation shield 134. During a cooking operation, the motor 171 is powered to drive the heating fan 160 and the cooling fan 165 (together defining the air movement device) in simultaneous rotation. Rotation of the air movement device can cause a pressure differential within the housing that causes air to be drawn into the housing via the air inlet IN1. As the air is drawn into the housing, a portion of the airflow can be directed along a snorkel flow path P1 provided within the housing 130. As shown in FIG. 1Q, the flow path P1 can be arranged to extend through a periphery of the upper portion 130a of the housing 130 until it reaches the upper layer 134a of the radiation shield 134. The flow path P1 can then extend through a first small opening 134c provided in the upper layer 134a of the radiation shield 134, proximate to the back of the housing 130, as shown. Once the airflow passes through the small opening 134c, the air flow path P1 can then extend horizontally within the gap between the upper layer 134a and the lower layer 134b until the air reaches a central point of the housing, substantially aligned with the axle 172. Adjacent to the axle 172, the lower layer 134b of the radiation shield can be provided with a second small opening (not shown), which can extend through the lower layer 134b into the lower portion 130b of the housing 130, directly overtop of the heating fan 160.

Accordingly, the air flow path P1 can direct the airflow through the second small opening provided in the lower layer 134b and expel the air directly over the heating fan 160 which can take in the air and direct the air over the heating element 150 to be heated. Once the air is heated by the heating element 150, the air can be arranged to follow a vortex flow path P2, whereby the air is directed downwards along sides of the container 200 until the air reaches the bottom of the container, at which point the air can be circulated back upward toward a central portion of the heating element, as shown in FIG. 1Q. In an aspect, the vortex flow path P2 is a torus shaped flow path. The vortex flow path P2 advantageously provides a heated airflow that circulates around both top and bottom surfaces of food within the container to provide thorough and even cooking of the food. Once the air is circulated back upward toward the central portion of the heating element, the heating fan 160 can then direct the air horizontally along the vortex flow path P2 until the air reaches an exhaust vent 137 provided at the back of the housing, as shown. It should be noted that, in some aspects, majority of the air that is heated by the heating element 150 and circulated along the vortex flow path P2 by the heating fan 160 is recirculated air that is originally present within the cooking volume of the cooking device 100, and only a small flow of air is drawn from the housing along flow path P1 into the cooking volume. The exhaust vent 137 is designed such that it bypasses the radiation shield 134 and the upper portion 130a of the housing 130, allowing for the air to be expelled along flow path P2 from the lower portion 130b directly to an outlet OUT1 of the exhaust vent 137. By providing the housing with the snorkel flow path P1 and the exhaust vent 137, the cooking system is able to fully seal the container with the seal assembly as described above and is still able to regulate the air that is drawn into the cooking system for the cooking operation. In some aspects, sizes of the first small opening 134c and the second small opening provided in the lower layer 134b of the radiation shield 134 can be specifically sized such that a ratio between air being drawn into the housing along the snorkel flow path P1 and air being exhausted out of the exhaust vent 137 establishes a desired level of humidity within the cooking volume of the container 200 during the cooking operation.

During operation, the electronics components (e.g., PCBA) 170 of the cooking system can produce heat as a result of powering the system. Accordingly, the cooling fan 165 can be provided to convectively cool the electronics components 170, using outside air, at the same time as the heating fan uses outside air to cook food in the container as described above. Additionally, in some cases, heat generated during cooking operations can be imparted onto the food container, causing the container to get hot to the touch, which can be a safety concern for users if the grab the container after the cooking operation. Accordingly, the systems and methods described herein may provide active cooling functionalities which are capable of actively cooling an exterior of the container during cooking, to ensure that the exterior of the container is not too hot if the user goes to grab the container during cooking of after cooking has completed.

For example, FIG. 1R is a cross-sectional view of the cooking device 100 taken along section H-H of FIG. 1E. As shown in FIG. 1R, and as described above, the top rim 130r of the housing 130 can be provided with the air inlet IN1. In some aspects, the air inlet IN1 can be provided around either an entirety of the top rim 130r, or only around a portion thereof. Similarly to as described above, during a cooking operation, the motor 171 is powered to drive the heating fan 160 and the cooling fan 165 (together defining the air movement device) in simultaneous rotation. Rotation of the air movement device can cause a pressure differential within the housing that causes air to be drawn into the housing via the air inlet IN1. As the air is drawn into the housing, a portion of the airflow can be directed along a cooling flow path P3 by the cooling fan 165. Specifically, as the cooling fan 165 rotates, it can draw air into the housing via the inlet IN1 and can direct a portion of the air along the flow path P3 to pass air by the electronics components (e.g., PCBA) 170 to convectively cool the electronics components 170 as they provide power to the cooking system 100.

Furthermore, while the air that is used to convectively cool the electronics components 170 may be warmer than the ambient air that is initially brought in through the inlet IN1, the air is still significantly cooler than the heat that can be affected to the exterior of the containers during cooking operations. Accordingly, it is also an aspect of the systems and methods described herein to leverage the air that is used to convectively cool the electronics components 170 to further cool the exterior of the containers of the system during cooking. Specifically, after the air flows over the electronics components 170 along flow path P3, the cooling fan 165 can be arranged to further direct the air along a secondary cooling flow path P4, as shown in FIG. 1R. The secondary cooling flow path P4 can begin at the cooling fan 165 and can extend along a periphery of the upper portion 130a of the housing until it reaches a sidewall of the housing, at which point the flow path P4 can extend downward to expel a flow of air out of an outlet OUT2, as shown. As shown in FIG. 1R, the outlet OUT2 can provided radially outward of the seal assembly 180 and the container 200. Accordingly, as air is directed along the flow path P4 by the cooling fan 165 and directed out of the outlet OUT2, the air can be projected downward to form an air curtain around the container, as shown, which is effective to convectively cool an external surface 200a of the container 200. In some aspects, the outlet OUT2 can be provided around an entire perimeter of the bottom surface 130c of the housing 130, however, in other aspects, the outlet OUT2 can only be provided on lateral sides of the bottom surface 130c to ensure that the handles 211 of the container 200 and a portion of the external surface 200a proximate to the handles 211 are effectively cooled. Because the outlet OUT2 is provided radially outside of both the first seal 181 and the second seal 182, the air curtain provided by the secondary cooling flow path P4 can effectively cool all container sizes that can be accommodated in the cooking system. In some aspects, an open surface area near each of the cooling fans 165 can be larger than a surface area of each outlet OUT2, such that outlet to speed up cooling air.

FIGS. 2A-2B show respective front and side views of a cooking system 500. As shown in FIGS. 2A-2B, the cooking system 500 includes the platform 105, the housing 130, the container holder 140 and the container 300. The platform 105, the housing 130, and the container holder 140 of the cooking system 500 can be similar to the cooking system 100 described above in reference to FIGS. 1A-1R, accordingly like components will not be described. Accordingly, prior to a cooking operation with the cooking system 500, the container holder 140 can be placed in the angled slot 122, as shown, to accommodate for the container 300.

FIGS. 3A-3B show respective front and side views of a cooking system 600. As shown in FIGS. 3A-3B, the cooking system 600 includes the platform 105, the housing 130, the container holder 140 and the container 400. The platform 105, the housing 130, and the container holder 140 of the cooking system 600 can be similar to the cooking system 100 described above in reference to FIGS. 1A-1R, accordingly like components will not be described. Accordingly, prior to a cooking operation with the cooking system 600, the container holder 140 can be placed in the base slot 123, as shown, to accommodate for the container 400.

FIGS. 4A-4B show respective front and isometric views of the cooking container 200 described herein. As shown in FIG. 4A, the container 200 includes the container body 205, and the container base/thermal plate 210 which includes handles 211 and feet 212. As described above, container body 205 may be made from a thermal shock-resistant material such as borosilicate glass. In some aspects, the base/thermal plate 210 may be made from a plastic material. However, the materials of the container body 205 and/or base 210 may be selected based on one or more of thermal conductivity, density, expansion characteristics, compressive strength, tensile strength, and other material properties. The container body 205 and the base 210 can be fixed to one another via either a friction fitting or by using an adhesive. The container 200 can also be provided with an air gap G1 between the base of the container body 205 and the container base 210 which acts as a thermal barrier. In some aspects, the handles 211 may be configured to be handled by a user, such as to pick up or otherwise move the container 200. For example, the handles 211 may extend from outer surface of an upper portion of the base 210 on one or more sides of the container 200. In other aspects, the handles 211 may extend from outer surface of an upper portion of the base 210 and can form a single handle that wraps around an entirety of the container 200. A containment volume of the container 200 can be 2.5 quarts, however other sizes for the container are realized. The container 200 can also be provided with a lid 230 which can be removably coupled with the upper rim of the container so that the container can also be used for food storage. By providing the container with the lid 230, a user can simply keep any leftover food within the container 200 and cover the container 200 with lid 230 for direct storage, eliminating the need for transferring the food to a separate storage container.

A height H1 of the container 200, measured from a bottom surface 210a of the base 210 to an upper perimeter 205a of the container body 205 can be specifically designed to correspond to the first distance D1 between the top surface of the container holder 140 and the first seal 181 the bottom surface 130c of the housing 130, in reference to FIG. 1F, such that the container 200 and be securely positioned within the cooking system 100 when the container holder 140 is positioned in the slot 121. Specifically, in some aspects, the height H1 can be within a range of 70 mm- 90 mm, particularly 79.5 mm, however, heights H1 which are greater than 90 mm or less than 70 mm are also realized. Additionally, a lateral width W3 of the upper perimeter 205a of the container body 205 can be specifically designed to match a width of the first seal 181 such that the upper perimeter 205a is fully sealed by the first seal 181 when the container 200 is secured to the cooking system. Furthermore, in some aspects, a lateral width W4 between the of the feet 212 can be specifically designed to correspond to the lateral width of the container holder 140, such that movement of the container 200 in the lateral direction is restricted when the container 200 is secured to the cooking system. For example, in some aspects, the lateral width W4 between the of the feet 212 can be within a range of 85 mm- 100 mm, however, lateral widths W4 which are greater than 100 mm or less than 85 mm are also realized.

As shown in FIG. 4B, the container 200 can also be provided with one or more crisper trays 240 that may be slidably received by the container 200 cavity. The crisper tray 240 may be used to increase heat transfer to food contained within the container. The increase in heat transfer facilitated by the crisper tray may increase a temperature of the food within the vessel and thus increase a level of crispiness of an external surface of the food. Furthermore, the crisper tray may comprise one or more openings to facilitate fluid flow. For example, air may flow through the one or more openings to and/or from any food within the container, which may contribute to a crisping effect of the food.

FIG. 5 shows a front view of the cooking container 300 described herein. As shown in FIG. 5, the container 300 includes the container body 305, and the container base/thermal plate 310 which includes handles 311 and feet 312. The container 300 can be made from similar materials and can be constructed in a similar way to the container 200 described above, accordingly, like components are not described. A containment volume of the container 300 can be 4 quarts, however other sizes for the container are realized. The container 300 can also be provided with a lid 330 which can be removably coupled with the upper rim of the container so that the container can also be used for food storage. By providing the container with the lid 330, a user can simply keep any leftover food within the container 300 and cover the container 300 with lid 330 for direct storage, eliminating the need for transferring the food to a separate storage container.

A height H2 of the container 300, measured from a bottom surface 310a of the base 310 to an upper perimeter 305a of the container body 305 can be specifically designed to correspond to a second distance D2 between the top surface of the container holder 140 and the bottom surface 130c of the housing 130, in reference to FIG. 2B, such that the container 300 and be securely positioned within the cooking system 100 when the container holder 140 is positioned in the slot 122. Specifically, in some aspects, the height H2 can be within a range of 110 mm- 120 mm, particularly 114 mm, however, heights H2 which are greater than 120 mm or less than 110 mm are also realized. Additionally, the upper perimeter 305a of the container body 305 can be specifically designed to have the same lateral width W3 as the container 200 to match a width of the first seal 181 such that the upper perimeter 305a is fully sealed by the first seal 181 when the container 300 is secured to the cooking system. Accordingly, the containers 200 and 300 can be designed with the same sized upper perimeters and can only differ in depth of the cooking volume defined in part by H1 and H2, respectively. Furthermore, in some aspects, the feet 312 can be specifically designed to have the same lateral separation W4 as the container 200 described above such that movement of the container 300 in the lateral direction is restricted when the container 300 is secured to the cooking system.

FIG. 6 shows a front view of the cooking container 400 described herein. As shown in FIG. 6, the container 400 includes the container body 405, and the container base/thermal plate 410 which includes handles 411 and feet 412. The container 400 can be made from similar materials and can be constructed in a similar way to the container 200 described above, accordingly, like components are not described. A containment volume of the container 400 can be 6 quarts, however other sizes for the container are realized. The container 400 can also be provided with a lid 430 which can be removably coupled with the upper rim of the container so that the container can also be used for food storage. By providing the container with the lid 430, a user can simply keep any leftover food within the container 400 and cover the container 400 with lid 430 for direct storage, eliminating the need for transferring the food to a separate storage container.

A height H3 of the container 400, measured from a bottom surface 410a of the base 410 to an upper perimeter 405a of the container body 405 can be specifically designed to correspond to a third distance D3 between the top surface of the container holder 140 and the bottom surface 130c of the housing 130, in reference to FIG. 3B, such that the container 400 and be securely positioned within the cooking system 100 when the container holder 140 is positioned in the base slot 123. Specifically, in some aspects, the height H3 can be within a range of 140 mm- 150 mm, particularly 148.43 mm, however, heights H3 which are greater than 150 mm or less than 140 mm are also realized. Additionally, a lateral width W5 of the upper perimeter 405a of the container body 405 can be specifically designed to match a width of the second seal 182 such that the upper perimeter 405a is fully sealed by the second seal 182 when the container 400 is secured to the cooking system. Furthermore, in some aspects, the feet 412 can be specifically designed to have the same lateral separation W4 as the container 200 described above such that movement of the container 400 in the lateral direction is restricted when the container 400 is secured to the cooking system. In some aspects, the containers 300 and 400 can also be provided with one or more crisper trays which can be similar the crisper tray 240 of container 200 described above.

In some cases, users may wish to prepare a meal that includes multiple ingredients that have differing cooking requirements, e.g., chicken wings and brussels sprouts. Accordingly, in some aspects, the cooking systems described herein can be adapted to accommodate two cooking or more containers at a time, allowing for the user to execute simultaneous cooking operations using the same device as will be described in greater detail below in reference to FIGS. 7A-26.

FIG. 7A is an isometric view of another cooking system 700 according to the systems and methods described herein. Cooking system 700 include similar features and functionalities to the cooking systems described above in reference to FIGS. 1A-3B, accordingly, like features and functionalities will not be described. As shown in FIG. 7, the cooking system 700 includes a platform 705, a housing 730, and at least two containers 790, 795. In some aspects, the cooking system 700 can also include additional containers (not shown), which can differ in height and/or width from the containers 790, 795, similarly to the size variability of the containers 200, 300, 400 described above. The platform 705 is arranged to be positioned on a countertop and includes a base 710 and a spine 720 projecting upward from the base 710 and coupling the housing 730 to the base 710. In some aspects, the base 710, spine 720 and housing 730 can have a similar construction to the base 110, spine 120 and housing 130 of cooking system 100 and can include similar components and functionalities, accordingly, like components are not described. Similar to the cooking system 100, a maximum lateral width of the housing 730 may be greater than a lateral width of the spine 720. Additionally, the spine 720 is arranged to project upward from a back of the base 710 to couple the back of the base 710 to a back of the housing 730 such that the housing 730 is cantilevered over the base 710. This design provides the cooking system 700 with an aesthetically appealing look that that deceives a user into thinking that the housing 730 is floating over the countertop. In some aspects however, to accommodate for the larger housing 730 of the cooking system 700, the spine 720 may be wider than the spine 120 of cooking system 100. In some aspects, the spine 720 also may include a structural fin 721 which is arranged to project forward from the spine 720 in between the containers 790, 795, to provide additional structural support for the housing 730.

Because the cooking system 700 is designed to accommodate two containers at a time, the housing 730 can include two independent sets of heating elements, heating fans, cooling fans, and exhaust vents (not shown). In some aspects, each heating element, heating fan, and cooling fan of the cooking system 700 can be similar to the heating element 150, heating fan 160, cooling fan 165, and exhaust vent 137 of cooking system 100. Similar to housing 130, the housing 730 can be divided into an upper portion and a lower portion, which can be separated by a partition/radiation shield (not shown), which can include two layers of material separated by an air gap to provide desirable insulative properties between the upper portion and the lower portion of the housing 730. The cooking system 700 also includes temperature sensors (not shown), and electronics components (e.g., PCBAs) arranged to provide power to the heating elements, heating fans, cooling fans, and temperature sensors similarly to as described above. All the components within the housing 730 can be arranged in respective upper and lower portions of the housing 730 similarly to the arrangement of the components of system 100. The cooking system 700 can also be arranged to perform duplicative instances of the heating flows and cooling air flows described above, during cooking operations using each of the containers 790, 795.

The housing 730 also includes an input interface 731 on a top surface of the housing 730. The input interface 731 comprises a plurality of buttons/knobs 731a configured to allow a user to control cooking operations for both containers 790, 795. The input interface 731 is connected to a control unit (not shown) arranged within the cooking device 700. A user may control a power status (e.g., on, off), a cooking temperature, a power setting, a cooking mode (e.g., Airfry, Max Crisp, Reheat, etc.), a cooking time, or a combination thereof via the input interface 731 for cooking operations for both containers 790, 795. In some aspects, the input interface 731 can include two sets of controls for controlling a cooking operation with each of the containers 790, 795 independently. In alternative aspects, the input interface 731 can include a single set of controls, which the user can toggle between a first configuration in which the user can control a cooking operation using the container 790, and a second configuration in which the user can control a cooking operation using the container 795. In some aspects, the input interface 731 can also include a digital screen which can show a cooking temperature or other cooking information, and which can be illuminated by one or more lights (not shown) for user visibility. Additionally, in some aspects, a top rim 730r of the housing 730 can also be provided with a light strip (not shown) to provide additional aesthetic illuminating functionalities, similarly to as described above.

As mentioned above, in some cases, users may wish to prepare a meal that includes multiple ingredients that have differing cooking requirements, e.g., chicken wings and brussels sprouts. Accordingly, in some aspects, the cooking system 700 can further include a functionality that allows the user to synchronize cooking operations using both the container 790 and the container 795 simultaneously. For example, expanding on the example provided above, the user can place the chicken wings (which require a cook time of 20 minutes at 300 degrees, for example) in container 790, and can place the brussels sprouts (which require a cook time of 10 minutes at 400 degrees, for example) in container 795. The user can then interact with the input interface 731 to set respective cooking parameters for the chicken wings and the brussels sprouts, based on the requirements provided above, and can then provide an input into the interface 731 requesting a synchronized cooking operation. Upon receipt of the synchronized cooking request, the controller can compare the cooking operations and can automatically initiate the cooking operations at different times, such that the two cooking operations complete at the same time. This functionality automatically ensures that no ingredient of the meal is left to sit and cool while waiting for other ingredients to finish cooking, providing the user with a uniformly hot meal at the concluding of the cooking operation. In other aspects, users may wish to prepare multiple meals in each container 790, 795 which require the same cooking parameters. In this case the system 700 can further include a mirroring functionality, which allows the user to interact with the input interface 731 to set cooking parameters one of the containers 790, 795 and then the system 700 can copy those cooking parameters and applying them to the other of the containers 790, 795 to eliminate duplicative user inputs. In some aspects, the user can also simply perform a cooking operation using a single container 790 or 795.

The containers 790, 795 can be selectively coupled to the cooking system 700 by inserting the containers 790, 795 into a front of the housing 730, such that the containers 790, 795 are securely positioned between the base 710 and a bottom surface 730c of the housing 730, similarly to as described above. Accordingly, the system 700 can further include independent seal assemblies 780a, 780b, which can be coupled to the bottom surface 730c of the housing 730. In some aspects, each seal assembly 780a, 780b can be similar to the seal assembly 180 of cooking system 100 described above and can include one or seals and sensors/switches 783a, 783b, which can operate as described above to seal the containers 790, 795, respectively, during cooking operations.

In some aspects, the containers 790, 795 can each include a container body 791, 796, and a container base 792, 797 which includes handles 793, 798. In some aspects, the materials of the containers 790, 795 and the dimensional design requirements can be similar to those of containers 200, 300, and 400 described above, such that the containers fit within the cooking system 700 in much the same way as the containers 200, 300, and 400 fit within the cooking systems 100, 500, and 600. Additionally, in some aspects, the handles of the containers described herein (e.g., handles 211, 311, 411, 793, 798) may be provided on the bases of the containers with a hinged connection or the like such that the handles can be folded to better fit within the cooking systems described herein or for storage. For example, in some aspects, the handles 793, 798 of containers 790, 795 can be provided with a folding means to allow for the two containers to better fit within the housing.

FIG. 7B illustrates a front view of a variation of the cooking system 700 shown in FIG. 7A. The cooking system 700 in FIG. 7B includes the platform 705, the housing 730, the container 790, and a smaller container 795′. The smaller container 795′ may have a smaller volume than the container 795 shown in FIG. 7A, allowing for cooking operations with smaller volumes of food.

To accommodate the smaller container 795′ and ensure proper sealing with the seal assembly 780b on the bottom surface 730c of the housing 730, the cooking system 700 may be provided with a platform insert 799. The platform insert 799 is arranged to be selectively positioned on the base 710 beneath the smaller container 795′ to elevate the container 795′ to a height that allows the upper rim of the container 795′ to properly engage with the seal assembly 780b. In some aspects, the platform insert 799 may have a height that corresponds to the difference in height between the container 795 and the smaller container 795′, such that when the smaller container 795′ is positioned on the platform insert 799, the upper rim of the smaller container 795′ is positioned at substantially the same height as the upper rim of the container 795 would be when positioned directly on the base 710.

The platform insert 799 may include a top surface configured to support the base of the smaller container 795′ and may include features that interact with the feet or base of the smaller container 795′ to restrict lateral movement during cooking operations. In some aspects, the platform insert 799 may be constructed from a thermally resistant material and may include openings or perforations to allow for airflow around the smaller container 795′ during cooking operations. The platform insert 799 may be removable from the base 710, allowing a user to selectively use the platform insert 799 when cooking with smaller containers and to remove the platform insert 799 when using larger containers such as the container 795.

As shown in FIG. 7B, the container 790 may be positioned on the base 710 without the platform insert 799, while the smaller container 795′ is positioned on the platform insert 799. This configuration allows the cooking system 700 to accommodate containers of different sizes simultaneously, providing flexibility for users to prepare multiple food items with varying volumes in a single cooking operation. The seal assemblies 780a, 780b may be arranged to seal around the upper rims of both the container 790 and the smaller container 795′, respectively, ensuring that both cooking chambers are properly sealed during operation.

FIGS. 8A and 8B illustrate another cooking system 800 according to the systems and methods described herein. In some aspects, the cooking system 800 can includes similar features and functionalities to the cooking systems 100 and 300-700 described above, accordingly, like features and functionalities are not described in greater detail below.

As shown in FIGS. 8A and 8B, the cooking system 800 includes a platform 805, a housing 830, and at least two containers 890, 895. The platform 805 is arranged to be positioned on a countertop and includes a base 810 and a spine 820 projecting upward from the base 810 and coupling the housing 830 to the base 810. The spine 820 is arranged to project upward from a back of the base 810 to couple the back of the base 810 to a back of the housing 830 such that the housing 830 is cantilevered over the base 810 (see FIG. 8J). In some aspects, the spine 820 may include a structural fin 821 which is arranged to project forward from the spine 820 in between the containers 890, 895, to provide additional structural support for the housing 830. In some aspects, the containers 890, 895 can be similar to the containers of the cooking systems described above. In some aspects, the system 800 may also be adapted to include three distinct cooking portions, rather than the two cooking portions shown. Additional details of the containers 890, 895 and other exemplary containers according to the systems described herein are discussed in greater detail below in reference to FIGS. 8Q-26.

The housing 830 includes an input interface 831 on a top surface of the housing 830. The input interface 831 comprises a plurality of buttons/knobs 831a configured to allow a user to control cooking operations for both containers 890, 895. The input interface 831 is connected to a control unit (not shown) arranged within the cooking system 800. A user may control a power status (e.g., on, off), a cooking temperature, a power setting, a cooking mode (e.g., Airfry, Max Crisp, Reheat, etc.), a cooking time, or a combination thereof via the input interface 831 for cooking operations for both containers 890, 895. In some aspects, the input interface 831 can include two sets of controls for controlling a cooking operation with each of the containers 890, 895 independently. In some aspects, the input interface 831 can include a single set of controls, which the user can toggle between a first configuration in which the user can control a cooking operation using the container 890, and a second configuration in which the user can control a cooking operation using the container 895.

The containers 890, 895 can be selectively coupled to the cooking system 800 by inserting the containers 890, 895 into a front of the housing 830, such that the containers 890, 895 are securely positioned between the base 810 and a bottom surface 830c of the housing 830. The system 800 can further include independent seal assemblies 880, 883 provided on the bottom surface 830c of the housing 830. Each seal assembly 880, 883 can include a seal to seal an upper rim of the containers 890, 895 with the bottom surface 830c, and a sensor/switch arranged to actuate responsive to the containers 890, 895 being properly positioned within the system 800, as discussed below in reference to FIGS. 8C and 8D.

FIGS. 8C and 8D are cross-sectional views of the cooking system 800 taken along section J-J of FIG. 8B depicting the seal assembly 880 with no container attached and the seal assembly 880 with a container attached, respectively. The seal assembly 883 can be substantially similar to the seal assembly 880, accordingly, like components are not described. As shown in FIGS. 8C and 8D, the seal assembly 880 can include a first seal 881 arranged to seal around an upper rim of either of the containers 890, 895.

The first seal 881 can include an inner portion 881a that is arranged to protrude downward from the bottom surface 830c. By providing the first seal with the aforementioned inner portion, the first seal can advantageously project into a volume of the container which it is sealing around to better seal the container with the cooking system 800 during a cooking operation.

The seal assembly 880 can also include a first sensor/switch 882 arranged to detect when a container is received in the first seal 881. For example, when the container 890 is not present in the system 800, as shown in FIG. 8C, the sensor/switch 882 can be biased to an extended, unactuated position. In some aspects, the switch 882 can be biased by a spring 882s, however, other biasing mechanisms are also appreciated. Once the container 890 is properly seated within the system 800, as shown in FIG. 8D, the first sensor/switch 882 contacts a rim 890r of the container and is actuated upward. Depressing the first sensor/switch 882 may provide an electrical signal to the controller of the system 800 to inform the system that the container 890 is present in the cooking system 800. Once the container 890 is properly seated under the seal assembly 880, the inner portion 881a of the seal is arranged to protrude into a cooking volume 890v of the container 890, as shown. The seal assembly 883 may be substantially similar to the seal assembly 880 and may operate in a similar manner to seal the container 895 during cooking operations. In some aspects, the seal assembly 880 can further include a deformable portion, similarly to as described above, which can allow for the seal to move up and down during container insertion and removal. In some aspects, the system 800 can also include one or more temperature sensors 888 provided within a lower portion of the housing 830, and arranged to monitor temperatures of cooking operations of the system 800, as discussed in greater detail below.

FIG. 8E is a cross-sectional view of the cooking system 800 taken along section I-I of FIG. 8A depicting the internal components of the cooking system 800. The housing 830 can be divided into an upper portion 830a and a lower portion 830b, which can be separated by a partition/radiation shield assembly 834, which can include at least an upper divider 834a, a first shield layer 834b, and a second shield layer 834c, which are separated by an air gap to provide insulative properties between the upper portion 830a and the lower portion 830b of the housing 830. The upper portion 830a can be arranged to house electronics components, which can include first and second motors 835a, 835b, and processing units/controllers 837 (e.g., PCBAs), powered by a power supply, and arranged to control cooking operations of the system 800 by controlling two independent sets of heating elements, heating fans, and cooling fans, which can be similar to the heating elements, heating fans, and cooling fans of the cooking systems described above. Specifically, as shown in FIG. 8E, the cooking system 800 includes a first heating element 850a and a second heating element 850b positioned in the lower portion 830b of the housing 830. In some aspects, the heating elements may be higher powered and may cycle between two zones due to power limitations (e.g., 2×1600 W or 2×1650 W). In some aspects, the heating elements may be lower powered and may operate simultaneously (e.g., 2×1350 W). In some aspects, the housing 830 may also be provided with insulation, such as fiberglass, to compensate for heat loss through the container. Insulation may also be provided in the spine.

The cooking system 800 also includes a first air movement device 860a and a second air movement device 860b configured to draw air into the housing 830 and direct the air over the first and second heating elements 850a, 850b and into volumes of the first and second containers 890, 895, respectively. The cooking system 800 further includes a third air movement device 865a and a fourth air movement device 865b configured to draw air into the housing 830 and direct the air out of openings provided around perimeters of the first and second containers 890, 895, respectively, for cooling, as discussed in greater detail below.

In some aspects, the third air movement device 865a and the fourth air movement device 865b may be positioned between the upper divider 834a and the first shield layer 834b. The first air movement device 860a and the second air movement device 860b may be positioned in the lower portion 830b of the housing 830, below the second shield layer 834c. This arrangement positions the cooling fans (third and fourth air movement devices 865a, 865b) and the heating fans (first and second air movement devices 860a, 860b) on opposite sides of the first and second shield layers 834b, 834c, providing thermal separation between the cooling airflow paths and the heating airflow paths during cooking operations. The first motor 835a may be arranged to drive both the first air movement device 860a and the third air movement device 865a by way of a first axle 836a. The first axle 836a may extend through the partition/radiation shield assembly 834, coupling the first motor 835a to both the first air movement device 860a and the third air movement device 865a such that rotation of the first motor 835a causes simultaneous rotation of both air movement devices. Similarly, the second motor 835b may be arranged to drive both the second air movement device 860b and the fourth air movement device 865b by way of a second axle 836b. The second axle 836b may extend through the partition/radiation shield assembly 834, coupling the second motor 835b to both the second air movement device 860b and the fourth air movement device 865b such that rotation of the second motor 835b causes simultaneous rotation of both air movement devices. This configuration allows each motor to independently control both heating and cooling airflows for its respective cooking zone, enabling coordinated air circulation for cooking and thermal management within each zone of the cooking system 800. Additionally, in some aspects, the motors 835a, 835b each of the cooking portions can be adapted to actuate in opposite directions to ensure that air provided to the cooking chambers converges through a center of the cooking device.

During a cooking operation, the first and second air movement devices 860a, 860b can be arranged to draw air into the housing 830 via an air inlet 839i provided at a top rim 830r of the housing 830. The air can be directed along a cooling air flow path and a heating air flow path, as will be described below.

Cooling functionalities of the system 800 are shown and described in reference to FIG. 8F, which is an enlarged view of DETAIL-C of FIG. 8E, illustrating an exemplary cooling airflow channel CFP of the cooking system 800. During a cooking operation, the third and fourth air movement devices 865a, 865b can be arranged to draw air into the housing 830 via the air inlet 839i and direct a portion of the air along cooling flow paths to convectively cool both the electronics components of the system and the containers 890, 895. For example, as shown in FIG. 8F, each cooking portion of the system 800 can include a cooling airflow channel CFP 866. As the air is drawn into the housing 830 by the third air movement device 865a (and the fourth air movement device 865b), a portion of the air passes over the electronics components (e.g., motor 835a) to provide cooling, and is then directed along the cooling airflow channel CFP 866. The cooling airflow channels 866 of the system 800 are arranged to extend out toward a periphery of the housing 830, and downward to expel flows of air out of outlets 8390 provided radially outward of the seal assemblies 880, 883 and the containers 890, 895. As the air is directed out of the outlets 8390, the air can be projected downward to form air curtains around the containers 890, 895, which are effective to convectively cool external surfaces of the containers 890, 895. As shown in FIG. 8F, the cooling airflow channel CFP 866 may be configured to narrow from an upper portion 866a to a lower portion 866b. This narrowing geometry of the channel 866 may be arranged to increase the velocity of the cooling airflow as it exits the housing out of outlets 8390, thereby enhancing the cooling effect on the container 890. A similar cooling airflow channel may be provided for the container 895. While the air that is used to convectively cool the electronics components may be warmer than the ambient air that is initially brought in through the air inlet 839i, the air is still significantly cooler than the heat that can be imparted to the exterior of the containers 890, 895 during cooking operations. In some aspects, the cooling airflow channel CFP 866 can also include one or more additional cooling air ducts that are adapted to direct more air over the electronics components of the system 800 to further improve cooling thereof.

In some aspects, the cooking system 800 can also include a secondary air inlet 839s provided between a top portion of the housing 830 and a brim portion 830d of the housing 830. The secondary air inlet 839s may be arranged as a gap between the top and brim portions to allow additional ambient air to be drawn into the housing 830. The secondary air inlet 839s may be configured to supplement airflow drawn through the top air inlet 839i and may be used to cool the glass containers 890, 895 during cooking operations. In some aspects, a total inlet area defined by the top air inlet 839i and the secondary air inlet 839s may be matched to a total outlet area of the housing 830 to optimize airflow efficiency.

In some aspects, the cooking system 800 can also include a blast cooling function when one or both of the containers 890, 895 are removed after cooking. The blast cooling may rapidly reduce the temperature of the containers to improve user safety. In some aspects, this blast cooling can be provided by the third and fourth air movement devices 865a, 865b increasing their speed when the containers 890, 895 are removed. In some aspects, additional cooling airflow can also be provided by additional fans provided in the spine 820 or the base 810 (not shown). For example, in some aspects, the base of the cooking system may be configured to include cooling features similar to those provided around the top of the container, which may be configured to blow an air curtain upward toward the container.

FIG. 8G illustrates a top view of the cooking system 800. As shown in FIG. 8G, the housing 830 can have a substantially rounded rectangular perimeter when viewed from the top. The air inlet 839i is provided around a perimeter of the top rim 830r to facilitate airflow into the housing 830 during cooking operations. As shown in FIG. 8G, the system can also include exhaust vents 855a, 855b provided at the back of the housing 830. In some aspects the system can include multiple exhaust vents as shown, however, it is also realized that the system 800 could include a single, combined exhaust vent configured to exhaust air from both cooking portions during cooking operations using the containers 890, 895. In some aspects, the exhaust vents 855a, 855b can include louvered grills, as shown, which are arranged to direct the exhaust airflow out of the system 800 at an angle, to prevent the exhausted airflow from being drawn back into the system, as discussed in greater detail below.

To mitigate the risk of liquid ingress into the housing 830 via the top air inlet, the cooking system 800 can also include a drainage channel structure arranged within the housing 830 above and around electronic components. Specifically, FIG. 8H is a partial cross-sectional view of a water flow diversion channel WFDC taken along section K-K of FIG. 8G. As shown in FIG. 8H, the water diversion channel 840 is provided below the top rim 830r, within the air inlet 839i, and is shaped such that any water that inadvertently enters the inlet 839i is routed out of the secondary air inlet 839s provided between the top portion of the housing 830 and the brim portion 830d of the housing 830. The water diversion channel 840 may include a sloped surface 840s and a labyrinth flow path LFP that prevents water from coming into contact with the internal electronics components of the system 800 by directing the water along the labyrinth flow path LFP toward the secondary air inlet 839s, where the water can be expelled from the housing 830. The labyrinth flow path LFP also includes an elevated wall 840e which advantageously allows for air to be drawn into the housing to cool the electronics components, by passing over the elevated wall 840e, but prevents water from flowing into the electronics components.

Heating airflow functionalities of the system 800 are shown and described in reference to FIG. 8I, which is a cross-sectional view of the cooking system 800 taken along section L-L of FIG. 8G. As shown in FIG. 8I, the system 800 can further include one or more heating airflow paths HFP 851 provided within the housing 830. The airflow path 851 can be arranged to extend through a periphery of the upper portion 830a of the housing 830 until they reach the upper divider 834a of the partition/radiation shield assembly 834. As the air is drawn into the housing 830 via the air inlet 839i, a portion of the airflow can be directed along the heating airflow path 851, through one or more bypass openings 851a provided in the partition/radiation shield assembly 834, similarly to as described above in reference to FIG. 1Q. Once the airflow passes through the one or more bypass openings 851a, the air airflow path 851 can then extend horizontally within a gap between the first shield layer 834b and the second shield layer 834c until the air reaches central points of the housing, substantially aligned with the first axle 836a and the second axle 836b, respectively. Adjacent to the axles 836a, 836b, the second shield layer 834c of the partition/radiation shield assembly 834 can be provided with openings 851b, which can extend through the second shield layer 834c into the lower portion 830b of the housing 830, directly overtop of the first air movement device 860a and the second air movement device 860b, respectively.

Accordingly, the air airflow path 851 can direct the airflow through the openings 851b provided in the second shield layer 834c and expel the air directly over the first and second air movement devices 860a, 860b which can take in the air and direct the air over the first and second heating elements 850a, 850b to be heated. Once the air is heated by the heating elements 850a, 850b, the air can be arranged to follow a vortex flow path VFP, whereby the air is directed downwards along sides of the containers 890, 895 until the air reaches the bottoms of the containers, at which point the air can be circulated back upward toward central portions of the heating elements 850a, 850b. In some aspects, the vortex flow path VFP may be torus shaped flow paths. The vortex flow path VFP advantageously provide heated airflows that circulate around both top and bottom surfaces of food within the containers to provide thorough and even cooking of the food. Once the air is circulated back upward toward the central portions of the heating elements 850a, 850b, the first and second air movement devices 860a, 860b can then direct the air to the one or more exhaust vents 855a, 855b provided at the back of the housing 830. By providing the housing with the heating airflow path 851 and the exhaust vents 855a, 855b, the cooking system 800 is able to fully seal the containers 890, 895 with the seal assemblies 880, 883 as described above and is still able to regulate the air that is drawn into the cooking system for the cooking operations. In some aspects, sizes of the first one or more bypass openings 851a and the openings 851b provided in the partition/radiation shield assembly 834 can be specifically sized such that a ratio between air being drawn into the housing along the heating airflow path 851 and air being exhausted out of the exhaust vents 855a, 855b establishes a desired level of humidity within the cooking volumes of the containers 890, 895 during the cooking operations. As indicated above, the exhaust vents 855a, 855b may include louvered grills 856 that control the flow of the exhausted air to be directed out of the system 800 at an angle directed away from a back of the housing 830. This design advantageously prevents the exhausted air from being drawn back into the housing via the inlet 839i.

In some aspects, the cooking system may include synchronized dual zone cooking capabilities similar to the capabilities described above in reference to the system 700. In some aspects, the controls of the system 800 may be configured such that, responsive to removal of one of the containers 890, 895 from the system 800 during a synchronized cooking operation, the system 800 may pause cooking in both zones to synchronize completion. The system 800 may also be provided with a “Blast” button on the interface 831, which may be provided to increase heat for a set duration, similar to adding time on a microwave. In some aspects, the system 800 can also include a “Shake” reminder to prompt the user to toss food in one or more of the containers 890, 895.

FIGS. 8J and 8K illustrate perspective and front views of the cooking system 800 with no containers attached. As shown in FIGS. 8J and 8K, the platform 805 includes base 810 that extends forward from the spine 820. The base 810 is arranged to support the containers 890, 895 when the containers are inserted into the cooking system 800. In some aspects the base 810 can include guide features 810g provided on a top surface thereof and arranged to interact with rails or skis provided on bases of the containers 890, 895 to facilitate insertion and alignment of the containers, as described in greater detail below. The spine 820 projects upward from a back of the base 810 to couple the back of the base 810 to the back of the housing 830 such that the housing 830 is cantilevered over the base 810. In some aspects, a maximum lateral width of the housing 830 may be greater than a lateral width of the spine 820, similarly to the cooking systems described above. In some aspects, the spine 820 and the structural fin 821 can together form a T-shaped or W-shaped structure, formed from metal, such as aluminum, with a plastic covering. In some aspects, the structural fin 821 may be arranged to terminate short of the front of the housing, as shown, to allow a user to pivot the container during insertion and removal, as discussed below.

FIGS. 8L and 8M illustrate alternative variations of the bottom surface 830c, 830c′ of the cooking system 800, taken along section M-M of FIG. 8K. As shown in FIG. 8L, the bottom surface 830c of the housing 830 can be provided with a grill 833 which is arranged below the heating elements 850a, 850b the seal assemblies 880, 883, and the outlets 8390 provided radially outside of each seal assembly 880, 883. As shown, the seal assemblies 880, 883 can include seals 881, 884 arranged to seal around an upper rim of either of the containers 890, 895, and sensors/switches 882, 885. Additionally, as shown, the outlets 8390 can be formed as a plurality of openings provided radially outside of the seals 880, 883. In some aspects, as shown, inner outlets 8390 of each cooking portion can be separated by the structural fin 821 of the spine 820, which is arranged to project forward from the spine 820 in between the containers 890, 895.

As shown in FIG. 8M, a variation of the cooking system 800 can include the bottom surface 830c′, provided with a grill 833′ which is arranged below the heating elements 850a′, 850b′ the seal assemblies 880′, 883′, and the outlets 8390′ provided radially outside of each seal assembly 880′, 883′. As shown, the seal assemblies 880′, 883′ can include seals 881′, 884′ arranged to seal around an upper rim of either of the containers 890′, 895′, and sensors/switches 882′, 885′. Additionally, as shown, the outlets 8390′ can be formed as a plurality of openings provided radially outside of the seals 880′, 883′. In some aspects, as shown, inner outlets 8390′ of each cooking portion can be separated by a structural fin of spine 820, similarly to as described above. In some aspects, to allow for a user to better see the contents of the cooking containers during cooking operations, and to provide additional aesthetic value, each cooking portion can also be provided with at least one light 889a, 889b arranged to illuminate a volume of the container during cooking operations. In other aspects, the illuminating features provided by the lights 889a, 889b can be similar to that of the feature described above in reference to FIG. 1K. In some aspects, the cooking systems described herein can additionally or alternatively be provided with lighting features positioned in a middle region between the two containers (e.g., proximate to, or within the spine 820). In this case, the lighting features can be arranged to illuminate each container from a central location of the unit, projecting light laterally toward the sides of each container, providing visibility into both cooking volumes. Such a central lighting arrangement may reduce the number of lighting components while providing illumination to multiple cooking zones simultaneously. In some aspects, these additional or alternative lighting features may include incandescent bulbs, LEDs, light pipes, or combinations thereof, similarly to as described above. In some aspects, LEDs may be coupled to light pipes that direct illumination into the cooking volume at desired angles.

FIGS. 8N and 80 illustrate perspective and rear views of a structural frame 823 of the cooking system 800. The structural frame 823 includes an internal reinforced spine structure 824, an internal reinforced base structure 825, and an internal reinforced housing structure 826, which are together configured to provide rigidity to the cantilevered design of the system 800. The structural frame 823 may be constructed from metal, such as steel or aluminum. In some aspects, the components 824, 825, 826 of the structural frame 823 may be rigidly coupled to one another via bolts/rivets or welded connections, or any other type of rigid coupling scheme to ensure strength of the frame 823. The spine structure 824 may include internal ribbing 824a to provide additional structural support and may house one or more wires, such as a power cord (not shown).

FIG. 8P illustrates a side view of the cooking system 800. As shown in FIG. 8P, the housing 830 extends forward from the spine 820, creating a cantilevered configuration. The container 890 is positioned between the base 810 and the bottom surface 830c of the housing 830. The container 890 includes a front handle 893a, a rear handle 893b, and a side handle 893c that projects outward from a side of a base 892, providing various gripping surfaces for users.

FIG. 8Q is a perspective view of an exemplary container 890 (or container 895) configured to be used with the cooking system 800. As shown in FIG. 8Q, the container 890 includes a container body 891 and a container base 892. The container body 891 may be made from a thermal shock-resistant material such as borosilicate glass, other glass material, or thermally resistant plastics. The container base 892 can include a plurality of handles extending from lateral sides thereof. For example, in some aspects, the container base 892 can include one or more handles 893a, 893b provided on a front and/or back of the base 892, and one or more handles 893c, 893d provided on lateral sides of the base 892. However, it is appreciated that the container 890 can be symmetrical, such that the front can also be referred to as the back, and vice versa. In some aspects, the side handles 893c, 893d may also include clip features (not shown) to secure the container to the cooking system 800. In some aspects, the front and rear handles 893a, 893b, and the side handles 893c, 893d can be arranged to extend outward from heat protection flanges 892f of the base 892 which extend upward along sides of the container body 891. The container 890 can also include feet 894 positioned at a bottom surface 892a of the base 892. In some aspects, the feet 894 can be in the form of rails or skis that extend along the bottom surface 892a and are configured to interact with the guide features 810g on the base 810 of the cooking system 800, as described in greater detail below. In some aspects, the container 890 can also include a lid 899 configured to removably seal the container 890 for storage of food, similarly to the containers described above in reference to FIGS. 1A-7B.

FIGS. 8R and 8S are cross-sectional views of alternative variations of the container 890. As shown in FIG. 8R, the container 890 includes the container body 891 and the container base 892 with a gap G2 between the base of the container body 891 and the container base 892 which acts as a thermal barrier. In some aspects, the gap G2 may be defined by a projection arranged to support an air fryer pod above the container. The gap may be sized to allow adequate airflow around the container during cooking operations. In some aspects, the container 890 can also be provided with one or more crisper trays 898 that may be slidably received by the container 890. The crisper tray 898 may be used to increase heat transfer to food contained within the container 890. In some aspects, as shown in FIG. 8R, the crisper tray 898 can be arranged to friction fit with interior walls of the container body 891. Additionally, the container base 892 includes mounting features 892m on its lateral sides that may facilitate attachment to or interaction with corresponding ledges 891a provided on an exterior of the container body 891, as shown. in an aspect, the mounting features 892m include indents and detents molded into the side wall or bottom surface of the container 890. The container base 892 also includes corresponding indents and detents that align with and engage with the indents and detents on the container 890.

FIG. 8S illustrates an alternative variation of the container, shown as container 890′. The container 890′ includes a container body 891′ and a container base 892′ with a gap G2′ between the base of the container body 891′ and the container base 892′. As shown in FIG. 8S, in some aspects, the container body 891 can optionally include protrusions 891p that can be molded integrally within an interior volume of the container body 891 and configured to receive and hold the crisper tray 898.

FIG. 8T is a bottom view of the container 890. As shown in FIG. 8T, the bottom surface of the base 892a includes the feet/rails/skis 894 extending along opposite sides of the container base 892. In some aspects, the rails 894 include curved end portions 894e and parallel central portions 894c that assist in guiding the container 890 during placement into the cooking system 800, as discussed below. In some aspects, the end portions 894e can also be provided with rubber inserts 894r to prevent sliding on countertops and other resting surfaces. In some aspects the base 892 of the containers 890 can further include secondary rails 894s that can be provided between the central portions 894c and which can be sized to extend from the bottom surface 892a by a distance that is less than the distance the feet 894 extend, such that the secondary rails 894s are arranged to contact a top surface of the guides 810g during insertion and removal processes, as discussed below. The base also includes the handles 893a, 893b provided on a front and/or back of the base 892, and the handles 893c, 893d extending laterally from the base 892.

FIGS. 8U-8X are partial perspective views of an insertion operation of the container 890 into the cooking system 800, with FIGS. 8U-8V showing the entire container 890, and FIGS. 8W-8X only showing the interaction between the feet 894 of the base 892 and the guide features 810g provided on the base 810 of the cooking system 800. As shown in FIGS. 8U-8X, the guide features 810g are arranged to protrude from the top surface of the base 810 and have a generally oblong shape with curved ends that are specifically designed to accommodate the angled insertion of the containers 890, 895. The radii of the curved ends of the guide features 810g are dimensioned to provide smooth engagement with the curved end portions 894e of the feet 894 during the initial angled positioning of the container 890. This oblong configuration allows the guide features 810g to receive the container 890 at various angles while guiding it toward proper alignment with the housing 830. As shown in FIGS. 8U and 8W the insertion operation begins with the container 890 being positioned at an angle Ø relative to the front of the housing 830, with the end portions 894e of the feet/rails/skis 894 being in contact with the guide features 810g. The curved end portions 894e of the rails 894 facilitate smooth engagement with the guide features 810g. As shown in FIGS. 8U-8X, the container 890 is then rotated such that the container 890 becomes aligned with the front of the housing 830. The rails 894 slide along the guide features 810g during this rotation, guiding the container 890 into proper alignment. As shown in FIG. 8X, once the container 890 is fully inserted and aligned, the container 890 is securely positioned between the base 810 and the bottom surface 830c of the housing 830, with the parallel central portions 894c of the rails 894 being provided on opposite sides of the guide feature 810g to prevent lateral movement of the container 890 once it is properly positioned.

The design of the feet 894 and the guide features 810g of the system 800 advantageously allows for the container 890 to optionally be inserted onto the base 810 at an angle relative to the front of the housing 830, and then rotated such that the container 890 is aligned with the front of the housing 830. Optional angled insertion provides significant ergonomic benefits by allowing users to more easily position and guide the container 890 into the cooking system 800. For example, when the container 890 contains a substantial quantity of food, the combined weight of the container 890 and its contents may require a user to grip both of the front and rear handles 893a, 893b simultaneously for secure handling. In such cases, the angled insertion approach allows the user to maintain a two-handed grip on the container 890 while positioning it onto the base 810, as the angled orientation provides clearance for the user's hands to access both handle positions without interference from the housing 830 or the spine 820. Once the rails 894 are engaged with the guide features 810g, the user can then rotate the container 890 into final alignment, release the grip of the rear handle 893b and slide the container 890 onto a sealed position with the housing 830 using one hand, with the container 890 being guided by the parallel central portions 894c of the feet being in guided contact with the guides 810g, ensuring stable control throughout the insertion process. This angled insertion capability is particularly beneficial when the container 890 holds dense or heavy food items, as it reduces the risk of the container 890 being dropped or misaligned during installation into the cooking system 800. The angled insertion also reduces the precision required for initial placement, making the container insertion process more intuitive and user-friendly. In some aspects, as shown in FIGS. 8T and 8X, the base 892 of the containers 890 can further include secondary rails 894s that are sized to extend from the base 892 by a distance that is less than the distance the feet 894 extend, such that the secondary rails 894s are arranged to contact a top surface of the guides 810g during insertion and removal processes, to provide less friction between the base 892 and the base 810 as the containers 890, 895 are inserted and removed therefrom.

FIGS. 8Y and 8Z are front and side sectional views of the base 892 of the container 890 selectively connected to the base 810 of the cooking system 800. As shown in FIGS. 8Y and 8Z, in some aspects, the base 810 of the system 800 can further include a switch or plunger 812 arranged to detect the presence of the container 890. The switch or plunger 812 may be provided within the guide features 810g or at other suitable locations, and can be biased to an extended position by a spring 812s. During insertion, the base 892 of the container may initially be arranged to compress the switch/plunger 812 until the container is properly positioned on the platform 805. Once properly positioned, the switch/plunger 812 can align with one or more detents 892d provided on the base 892, allowing the switch/plunger 812 to at least partially return to its extended position, as shown in FIGS. 8Y-8Z. In some aspects, the container 890 can be symmetrical to allow for it to be inserted both rear handle first or front handle first. Accordingly, the container 890 can be provided with a plurality of detents 892d that are independently positioned to engage with the plunger 812 based on the orientation of the container 890 being inserted, as shown in FIG. 8Z. In some aspects, the detents 892d may have a teardrop shape that facilitates easier removal of the container 890 from the platform 805 by providing a gradual ramp surface, while the steeper side of the teardrop shape prevents the container 890 from being pushed past the plunger 812 during insertion. The detent 892d engagement actuates the switch 812 to signal the controller that the container 890 is correctly installed. In some aspects, the switch 812 may be hidden within the base 810 and actuated when the container 890 is properly installed. In some aspects, the spring based interaction between the switch/plunger 812 and the detents 892d can also provide tactile and/or auditory feedback to the user to indicate that the container 890 is properly seated. For example, once the switch/plunger 812 engages with one of the detents 892d, the spring 812s can cause the plunger 812 to snap into the extended position, providing a tactile response to the user or making a sound to indicate that the container 890 is fully inserted. This detection mechanism also ensures that cooking operations can only be initiated when the container 890 is properly seated, improving safety and cooking performance. This feature can also provide additional position securing functionalities, as the container must overcome the bias force of the plunger spring 812s in order to remove the container from the system after being properly positioned.

FIG. 8AA-8DD illustrate perspective, front, side, and detail views, respectively, of another container 890″ according to the systems and methods described herein. In some aspects, the container 890″ can be substantially similar to the container 890 described above, accordingly, like components will not be described in detail. The container 890″ includes a container body 891″ and a container base 892″ with a gap G2″ between the base of the container body 891″ and the container base 892″ which acts as a thermal barrier, similarly to the container 890 described above. The container base 892″ can include a plurality of handles extending from lateral sides thereof. For example, in some aspects, the container base 892″ can include one or more handles 893a“, 893b” provided on a front and/or back of the base 892″, and one or more handles 893c″, 893d″ provided on lateral sides of the base 892″. The container 890″ can also include feet 894″ positioned at a bottom surface of the base 892″, which can be in the form of rails or skis that extend along the bottom surface and are configured to interact with the guide features 810g on the base 810 of the cooking system 800, similarly to as described above. For example, the feet/rails/skis 894″ can include curved end portions 894e″ and parallel central portions 894c″ that assist in guiding the container 890″ during placement into the cooking system 800, as shown in FIG. 8BB and 8CC.

In some aspects, the side handles 893c″, 893d″ of the container 890″ can further include a ledge 896 that extends from the handle structure to provide an additional gripping surface or support point for users. The ledge 896 may be arranged to allow users to rest their fingers or thumbs during handling operations, providing enhanced stability and control when manipulating the container 890″. In some aspects, the side handles 893c″, 893d″ can be provided along the lateral flanges 892f″ of the heat protection base 892″ in a position that is upward relative to the position of the side handles 893c, 893d of the container 890. In some aspects, upward positioning of the side handles 893c″, 893d″ along the flanges 892f″ may provide improved ergonomics during lifting and carrying operations, as the handles may be positioned closer to a center of gravity of the container 890″ when loaded with food contents. In some aspects, the side handles 893c″, 893d″ are used to provide leverage for a user to remove the protective base from the glass vessel. The lateral flanges 892f″ include indents and detents that interact with the corresponding indents and detents on the glass vessel. Additionally, as shown in FIG. 8DD, the side handles 893c″, 893d″ may be provided with holes or apertures 897 formed through the handle structures, which can be arranged to improve heat dissipation from the handle structures during and after cooking operations.

FIG. 8EE-8HH illustrate an alternative removal process for removing the container 890″ from the cooking system 800. FIG. SEE is a partial sectional view of the container 890″ when it is properly seated within the system 800. FIG. SEE shows similar components to the components of container 890 shown in FIGS. 8W and 8X. As shown in FIG. 8EE, the container 890″ includes the feet/rails/skis 894″ having the curved end portions 894e″ and parallel central portions 894c″ arranged to straddle the guide feature 810g when the container 890″ is properly seated within the system 800. In some aspects, the end portions 894e″ can also be provided with rubber inserts 894r″ to prevent sliding on countertops and other resting surfaces. In some aspects the base 892″ of the container 890″ can further include structural support rails 894s″ arranged to span between the central portions 894c″ and sized to extend from the bottom surface of the base 892″ by a distance that is less than the distance the feet 894″ extend, such that the structural support rails 894s″ do not interfere with the guides 810g during insertion and removal processes. In some aspects, as shown in FIG. 8EE, the guide features 810g may further include a guide detent 810gd provided on a front lateral side of the guide feature 810g on respective external sides of the system 800. The guide detents 810gd may be formed as raised portions or protrusions that extend laterally outward from and external side of the guide features 810g and are positioned to interact with a rear external foot 894″ of the container 890″ during removal operations, as discussed below.

As shown in FIG. 8FF, when the container 890″ is being removed from the system 800, the container 890″ is initially pulled forward along the guide features 810g. During this forward movement, the rubber insert 894r″ provided on the external rear foot 894″ of the container 890″ approaches the guide detent 810gd. FIG. 8GG is a detail view from DETAIL-D of FIG. 8FF showing the interaction between the rubber insert 894r″ provided on the external rear foot 894″ of the container 890″ and the guide detent 810gd. As shown in FIG. 8GG, during forward movement of the container 890″, the rubber insert 894r″ of the external rear foot 894″ of the container 890″ contacts the guide detent 810gd, which acts as a catch that temporarily interrupts the linear forward motion of the external rear foot 894″. The engagement between the rubber insert 894r″ and the guide detent 810gd creates a pivot point PIV about which the container 890″ can rotate.

As shown in FIG. 8HH, the contact between the rubber insert 894r″ and the guide detent 810gd temporarily halts forward linear motion of the rear external foot 894″, while the opposing internal rear foot (not shown) is not impeded from forward motion. This causes the container 890″ to naturally rotate outward relative to the front of the housing 830, pivoting about the rear external foot 894″. This rotation positions the container 890″ at an angle relative to the cooking system 800, which may facilitate easier gripping of the container 890″ by providing clearance for a user's hands to access both the front and rear handles 893a″, 893b″ without interference from the housing 830 or the spine 820. The interaction between the rear external foot 894″ and the guide detent 810gd may provide a controlled rotation that assists users in transitioning from a one-handed pull motion to a two-handed grip on the container 890″ for secure removal and transport. In some aspects, the guide detents 810gd may be sized and positioned such that the rotation angle achieved during removal corresponds to the angle Ø used during the angled insertion process described above, providing a consistent and intuitive user experience for both insertion and removal operations.

In some aspects, a stacked cooking embodiment may be considered for the cooking system 800, where the two heating zones of the system 800 are stacked vertically, rather than being positioned in lateral separation, as shown. In this case, the system may use different sized containers to facilitate airflow between containers positioned vertically within the housing 830.

In some aspects the containers of the systems described herein can feature a wide variety of handle/container base designs. Several of the various handle/base designs for the containers described herein are discussed in greater detail below in reference to FIGS. 9A-26. The containers described below can be similar to the other containers described above, accordingly, like components are not described. Similarly, cooking systems variously depicted throughout FIGS. 9A-26 can be similar to the cooking systems 700 and 800 described above, accordingly, like components will not be described.

FIG. 9A illustrates a front view of two exemplary containers 910, 950 which are selectively coupled to a cooking system 900. FIG. 9B illustrates an isometric view of the two containers 910, 950 shown separately from the cooking system. As shown, the containers 910, 950 include bases 912, 952 that are adapted to wrap around the lower portions of the glass containers and include the handle structures 914, 954 which are adapted to wrap at least partially around the containers, and can include curled edges to provide a better gripping surface for users. FIG. 9C illustrates a top view of the two containers 910, 950. As shown in FIG. 9C, the handles 914, 954 can be adapted to wrap around three sides of the containers 910, 950, respectively, which do not include internal sides 911, 951 of the containers. This design allows for the containers 910, 950 to more easily fit within the cooking system 900 without interfering with the structural fin 901 of the system, which can be similar to the structural fins described above.

FIGS. 10A-10C illustrate front, isometric, and top views of exemplary container structures 1010, 1050 with side handle configurations. As shown, the containers 1010, 1050 include heat protection bases 1012, 1052 that are adapted to wrap around the lower portions of the glass containers and include integrated handle portions 1013, 1014 and 1053, 1054 that project laterally from opposite sides of the base platforms. This side handle allows users to grip the containers from the lateral sides during insertion and removal operations. The side handles 1013, 1014, 1053, 1054 have curved ergonomic profiles designed to facilitate comfortable gripping during handling operations.

FIGS. 11A-11B illustrate front and isometric views of container structures 1110, 1150 which are each provided with heat protection bases 1112, 1152 that feature surrounding rim handles 1113, 1153 arranged to project outward from all sides of the containers to allow for gripping versatility. The heat protection bases 1112, 1152 also include raised rim structures 1114, 1154 extending upward around the perimeters of the container bodies, creating enhanced protective barriers between the heated glass surfaces and user contact points. This design addresses safety concerns by providing additional thermal protection while maintaining comfortable gripping surfaces that accommodate various hand sizes and oven mitt configurations.

FIG. 12 illustrates a top view of containers 1210, 1250 with pivotal side handle structures 1213, 1214 and 1253, 1254 that extend laterally from opposite sides of the bases 1212, 1252, and which are hingedly coupled to the bases 1212, 1252, and front handles 1215, 1255. As shown in FIG. 12, in some aspects, the pivotal side handle structures 1213, 1214 and 1253, 1254 can be biased to the extended position (e.g., the illustrated position of handle 1213) by spring biasing mechanisms or friction mechanisms, or the like, such that they are arranged to initially be biased to the extended position for gripping by a user, and are arranged to fold downward responsive to coming into contact with a structural fin 1201 of the system (similar to the structural fin 821 of system 800). This pivotal design allows the containers 1210, 1250 to be inserted into the cooking system even when the structural fin 1201 would otherwise interfere with fixed lateral handles, as the pivotal handles automatically fold out of the way during insertion and then return to their extended positions once the containers are properly seated. This design can advantageously allow for the containers described herein to be provided with handles on both lateral sides (and front and back) while also allowing for the housing structure to be more compactly designed.

FIG. 13 illustrates an isometric view of container 1310 with a comprehensive multi-handle configuration. As shown, the container 1310 includes a base 1312 that is adapted to wrap around the lower portion of the glass container and includes handle portions 1313, 1314 symmetrically projecting from the front and back surfaces, and side handle portions 1315 extending symmetrically from opposite sides of the base. In some aspects, the front and rear handles, and the side handles can be formed continuously around the base 1212.

FIGS. 14A-14B illustrate isometric and sectional side views of container 1410 with enhanced front and back handle structures 1413, 1414. As shown, the container 1410 includes a base 1412 that is adapted to wrap around the lower portion of the glass container and extend upward along the front and back of the container. The front handle 1413 forms a pistol grip type handle that provides an ergonomic gripping surface with enhanced control and leverage for single-handed operation. The pistol grip configuration allows users to maintain a secure grip while maneuvering the container, particularly when inserting or removing the container from the cooking system. The rear handle 1414 provides the user with a supplementary gripping surface that is positioned at a level similar to the top of the pistol grip to aid in carrying the container when the load is too heavy to be carried by the pistol grip alone. This dual-handle configuration enables two-handed carrying for heavier loads, with the rear handle 1414 serving as a stabilizing grip point that works in conjunction with the pistol grip 1413 to provide balanced support and enhanced user safety when transporting containers with substantial food contents.

FIGS. 15A-15B illustrate front and perspective views of a cooking system 1500 that includes containers 1510 and 1550 which are different volumes. In some aspects, the cooking system 1500 can be similar to the cooking systems described above, accordingly, like components will not be described. As shown in FIGS. 15A-15B, the cooking system 1500 can accommodate containers 1510, 1550 of various sizes by utilizing a platform insert 1501 that can be selectively positioned on the base of the system 1500 to elevate smaller containers to the proper sealing height, similarly to as described above. For example, in reference to the system 800, the platform insert 1501 can be configured to slide over the guides 810g of system 800 to provide an elevated surface for the smaller container 1550 while maintaining proper alignment and positioning within the cooking zones.

FIGS. 15C-15E illustrate perspective, side, and front views of the container 1510. As shown, the container 1510 includes a base 1512 that is adapted to wrap around the lower portions of the glass container and includes front and back handle portions 1513, 1514. The front handle portion 1513 forms an inverted pistol grip that provides an ergonomic gripping surface with enhanced control and leverage for single-handed operation. The inverted pistol grip configuration allows users to maintain a secure grip while maneuvering the containers, particularly when inserting or removing the containers from the cooking system. The rear handle portion 1514 is positioned at a level similar to the inverted pistol grip 1513 to aid in carrying the containers when the load is too heavy to be carried by the front grip alone. This dual-handle configuration enables two-handed carrying for heavier loads, with the rear handles serving as stabilizing grip points that work in conjunction with the inverted pistol grips to provide balanced support and enhanced user safety when transporting containers with substantial food contents. In some aspects, the components of the smaller container 1550 can be similar to those of the container 1510, accordingly, like components are not described.

FIGS. 16A-16B illustrate front and side views of a cooking system 1600 with another exemplary container structure 1610 selectively coupled thereto. In some aspects, the cooking system 1600 can be similar to the cooking systems described above, accordingly, like components are not discussed further. The container 1610 includes a transparent container body 1611 and a heat protection base 1612 positioned beneath the container body 1611. The base 1612 includes front and rear handles 1613, 1614 that are arranged such that users can hold the container 1610 as if they were holding a tray, with a thumb provided on a top surface of the handles 1613, 1614 and the rest of the user's fingers curving underneath the base 1612. The base 1612 also includes upper rims 1615, 1616 extending upward from the front and rear handles 1613, 1614, respectively. The upper rims 1615, 1616 extend along the container body 1611 to provide heat protection barriers between the heated glass surfaces and user contact points, similarly to the heat protection rims of containers 1110 and 1150 described above. The side view of FIG. 16B shows the profile of the handles 1613, 1614 and the upper rims 1615, 1616 extending upward along the front and rear sides of the container body 1611.

FIGS. 17A-17B illustrate isometric and side views of another exemplary container structure 1710 as described herein. As shown in FIG. 17A, the container 1710 includes a transparent container body 1711 and a heat protection base 1712 positioned beneath the container body 1711, which includes front and rear handles 1713, 1714. In some aspects, the front and rear handles 1713, 1714 can be designed similarly to the handles of container 1610, but can omit the additional upper rim portions that extend upward along the container body 1711.

FIGS. 18A-18D illustrate isometric, front, side, and bottom views of another exemplary container structure 1810 as described herein. As shown in FIG. 18A, the container 1810 includes a transparent container body 1811 and a heat protection base 1812 positioned beneath the container body 1811. The base 1812 includes a skirt 1819 that extends around a bottom periphery of the container body 1811. Front and rear handles 1813, 1814 are provided at an upper portion of the skirt 1819. The base 1812 also includes upper rims 1815, 1816 that extend upward along the container body 1811 above the front and rear handles 1813, 1814 to act as heat protection barriers, similarly to as described above. The skirt 1819 provides a continuous protective barrier around the lower perimeter of the container body 1811, enhancing thermal protection. FIG. 18C illustrates a side view of the symmetrical container 1810, showing the profile of the skirt 1819 and the handles 1813, 1814 extending from the upper portion of the skirt 1819. FIG. 18D illustrates a bottom view of the container 1810, showing a bottom surface 1818 of the base 1812 and feet 1817 positioned to provide stable support.

FIGS. 19A-19C illustrate isometric, front, and sectional side views of another exemplary container structure 1910 as described herein. As shown in FIG. 19A, the container 1910 includes a transparent container body 1911 and a heat protection base 1912 positioned beneath the container body 1911. The base 1912 includes a skirt 1919 that extends around a bottom periphery of the container body 1911, similarly to as described above in reference to the container 1810. In some aspects, as shown, the front and rear handles 1913, 1914 can be provided at a lower portion of the skirt 1919, positioned closer to a bottom surface of the base 1912 than the handles of the container 1810 described above.

FIGS. 20A-20C illustrate isometric, side, and front views of another exemplary container structure 2010 as described herein. As shown in FIG. 20A, the container 2010 includes a body 2011 and a heat protection base 2012 that extends along a bottom of the container body 2011 and extension portions 2012a, 2012b that extend upward along lateral sides of the container body 2011 to an upper rim 2020 of the container body 2011, where the extension portions 2012a, 2012b connect to a heat protection rim 2030 configured to surround a periphery of the upper rim 2020 of the container. Front and rear handles 2013, 2014 can be provided on the heat protection rim 2030, proximate to a front portion and a rear portion of the upper rim 2020, respectively. The heat protection rim 2030 can also include flanges 2031, 2032 which are arranged to project downward from the handles 2013, 2014, along front and rear sides of the container, to provide comprehensive thermal protection proximate the handles.

FIG. 21A illustrates a perspective view of other exemplary container structures 2110, 2150 as described herein. FIG. 21B illustrates a front view of the smaller container structure 2150 of FIG. 21A. FIG. 21C illustrates a side view of the larger container structure 2110 of FIG. 21A. The container structures 2110, 2150 include a large container 2110 and a small container 2150. As shown, the containers 2110, 2150 can each includes a transparent container body 2111, 2151 and a heat protection base 2112, 2152. The bases 2112, 2152 can include skirts 2119, 2159 that extend around a periphery of a bottom portion of the container bodies 2111, 2151. Front and rear handles 2113, 2114 and 2153, 2154 extend from the skirts 2119, 2159, and heat protection flanges 2115, 2116 and 2155, 2156 extend upward along sides of the container bodies above the front and rear handles 2113, 2114 and 2153, 2154. The handles may be provided along a central portion of the skirts. The smaller container 2150 can also be provided with a platform insert 2101 that can be selectively positioned on a base of a cooking system to elevate the smaller container 2150 to a proper sealing height, similarly to as described above.

FIGS. 22A-22D illustrate isometric, front, side, and bottom views of another exemplary container structure 2210 as described herein. As shown in, the container 2210 includes a transparent container body 2211 and a heat protection base 2212 that includes front and rear flanges 2215, 2216 that extend upward along front and back sides of the container body 2211. Handles 2213, 2214 extend from the flanges 2215, 2216, respectively. The flanges 2215, 2216 provide heat protection along the front and back sides of the container body 2211, while the handles 2213, 2214 provide gripping surfaces for user manipulation. The front and rear flanges 2215, 2216 that extend from the base 2212 can also be provided with mounting features (not shown) which can be substantially similar to the mounting features 892m described above. Similarly, the container body 2211 can be provided with corresponding ledges (not shown), which can be substantially similar to the ledges 891a provided on the exterior lateral sides of the container body 891 described above, but can instead be positioned on the front and rear sides of the container body 2211 to facilitate attachment to or interaction with the mounting features provided on the front and rear flanges 2215, 2216 of the base 2212. In some aspects, the mounting feature/ledge interaction can include indents/detents molded into container body 2211, and corresponding indents/detents provided within the front and rear flanges 2215, 2216 that align with and engage with the indents/detents on the container body. FIG. 22D illustrates a bottom view of the container 2210, showing the bottom surface 2218 of the base 2212 and the feet 2217 arranged to provide stable support.

FIGS. 23A-23C illustrate front and side views of a cooking system 2300 with other exemplary container structures 2310, 2350 selectively coupled thereto. In some aspects, the cooking system 2300 can be similar to the cooking systems described above, accordingly, like components are not discussed further. The larger container 2310 includes a body 2311 and a heat protection base 2312 having walls 2319 that encompass a lower portion of the container body 2311 on all sides. Front and rear handles 2313, 2314 are provided in a central portion of the walls 2319 on front and rear sides. The base 2312 also includes flanges 2315, 2316 extending along front and rear walls of the container body 2311 above the front and rear handles 2313, 2314. A brim handle 2317 is provided at an upper end of the walls 2319 and extends around an entirety of a perimeter of the container body 2311. The smaller container 2350 includes a body 2351, heat protection base 2352 with walls 2359, front and rear handles 2353, 2354, flanges 2355, 2356, and a brim handle 2357, which can be substantially similar to the corresponding components of container 2310 described above. A platform insert 2301 can be selectively positioned on the base 2305 to elevate the smaller container 2350 to a proper sealing height, similarly to as described above.

FIG. 24 is an isometric view of another exemplary container structure 2410 as described herein. As shown, the container 2410 includes a transparent container body 2411 and a heat protection base 2412 positioned beneath the container body 2411. The container 2410 also includes a pivotal bucket-type handle 2413 that is coupled to lateral sides of the container body 2411. In some aspects, the handle 2413 could also be coupled to the base 2412. The pivotal handle 2413 can be U-shaped and arranged to fold along either a front or a back of the container 2410, similarly to a pivotal handle on a pail or a bucket. The pivotal handle 2413 may be hingedly coupled to the lateral sides via hinge connections 2420 that allow the handle 2413 to rotate between an upright carrying position and a folded storage position. The pivotal handle 2413 provides a versatile gripping option that can be positioned upright for carrying or folded down to reduce the overall height of the container 2410 during storage or when the container 2410 is positioned within a cooking system.

FIG. 25 is an isometric view of another exemplary container structure 2510 as described herein. As shown, the container 2510 includes a transparent container body 2511 and a heat protection base 2512 positioned beneath the container body 2511. The base 2512 includes front and rear handles 2513, 2514 extending therefrom. The front and rear handles 2513, 2514 are block-type handles that are designed for users to pinch grip with their thumb on a top surface 2513a, 2514a and the rest of the user's fingers on a bottom surface 2513b, 2514b. The handles 2513, 2514 have a compact profile that facilitates pinch gripping. The base 2512 also includes a front rim 2515 extending upward along a front side of the container body 2511 and a rear rim 2516 extending upward along a rear side of the container body 2511 to provide heat protection, similarly to as described above. The front and rear rims 2515, 2516 act as thermal barriers between the heated glass surfaces and user contact points.

FIG. 26 is an isometric view of another exemplary container structure 2610 as described herein. The container 2610 may be substantially similar to the container 2510 of FIG. 25. As shown, the container 2610 includes a transparent container body 2611 and a heat protection base 2612 positioned beneath the container body 2611. The base 2612 includes front and rear handles 2613, 2614 extending therefrom. The handles 2613, 2614 are arranged to only undercut on a rear surface 2613b, 2614b thereof and have a flat upper surface 2613a, 2614a. The base 2612 also includes a front rim 2615 extending upward along a front side of the container body 2611 and a rear rim 2616 extending upward along a rear side of the container body 2611 to provide heat protection.

FIGS. 27A-27B illustrate side and front views, respectively, of a container body 2700 of a container assembly, which is shown separately from a corresponding container base. The container body 2700 can be similar to the container bodies described above, accordingly, like components will not be described. As shown in FIGS. 27A-27B, the container body 2700 includes one or more external detents 2710 provided on exterior lateral sides or bottom surface of the container body 2700. The external indents or detents 2710 can be similar to the ledges 891a provided on the exterior of the container body 891 described above, and can be arranged to facilitate attachment to or interaction with corresponding mounting features provided on a container base. In some aspects, the indents or detents 2710 can additionally or alternatively be provided on front and rear exterior sides, along with a bottom of the container body 2700 to facilitate connection to other types of bases. For example, detents provided on the front and rear exterior sides of the container body 2700 can be arranged to interact with mounting features of bases having front and rear flanges, such as the base 2212 of container 2210 described above in reference to FIGS. 22A-22D. In some aspects, the container body 2700 can be made from a glass or plastic material, similarly to as described above, and the detents 2710 can be formed integrally with the body 2700 and arranged to protrude outward.

FIG. 27C is a perspective view of an exemplary container base 2720 of a container assembly, which can be coupled to the container body 2700. The container base 2720 can be similar to the container bases described above, accordingly, like components will not be described. As shown in FIG. 27C, the container base 2720 includes one or more external detents 2724 provided on exterior lateral flanges 2722 of the container base 2720. The external detents 2724 can be similar to the mounting features 892m of the container base 892 described above, and can be arranged to facilitate attachment to or interaction with corresponding ledges or detents 2710 provided on an exterior of the container body 2700. In some aspects, the detents 2724 can be a singular oblong/bar shaped detent, as shown, and arranged to protrude inward from the flanges 2722. In some aspects, the detents 2724 can include multiple sections to correspond to the one or more detents 2710. The base 2720 can also include one or more projections 2726 provided along an upper surface of the base 2720 and along front and rear flanges 2728 of the base 2720. The projections 2726 are arranged to support the container body 2700 and provide a thermal barrier between the upper surface of the base 2720 and the container body 2700. This thermal barrier can create a gap between the container body and the base, similarly to the gap G2 described above. In some aspects, the detents 2724 can additionally or alternatively be provided on the front and rear flanges 2728 to facilitate connection to other types of container bodies. For example, detents provided on the front and rear flanges 2728 can be arranged to interact with detents provided on the front and rear sides of a container body, such as the container body 2211 described above in reference to FIGS. 22A-22D.

FIG. 27D is a perspective view of another exemplary container base 2730 of a container assembly, which can be coupled to the container body 2700. The container base 2730 can be similar to the container bases described above, accordingly, like components will not be described. As shown in FIG. 27D, the container base 2730 includes one or more indents 2734 provided on exterior lateral flanges 2732 of the container base 2730. The indents 2734 are arranged to receive the one or more detents 2710 of the container body 2700, facilitating attachment between the container body 2700 and the container base 2730. In some aspects, the indents 2734 can be recessed slots or channels formed in the flanges 2732 and dimensioned to correspond to the detents 2710. The base 2730 also includes a skirt 2735 that extends around a periphery of a bottom portion of the container body 2700 when the container body 2700 is coupled to the base 2730. In some aspects, the skirt 2735 can be similar to the skirts described above in reference to FIGS. 18A-19C or FIGS. 21A-21C. The base 2730 can also include one or more projections 2736 provided along an upper surface of the base 2730 and along internal sides of the skirt 2735. The projections 2736 are arranged to support the container body 2700 and provide a thermal barrier between the upper surface of the base 2730 and the container body 2700.

FIG. 27E is a perspective view of another exemplary container base 2740 of a container assembly, which can be coupled to the container body 2700. The container base 2740 can be similar to the container bases described above, accordingly, like components will not be described. As shown in FIG. 27E, the container base 2740 includes one or more indents 2744 provided on exterior lateral flanges 2742 of the container base 2740. The indents 2744 are arranged to receive the one or more detents 2710 of the container body 2700, facilitating attachment between the container body 2700 and the container base 2740. In some aspects, the indents 2744 can be recessed slots or channels formed in the flanges 2742 and dimensioned to correspond to the detents 2710. The base 2740 also includes a skirt 2745 that extends around a periphery of a bottom portion of the container body 2700 when the container body 2700 is coupled to the base 2740. The base 2740 can also include one or more projections 2746 provided along an upper surface of the base 2740 and along internal sides of the skirt 2745. The projections 2746 are arranged to support the container body 2700 and provide a thermal barrier between the upper surface of the base 2740 and the container body 2700.

While the container bodies and container bases described above can be connected using any of the connection methods described above, other connection methods between the container bodies and the container bases are also realized. For example, in some aspects, the connection between the container bodies and the container bases described herein may be achieved by flipping the orientations of the indents and detents provided on the container base and the container body, respectively, such that the container body includes indents and the base includes detents. In some aspects, the container base can engage the container body through positive mechanical connections, such as snap-fit tabs, clips, or latch mechanisms. In some aspects, the connection between the container bodies and the container bases described herein can also be achieved using adhesives or suction cups or the like. In some aspects, the connection between the container bodies and the container bases can include rigid connection elements, such that the container bases may be permanently coupled to the container body. In some aspects, the connection between the container bodies and the container bases can include resilient connection elements, such that the container bases may be detachably coupled to the container body.

Certain aspects have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

What is claimed is:

1.-20. (canceled)

21. A cooking system, comprising:
a base configured to support containers during cooking operations;
a spine extending upward from a rear portion of the base;
a housing coupled to the spine and extending forward over the base in a cantilevered arrangement, the housing configured to accommodate two or more containers between the base and the housing;
guide features extending upward from a top surface of the base, the guide features having an oblong shape with curved ends; and
at least one container comprising a container body and a container base, the container base including elongated rails extending along opposite sides of a bottom surface of the container base, the rails having curved end portions and parallel central portions, wherein the curved end portions of the rails are configured to engage with the curved ends of the guide features to allow the container to be positioned at an angle relative to a front of the housing and then rotated into alignment with the housing such that the parallel central portions of the rails straddle the guide features to prevent lateral movement of the container.

22. The cooking system of claim 21, wherein the rails include rubber inserts positioned on the curved end portions to prevent sliding when the container is placed on countertops.

23. The cooking system of claim 21, wherein the container base further includes secondary rails positioned between the parallel central portions of the rails, the secondary rails extending from the container base by a distance less than the distance the rails extend, wherein the secondary rails are configured to contact a top surface of the guide features during insertion and removal processes to reduce friction between the container base and the base.

24. (canceled)

25. The cooking system of claim 21, wherein the base of the cooking system further comprises a switch configured to detect presence of the container when the container is properly seated on the base of the cooking system.

26. The cooking system of claim 25, wherein the switch is biased to an extended position by a spring and is configured to be compressed by the container base during insertion.

27. The cooking system of claim 26, wherein the container base includes one or more detents positioned to align with the switch when the container is properly positioned, allowing the switch to at least partially return to the extended position.

28. The cooking system of claim 27, wherein the detents have a teardrop shape that facilitates removal of the container while preventing the container from being pushed past the switch during insertion.

29. The cooking system of claim 21, wherein the container base includes multiple handle structures extending from different sides of the container base to provide various gripping options for users.

30. The cooking system of claim 29, wherein the multiple handle structures include a front handle extending from a front edge of the container base and a rear handle extending from a rear edge of the container base.

31. The cooking system of claim 21, further comprising a platform insert configured to be selectively couple to the guide features of the cooking system to elevate a smaller container being accommodated within the cooking system, wherein the smaller container comprises a container body and a container base, the container base including elongated rails extending along opposite sides of a bottom surface of the container base, the rails having curved end portions and parallel central portions, wherein the curved end portions of the rails are configured to engage with the curved ends of the platform insert to allow the smaller container to be positioned at an angle relative to a front of the housing and then rotated into alignment with the housing such that the parallel central portions of the rails straddle the platform insert to prevent lateral movement of the smaller container.

32. A method comprising:
positioning a container at an angle relative to a front of a housing of a cooking system having a base with guide features extending upward from a top surface thereof, wherein the container comprises rails with curved end portions provided on a base thereof;
engaging the curved end portions of the rails with curved ends of the guide features on the base;
rotating the container from the angled position toward alignment with the front of the housing while the rails slide along the guide features; and
securing the container in a final position where parallel central portions of the rails straddle the guide features to prevent lateral movement of the container, and wherein a top rim of the container is selectively sealed with a cooking portion of the cooking system.

33. The method of claim 32, wherein the container includes one or more handle structures extending sides of the base of the container, and wherein positioning the container at the angle is performed by gripping the one or more handle structures.

34. The method of claim 33, wherein the one or more handle structures include a front handle and a rear handle, and wherein positioning the container comprises gripping both the front handle and the rear handle simultaneously to maintain secure control during the angled insertion.

35. The method of claim 32, further comprising: actuating a switch positioned within the base of the cooking system when the container reaches the final position, wherein the switch provides tactile feedback to indicate proper seating of the container.

36. A container comprising:
a container body having an upper rim and sidewalls;
a container base coupled to the container body and including a bottom surface;
elongated rails extending along a bottom surface of the container base, the rails having curved end portions configured to facilitate initial engagement with guide features provided on a base of the cooking system, and parallel central portions configured to straddle the guide features when the container is properly positioned; and
one or more handles extending from the container base to provide gripping surfaces for user manipulation during insertion and removal of the container from the cooking system.

37. The container of claim 36, wherein the rails include rubber inserts positioned on the curved end portions to prevent sliding when the container is placed on countertops or other supporting surfaces.

38. The container of claim 36, wherein the container base further includes secondary rails positioned between the parallel central portions of the rails, the secondary rails extending from the container base by a distance less than the distance the rails extend, wherein the secondary rails are configured to contact a top surface of guide features of the cooking system during insertion and removal processes to reduce friction between the container base and a base of the cooking system.

39. (canceled)

40. The container of claim 36, wherein the container body is made from a transparent thermal shock-resistant material including at least one of borosilicate glass or thermally resistant plastic.

41. (canceled)

42. The container of claim 36, wherein the container body comprises one or more first detents or indents provided on an exterior of the sidewalls, and
wherein the container base comprises one or more second detents or indents provided on an interior face thereof and configured to interact with the one or more first detents or indents to securely couple the container base to the container body.

43. The container of claim 36, wherein the container base further comprises one or more projections provided along an upper surface of the base configured to support the container body and create a gap between the container body and the container base, providing a thermal barrier between the upper surface of the base and the container body.

44. The container of claim 36, wherein the one or more handles include a front handle extending from a front edge of the container base, a rear handle extending from a rear edge of the container base, and side handles extending laterally from opposite sides of the container base to provide multiple gripping options for users.

45.-63. (canceled)
